(19) United States
(12) Patent Application Publication
(10) Pub. No.: US 2002/0019253 A1
(43) Pub. Date: Feb. 14, 2002

(54) COMPUTER GAMING SYSTEM

(76) Inventors: ROBERT REITZEN, LOS ANGELES, CA (US); HEIN HUNDAL, STATE COLLEGE, PA (US)

Correspondence Address: THE HECKER LAW GROUP, 1925 CENTURY PARK EAST, SUITE 2300, LOS ANGELES, CA, 90067, US

(21) Appl. No.: 09/110,090

(22) Filed: Jul. 1, 1998

Related U.S. Application Data
(63) Continuation-in-part of application No. 08/851,255, filed on May 5, 1997, now Pat. No. 5,941,770.

(51) Int. Cl. A63F 9/24; G06F 19/00; A63F 13/00; G06F 17/00

(52) U.S. Cl. 463/16; 463/22; 273/292

(57) ABSTRACT

The present invention comprises an intelligent gaming system that includes a game engine, simulation engine, and, in certain embodiments, a static evaluator. Embodiments of the invention include an intelligent, poker playing slot machine that allows a user to play poker for money against one or more intelligent, simulated opponents. In one embodiment, the invention generates card playing strategies by analyzing the expected return to players of a game. In one embodiment, a multi-dimensional model is used to represent possible strategies that may be used by each player participating in a card game. Each axis (dimension) of the model represents a distribution of a player's possible hands. Points along a player's distribution axis divide each axis into a number of segments. Each segment has associated with it an action sequence to be undertaken by the player with hands that fall within the segment. The dividing points delineate dividing points between different action sequences. The model is divided into separate portions each corresponding to an outcome determined by the action sequences and hand strengths for each player applicable to the portion. An expected return expression is generated by multiplying the outcome for each portion by the size of the portion, and adding together the resulting products. The location of the dividing points that result in the maximum expected return is determined by taking partial derivatives of the expected return function with respect to each variable, and setting them equal to zero. The result is a set of simultaneous equations that are solved to obtain values for each dividing point. The values for the optimized dividing points define optimized card playing strategies.

### CROSS-REFERENCE TO RELATED APPLICATION

This patent application is a continuation-in-part of U.S. patent application Ser. No. 08/851,255 filed on May 5, 1997.

### BACKGROUND OF THE INVENTION

1. Field of the Invention

This invention relates to an intelligent card playing gaming system.

2. Background Art

Existing electronic casino games (slot machines) are available in which one player plays against a predetermined criteria that determines whether the player wins. One such game that is prominent in a casino or other gaming environment is referred to as video poker. In video poker, the player is dealt a hand of cards which is evaluated against a payoff table. Thus, the player is pitted against static, predetermined hand rankings. If the player's hand exceeds a threshold ranking, the player wins the amount indicated for the threshold. The player does not play poker against another player.

In Bridgeman et al, U.S. Pat. No. 5,046,736, a multi-player poker slot machine is described. One player is a person and the other player(s) is simulated by the slot machine system. The real player initiates all of the actions in the game while the simulated player merely responds by imitating each action of the player. There is no ability or intelligence of the simulated player to develop a strategy in which the simulated player decides upon an action other than the one performed by the real player. It is therefore, impossible for the simulated player to be the initiator of the game (i.e., make the first move). Further, the real player can predict with 100% accuracy the moves that the simulated player will take thereby making it easier for the real player to out-maneuver the simulated player.

The following provides a discussion of the game of poker.

Poker Basics

There are a large number of poker variations. However, certain basic concepts apply to most types of poker.

Poker hands generally consist of five cards from a 52 card deck. There are 2,598,960 different hands. The hands are linearly ordered in strength or “rank.” There are nine general categories of hands, ranked as shown in Table 1.

TABLE 1
Ranking by Categories

| Rank | Name | Example |
|---|---|---|
| 1 | Straight flush | J [symbol] 10 [symbol] 9 [symbol] 8 [symbol] 7 [symbol] |
| 2 | Four of a kind | K [symbol] K♦ K♥ K [symbol] 9 [symbol] |
| 3 | Full house | J♦ J♥ J [symbol] 3 [symbol] 3♥ |
| 4 | Flush | A [symbol] 10 [symbol] 9 [symbol] 5 [symbol] 2 [symbol] |
| 5 | Straight | 6♦ 5♥ 4 [symbol] 3 [symbol] 2♥ |
| 6 | Three of a kind | 10 [symbol] 10 [symbol] 10♦ 9♥ 7 [symbol] |
| 7 | Two pair | A♥ A [symbol] 4 [symbol] 4♦ 9 [symbol] |
| 8 | One pair | 9♦ 9♥ K [symbol] 8 [symbol] 6♥ |
| 9 | No pair | 3 [symbol] 5♦ 6♥ J [symbol] Q [symbol] |

Within each category, hands are ranked according to the rank of individual cards, with an ace being the highest card and a 2 being the lowest card. There is no difference in rank between the four suits of cards. Table 2 shows the ranking of some example hands within the two pair category. Because the suits of the individual cards do not matter for two pair hands (the suits become relevant only for flushes and straight flushes because all cards in these hands must be of the same suit), no suits are shown in Table 2.

TABLE 2
Relative Ranking of Some Two Pair Hands

| Highest | AAKKQ |
|---|---|
| | AAKKJ |
| | AAKK10 |
| | AAKK9 |
| | * * * |
| | AAQQ2 |
| | AAJJK |
| | AAJJQ |
| | * * * |
| | JJ223 |
| | 101099A |
| | 101099K |
| | * * * |
| | 33226 |
| | 33225 |
| Lowest | 33224 |

All hands can be ranked in a linear ranking from highest to lowest. Because suits are all of the same value, however, there are multiple hands that have identical rankings. For example, there are four equivalent hands for each type of straight flush, four of a kind, or flush; there are over a hundred equivalent hands for each two pair variation, and there are over 1000 equivalent hands for each type of no-pair hand. Accordingly, although there are over 2,000,000 possible hands, there are significantly fewer possible rankings.

Poker is characterized by rounds of card dealing and betting. Numerous variations of poker exist, including “five card draw,” “five card stud,” “seven card stud,” “hold'em,” and “Omaha.” The variations generally differ in the manner in which cards are dealt and in the manner in which bets are placed. Various criteria may also be used to determine the winning hand, including highest ranking hand wins, lowest ranking hand wins (“low-ball”), and high and low hands each win half (“high-low”).

Typically, a game starts when each player has placed an initial bet, called the “ante,” into the “pot.” The term “pot” refers to the total accumulation of bets made during a game. Each player that has “anted” is dealt an initial set of cards. The number of cards depends on the particular variation of poker being played. In five card draw, each player is initially dealt five cards.

After the deal, the players have the opportunity to place bets. If a player places a bet, that bet must be matched (“called”) or “raised” by each player that wants to remain in the game. A player who does not match a bet drops out of the game or “folds.” A round of betting ends when either every player but one has folded, or when the highest bet or raise has been called by each remaining player such that each remaining player has paid the same amount into the pot during the round.

Each game may have several “rounds” of betting. If two or more players remain after a round of betting, either more cards are dealt, or there is a “showdown,” depending on the game variation being played. A “showdown” occurs when two or more players remain in a game after the last round of betting for a game has been completed. A player wins a game of poker (also sometimes called a “hand of poker”) either by having the highest ranking hand when a “showdown” occurs, or by being the last remaining player in the game after all other players have dropped out, or “folded.” At a showdown, each player displays the player's hand to the other players. The player showing the hand with the highest ranking wins the pot.

FIG. 1 illustrates the sequence of events that occur in a game of five card draw poker. As shown in FIG. 1, the game begins with each player paying an ante into the pot at step 100. At step 105, each player is dealt five cards by one of the players who is referred to as the dealer. Players take turns being the dealer.

After each player has been dealt the initial set of five cards, the first round of betting occurs at step 110. In a round of betting, each player is successively given the opportunity to either “pass” (i.e. to place no bet, allowed only if no one has previously placed a bet during the round), to “call” (i.e. to pay an amount into the pot equal to the total amount paid by the immediately preceding bettor), to “raise” (i.e. to pay an amount into the pot greater than the amount paid by the immediately preceding bettor), or to “fold” (i.e. to not pay anything into the pot and thereby to drop out of the game). The betting sequence typically starts with the player to the immediate left of the dealer, and then progresses in a clockwise direction.

FIG. 2 illustrates an example of a first round of betting that may occur at step 110 of FIG. 1. In the example of FIG. 2 there are three players: player A 200, player B 205, and player C 210. Player A is the dealer. In FIG. 2, the cards dealt to each player are shown under the player's name. Thus, after the deal, player A's hand is AA762, player B's hand is KK225, and player C's hand is JJ843.

Since player B is the player to the immediate left of the dealer (player A), player B opens the betting round. Player B may pass (bet nothing), or place a bet. Player B's hand contains two pairs, which player B considers to be a good first round hand. Accordingly, as shown in FIG. 2, player B bets one “bet” at step 215. In this example, betting “one bet” means that the bettor bets the maximum betting limit allowed by the rules of the particular variation of poker game being played. Two types of betting are “limit” betting and “pot limit” betting. In limit betting, the maximum betting limit is a predetermined amount. For example, a betting limit may be $2. In pot limit betting, the maximum amount that a player may bet is the total amount in the pot at the time the bet is made, including the amount, if any, that the bettor would need to put into the pot if the bettor were calling. Other types of betting are no limit betting, and spread limit betting, in which bets are allowed within a certain range (e.g. $2-$8).

After player B has bet, it is player C's turn to act. Since player B has bet one bet, player C's choices are to match player B's bet (“call”), to raise, or to fold. Player C has a pair of jacks, which player C considers to be good enough to call but not good enough to raise. Accordingly, as shown in FIG. 2, player C calls at step 220 by placing an amount equal to player B's bet into the pot.

After player C has bet, it's player A's turn. Player A has a pair of aces, which player A considers to be good enough for not just calling, but raising. Player A therefore decides to raise player B's bet by one bet at step 225. Player A thus places a total of two bets into the pot—one to meet B's bet, and one to raise by one bet. After player A raises one bet, the betting proceeds back to player B. Player B considers his two pair hand to be good enough to call player A's bet, but not good enough to reraise. Accordingly, player B calls at step 230 by putting one bet (the amount of player A's raise) into the pot so that the total amount bet by player B equals the total amount bet by player A.

After player B bets, the betting returns to player C. To stay in the game, player C must place one bet into the pot to match player A's raise. However, player C doesn't believe that player C's hand of two jacks is good enough to call player A's raise. Accordingly, player C decides to drop out of the game by folding at step 235.

After player C folds, there are no remaining uncalled raises or bets. Accordingly, the first round of betting ends at step 240. Thus, after the first round of betting, there are two remaining players, player A and player B.

The size of the pot in the example of FIG. 2 after the first round of betting depends on the size of the initial ante and the betting limit of the game. Table 3 illustrates the growth in the size of the pot during the round of betting illustrated in FIG. 2 for a betting limit of $1 and for a pot limit. In both cases, it is assumed that the total ante of all three players is $1.

TABLE 3
Size of Pot for Limit and Pot Limit Poker
For Example of FIG. 2

| Betting | | Resulting Pot | Resulting Pot |
|---|---|---|---|
| Step | Action | ($1 Limit) | (Pot Limit) |
| 0 | Ante | $1 | $1 |
| 1 | B bets 1 bet | $2 | $2 |
| 2 | C calls B's bet | $3 | $3 |
| 3 | A raises by 1 bet | $5 | $8 |
| 4 | B calls A's raise | $6 | $12 |
| 5 | C folds | $6 | $12 |

Thus, at the end of the first round of betting illustrated in FIG. 2, the resulting pot is $6 for $1 limit poker and $12 for pot limit poker.

Referring again to FIG. 1, at the end of the first round of betting at step 110, a determination is made as to whether more than one player is left in the game at step 115. If only one player is left, that player wins the pot at step 120. If more than one player is left, play continues to step 125.

At step 125, the players remaining in the game have the opportunity to discard cards from their hands and replace them with newly dealt cards. A player may discard and replace (or “draw”) from 0 to 5 cards.

After the “draw” at step 125, the second round of betting takes place at step 130. The second round of betting proceeds in the same manner as the first round of betting. FIG. 3 illustrates an example of a second round of betting that occurs after the first round of betting of FIG. 2. As shown in FIG. 3, player A and player B each drew 1 card during the draw. Player A could have drawn more cards, but player A chose to draw only one card to make it appear that player A had a better hand than player A's pair of aces. Player A discarded the lowest card of player A's hand (a 2), and was dealt a 9. Player A's resulting hand as shown in FIG. 3 is AA976.

Player B, starting off with four good cards (two pairs), also drew one card, discarding a 5 and being dealt a 7. Player B's resulting hand as shown in FIG. 3 is KK227.

The betting in round 2, as in round 1, commences with player B. As shown in FIG. 3, even though player B has a fairly good two pair hand, player B chooses to “check” (i.e., “pass) at step 300. A check is equivalent to a pass, or to betting zero. The betting then proceeds to player A. Although player A's hand is not particularly strong, player A decides to bet 1 bet at step 305, hoping that player B will believe that player A has a strong hand and therefore fold. Making a bet with a weak hand that probably will not win in a showdown is referred to as “bluffing.”

Player B does not fold, but instead raises player A by one bet at step 310. Player B thus pays two bets into the pot: one to meet player A's bet, and one to raise player A one bet. Player A, believing that player B's raise is a bluff, decides to reraise player B at step 315. Player A thus pays two more bets into the pot, one to match player B's raise and one for the reraise. Player B, not having bluffed, calls player A's reraise at step 320 by paying a bet into the pot to match player A's one bet reraise.

Player B's call of player A's reraise ends the second round of betting, leading to a showdown at step 325. The amount of money in the pot at the end of the second round of betting depends on whether the game is a limit game or a pot limit game. Table 4 shows the growth in the pot in the second round of betting for limit and pot limit games given the first round pot shown in table 3.

TABLE 4
Size of Pot for Limit and Pot Limit Poker
For Example of FIG. 3

| Betting | | Resulting Pot | Resulting Pot |
|---|---|---|---|
| Step | Action | ($1 Limit) | (Pot Limit) |
| 0 | Beginning pot | $6 | $12 |
| 1 | B checks | $6 | $12 |
| 2 | A bets 1 bet | $7 | $24 |
| 3 | B raises 1 bet | $9 | $72 |
| 4 | A reraises 1 bet | $11 | $216 |
| 5 | B calls | $12 | $324 |

As shown in Table 4, in a pot limit game, the size of the pot increases dramatically with each pot limit bet, while the increase of the pot in a limit game is more moderate.

Referring again to FIG. 1, after the second round of betting at step 130, a determination is made as to whether more than one player is left in the game at step 135. If only one player is left, the remaining player wins the pot at step 140. If more than one player remains in the game, there is a showdown at step 145. The remaining players show their hands, and the highest ranking hand wins the pot at step 150. In the example of FIG. 3, player B's hand of two pairs has a higher ranking than player A's hand of a pair of aces. Accordingly, player A's bluffing strategy proves unsuccessful, and player B wins the pot.

A large number of books and papers have been written on poker playing and poker playing strategies. Examples include “Winning Poker Systems” and “Computation of Optimal Poker Strategies” by Norman Zadeh (Wilshire Book Company, 1974 and Operations Research, Vol. 25, No. 4, July-August, 1977, respectively), “Poker Strategy” by Nesmith C. Ankeny (Perigee Books, 1981), “An Optimal Strategy for Pot-Limit Poker” by William H. Cutler (American Math Monthly, Vol. 82, April 1975), and “Theory of Games and Economic Behavior” by Von Neuman and Morgenstern (Princeton University Press, 1944).

Attempts have been made in the prior art to generate optimal poker playing strategies that will provide a player with the best average economic return for any given hand dealt to the player. Many of these attempts have focused on a player's average “expected return” for taking actions such as passing, calling, betting, raising and bluffing given a particular hand of cards.

The expected return for a given action, given a particular hand of cards in a particular game circumstance, is the average return to a player for taking the action if the action were repeated many times. The expected return is the sum of the actual returns for each repetition divided by the number of repetitions. A player's overall actual return for a particular game of poker is the player's winnings (if any) from the game minus the player's investment in the game (i.e. the amount the player pays into the pot over the course of the game). For example, Table 5 shows the investment, winnings, and the net actual return for each of the players A, B, and C in the game of FIGS. 2 and 3, assuming the game is a limit game in which the limit is $1 and the initial ante is $0.33. In Table 5 bets are indicated by minus signs, and winnings by plus signs.

TABLE 5
Overall Actual Returns for Players A, B, and C
For Example of FIGS. 2 and 3 (in dollars)

| Action | A | B | C | Total Pot |
|---|---|---|---|---|
| First Round | | | | |
| Ante | −0.33 | −0.33 | −0.33 | 1 |
| B bets 1 bet | 0 | −1 | 0 | 2 |
| C calls B's bet | 0 | 0 | −1 | 3 |
| A raises by 1 bet | −2 | 0 | 0 | 5 |
| B calls A's raise | 0 | −1 | 0 | 6 |
| C folds | 0 | 0 | 0 | 6 |
| Second Round | | | | |
| B checks | 0 | 0 | 0 | 6 |
| A bets 1 bet | −1 | 0 | 0 | 7 |
| B raises 1 bet | 0 | −2 | 0 | 9 |
| A reraises 1 bet | −2 | 0 | 0 | 11 |
| B calls | 0 | −1 | 0 | 12 |
| Total bet | −5.33 | −5.33 | −1.33 | |
| Showdown | 0 | +12 | 0 | |
| Net return | −5.33 | +6.67 | −1.33 | |

For the example game of FIGS. 2 and 3 therefore, the actual overall return for player A is −$5.33, for player B +6.67, and for player C −$1.33.

The returns shown in Table 5 are the overall returns to each player for the entire game. Expected and actual returns may also be calculated for specific parts of the game. For example, returns may be calculated for the second round of play only. In calculating returns for the second round of play, the amounts invested by the players during the first round of play may or may not be taken into account. In the case where first round investments are not taken into account, returns for the second round of betting are calculated based on the size of the pot at the beginning of the round and the amounts invested by the players during the second round. Table 6 shows the returns for the second round for remaining players A and B in the example of FIGS. 2 and 3, neglecting first round investments made by the players.

TABLE 6
2nd Round Actual Returns for Players A and B
For Example of FIGS. 2 and 3 (in dollars)

| Action | A | B | Total Pot |
|---|---|---|---|
| Beginning Pot | | | 6 |
| B checks | 0 | 0 | 6 |
| A bets 1 bet | −1 | 0 | 7 |
| B raises 1 bet | 0 | −2 | 9 |
| A reraises 1 bet | −2 | 0 | 11 |
| B calls | 0 | −1 | 12 |
| Total bet | −3.00 | −3.00 | |
| Showdown | 0 | +12 | |
| Net return | −3.00 | +9.00 | |

The second round actual returns for players A and B for the example of FIGS. 2 and 3 are thus −$3 and +$9, respectively.

Since the payments made by players A and B into the pot are omitted when calculating the second round investments and returns in Table 5, the returns shown in Table 5 can be considered to be actual returns to players A and B for a two-player second round contest in which player A's hand is AA762 and player B's hand is KK227, and in which the beginning pot is $6. The actions that player B took in this second round of betting were to check, to raise, and to call player A's reraise. This sequence may be referred to as a “check-raise-call” sequence. Similarly, the actions that A took in the second round of betting were to bet and to reraise. This sequence may be referred to as a “bet-reraise” sequence.

More generically, from player A's point of view, the situation at the time player A first acts in round two of betting for the example of FIG. 3 is:

a) There is a certain amount in the pot, in this case, $6.

b) Player A has a hand that has a specific rank. In this case, A's hand is AA762. If hands are assigned relative hand strength rankings between 0 and 1 (1 being highest), then the rank of player A's hand will be some number S between 0 and 1. (See, for example, Von Neuman and Morgenstern, “Theory of Games and Economic Behavior,” Princeton University Press 1944).

c) Player B has checked. Accordingly, the following sequence of actions are possible (assuming that the game is limited to one reraise):

a) Player A also checks, and there is an immediate showdown.

The sequence of A's action under this option is “check.”

b) Player A bets, and player B calls. The sequence of A's actions under this option is “bet.”

c) Player A bets, and player B folds, in which case player A wins the pot. The sequence of A's actions under this option is “bet.”

d) Player A bets, player B raises, and player A folds. The sequence of player A's actions under this option is “bet-fold.” In some cases, a “bet-fold” sequence is the result of a “bluff bet.” Player A hopes to cause player B to fold with the bet, but if player B answers with a raise, player A folds.

e) Player A bets, player B raises, player A reraises, and player B calls. The sequence of player A's actions under this option is “bet-reraise.”

f) Player A bets, player B raises, player A reraises, and player B folds. The sequence of player A's actions under this option is “bet-reraise.”

g) Player A bets, player B raises, and player A calls. The sequence of player A's actions under this option is “bet-call.”

Although there are seven separate scenarios that may occur, there are only five possible sequences of actions for player A: i) check; ii) bet; iii) bet-fold; iv) bet-reraise; and v)bet call. Since the second sequence (“bet”) is included in the third through fifth sequences, this list can further be reduced to four possible sequences of actions: i) check; ii) bet-fold; iii) bet-reraise; and iv) bet-call.

In the example of FIG. 3, the action sequence that player A chose to take was to “bet-reraise.” As shown in FIG. 34, the resulting return to player A was a loss of $3 (−$3).

From FIG. 3, the returns to player A if player A had taken each of the other three action sequences can be calculated.

For the “check” sequence, the result would have been that player B would have won the pot in the showdown. A's investment in the second round would have been $0, and A's winnings would have been $0. Therefore A's net return for a “check” would have been $0.

For the “bet-fold” sequence (bluff bet), A would have bet $1, B would have called, then A would have folded. A's investment would have been $1, and A's winnings would have been $0. A's net return for a bluff bet would have been −$1.

For the “bet-call” sequence, A would have bet $1, B would have raised, A would have called with a $1 bet, and B would have won the showdown. A's investment would have been $2, and A's winning $0. Thus A's net return for a “bet-call” sequence would have been −$2.

Table 7 summarizes the actual second round returns to Player A that would have resulted given the circumstances of FIG. 3 for each of Player A's four possible action sequences check, bet-fold, bet-call, and bet-reraise.

TABLE 7
Second Round Returns for Player A with Different
Action Sequences for Example of FIG. 3

| Action Sequence | Return |
|---|---|
| Check | $0 |
| Bet-fold (bluff bet) | −$1 |
| Bet-call | −$2 |
| Bet-reraise | −$3 |

From Table 7, it can be seen that by choosing the “bet-reraise” sequence in the example game of FIG. 3, player A chose the action sequence that resulted in the lowest actual return for the particular game of FIG. 3. Player A would have obtained the best possible return by following the first action sequence option: Check. If player A had known the actual outcome of the game, player A would have selected the “Check” action sequence.

However, it is impossible for player A to know, ahead of time, what cards player B holds, or what the particular outcome of a game will be. What player A knows is player A's own hand, the size of the pot, and that player B has checked. Since the specific outcome of any action sequence chosen by player A will depend on what cards B holds and how player B plays, it will be impossible for player A to predict the actual return for each action sequence in any particular game. However, if player A were able to play a large number of games in each of which player A has a hand having the same ranking S as in the example of FIG. 3, in which B checks, but in which B has a variety of hands, and if A recorded the outcome of each action sequence for each of the games, A could obtain an average expected return for each of the action sequences for the situation of a second round betting round in which A has a hand of ranking S and player B bets first and checks. Player A would then be able to determine which action sequence, in the long run, will result in the highest return for a hand of ranking S if player B uses the check-raise-call sequence.

Theoretically, by playing a large number of games for each of player A's possible hands, and by keeping track of the outcomes for each action sequence, player A could calculate the expected returns for each action sequence for each possible hand for each game situation. Player A would then know the best action sequence to choose for any hand. However, given there are over 2 million possible hands, such an endeavor is unfeasible.

Prior art attempts have been made to create mathematical models of poker that could be used to obtain optimal playing strategies. However, these prior art attempts have not been directly applicable for to real time poker games and poker playing systems.

### SUMMARY OF THE INVENTION

The present invention comprises an intelligent gaming system that includes a game engine, simulation engine, and, in certain embodiments, a static evaluator. One embodiment of the invention comprises an intelligent, poker playing slot machine that allows a user to play poker for money against one or more intelligent, simulated opponents. Another embodiment comprises a computer game system that allows a player to play a game simultaneously against an intelligent, simulated opponent and against a set of predetermined criteria. The invention can be used, for example, with any of a variety of card games, including, without limitation, poker games including five card draw, five card stud, seven card stud, hold'em, Omaha, and others, in high-ball, low-ball, and high-low configurations, and with specified betting limits, pot limits, no-limits, spread limits, etc. The simulation engine generates actions for the simulated player(s). The simulation engine allows a real person, or user, to play against intelligent, simulated opponents. In addition, in certain embodiments a static evaluator offers another level of play in which the user can play against a predetermined criteria for winning. In one embodiment of the invention, the user plays against simulated opponent(s). In another embodiment of the invention, the user plays against simulated opponent(s) and against the predetermined criteria.

The game engine controls the play according to the rules established for the game. Input is received from either the player or a simulated player and is processed by the game engine. A game can be thought of as comprising a set of action points at which either the user or a simulated player are requested to act. The game engine restricts the players to valid actions at the action points.

The gaming system allows either the user or a simulated player to be the first to act. The user can respond to a request for an action when it is the user's turn to act. The simulation engine determines the action taken by a simulated player. The simulation engine uses its knowledge of the current state of the game to determine the action or sequence of actions to be taken by the simulated player. The current state of the game can include, for example, the simulation engine's understanding of the probability of winning. The current state of the game can further include the point of the game at which an action is to be taken.

In one embodiment of the invention, the gaming system is an intelligent poker playing slot machine system. The poker playing system is comprised of two poker players one of which is the simulated player and the other is the user. The poker playing system includes input means for accepting bets from the user and output means for paying winnings to the user. The poker playing system allows a first round of betting, a draw, and a second round of betting. The first round action(s) includes the number of cards that the simulated player draws at the conclusion of the first round.

A set of action sequence triggering variables having associated values are used by the simulation engine to identify the simulated player's action(s). Each action sequence triggering variable identifies one or more actions to be taken by the simulated player. An action sequence triggering variable is identified and its value is used to determine the action(s) that are adopted for use by the simulated player.

Each action sequence triggering variable used to determine a strategic sequence of actions for the simulated player is associated with a hand rank (e.g., three of a kind or a pair of queens). The hand rank of the hand dealt to the simulated player is compared to appropriate action sequence triggering variables to determine the action sequence strategy to be used. In one embodiment, a value is associated with each variable that identifies a portion of time that an action(s) associated with the variable is to be taken.

In the first round, one or more applicable action sequence triggering variable(s) are identified using the simulated player's hand rank. A determination is made whether the action(s) associated with the chosen action sequence triggering variables are to be adopted using the values associated with the variables. For example, in one embodiment, a random number between zero and one is compared to a value associated with a variable that represents a percentage of time an action(s) associated with the variable is to be taken. If the random number is less than the percentage, a first action is taken. If the random number is greater than the percentage, a different action is taken. For example, if the action sequence triggering variable(s) specifies that the simulated player is to bet at an action point where the simulated player can only bet or fold, the fold action can be adopted if it is determined using the variable values that the bet action should not be taken.

In the second round, values for a set of action sequence triggering variables are determined. In one embodiment, the values are retrieved from a lookup table. In another embodiment, the values are dynamically generated by the intelligent poker playing system. The values can be stored in an initialization table. Each row contains a set of values that are used to initialize the action sequence triggering variables. The selection or generation of the values for the set of action sequence triggering variables is based on a set of game criteria. For example, the game criteria can be the number of cards that P1 (the first player to act) and P2 (the second player to act) drew and the size of the pot.

If the values for the action sequence triggering variables are pre-calculated, the game criteria is used to identify a row in the initialization table. Each column in the row contains a value for one of the action sequence triggering variables. The values for each action sequence triggering variable specifies a hand rank and a percentage. Further, a set of actions is associated with each action sequence triggering variable. In one embodiment, the percentage represents the portion of time an action associated with the variable is to be adopted by the simulated player in the case where the player has the exact hand rank specified by the variable.

In one embodiment that dynamically generates the values of the action sequence triggering variables, a multi-dimensional model is used to represent possible strategies that may be used by each player participating in a card game. Each axis (dimension) of the model represents a distribution of a player's possible hands. Points along a player's distribution axis divide each axis into a number of segments. Each segment has associated with it an action sequence to be undertaken by the player with hands that fall within the segment. The dividing points delineate dividing points between different action sequences. The model is divided into separate portions each corresponding to an outcome determined by the action sequences and hand strengths for each player applicable to the portion. An expected return expression is generated by multiplying the outcome for each portion by the size of the portion, and adding together the resulting products. The location of the dividing points that result in the maximum expected return is determined by taking partial derivatives of the expected return function with respect to each variable, and setting them equal to zero. The result is a set of simultaneous equations that are solved to obtain values for each dividing point. The values for the optimized dividing points define optimized card playing strategies.

A variable's hand rank is used to position the variable relative to the other variables in the set of action sequence triggering variables along a hand strength axis. A hand strength is determined for the simulated player's hand and compared to the values of the action sequence triggering variables. The value of the simulated player's hand strength relative to the value of the action sequence triggering variables determines the simulated player's action(s).

In one embodiment, the gaming system of the invention allows the simultaneous play by a user against one or more intelligent, simulated opponents and against a pre-determined payoff schedule. In one example, a poker playing slot machine is provided that allows a player to play simultaneously against an intelligent, simulated opponent and against a video-poker style payoff table. For a particular hand, a player may be awarded winnings based on the payoff table even if the player loses against the simulated opponent.

### BRIEF DESCRIPTION OF THE DRAWINGS

FIG. 1 is a flow chart illustrating a sequence of events in five card draw poker.

FIG. 2 is a schematic diagram illustrating a first round of betting.

FIG. 3 is a schematic diagram illustrating a second round of betting.

FIG. 4 provides an example of a general purpose computer that can be used with the present invention.

FIG. 5 provides an example of the system components according to one or more embodiments of the invention.

FIGS. 6A-6F provide a process flow for an intelligent “five card draw” poker game between two players according to an embodiment of the invention.

FIG. 7A illustrates possible first round actions according to one embodiment of the invention.

FIG. 7B illustrates possible first round actions where raises are limited according to one embodiment of the invention.

FIGS. 8A-8C provide a process flow for identifying a first round strategy for player P1 according to an embodiment of the invention.

FIGS. 9A-9C provide a process flow for identifying a first round strategy for player P2 according to an embodiment of the invention.

FIG. 10 illustrates possible second round actions according to one embodiment of the invention.

FIG. 11 illustrates possible second round actions in a game where raises are limited according to one embodiment of the invention.

FIG. 12 provides an example of a second round strategy lookup table used in one embodiment of the invention.

FIG. 13 illustrates actual columns for table 1500 of FIG. 12 according to an embodiment of the invention.

FIG. 14 illustrates the action sequence intervals given sample values for the action sequence triggering variables according to one embodiment of the invention.

FIG. 15 provides a second round process flow that uses the table of FIGS. 12-14 according to one embodiment of the invention.

FIGS. 16A-16B provide values for action sequence triggering variables for example pot sizes of 3 and 5.

FIGS. 17 and 18 illustrate slot machine embodiments of the intelligent card playing system of the invention.

FIG. 19 illustrates games in the model of FIG. 41 that correspond to resolution step 3826 of Table 21.

FIG. 20 illustrates games in the model of FIG. 41 that correspond to resolution step 3840 of Table 21.

FIG. 21 illustrates games in the model of FIG. 41 that correspond to resolution step 3854 of Table 21.

FIG. 22 illustrates games in the model of FIG. 41 that correspond to resolution step 3868 of Table 21.

FIGS. 23A to 23C comprise a flow chart illustrating a sequence of events in a two-player, one round game with check-raising.

FIG. 24 illustrates action sequences corresponding to different hand ranks in one embodiment of the invention.

FIG. 25 is an example of a two-dimensional model of the present invention.

FIG. 26 is an example of a two-dimensional model of the present invention.

FIG. 27 is a flow chart illustrating a sequence of events in a two-player, one round game without raising with pot-limit betting.

FIG. 28 illustrates action sequences corresponding to different hand ranks in one embodiment of the invention.

FIG. 29 illustrates an interpolation method used in one embodiment of the invention.

FIG. 30 illustrates an example computer system that may be used to implement an embodiment of the invention.

FIG. 31 is a flow chart of one embodiment of a computer implementation of the invention for a two-player game.

FIG. 32 illustrates a uniform cumulative distribution function for player P1.

FIG. 33 illustrates a uniform cumulative distribution function for player P2.

FIG. 34 is a flow chart illustrating a sequence of events in a two-player, one round game without raising.

FIG. 35 illustrates an example of a two-dimensional model of one embodiment of the invention.

FIG. 36 illustrates further development of the two-dimensional model of FIG. 35.

FIG. 37 is a flow chart of steps used in one embodiment of the invention to generate improved card playing strategies.

FIGS. 38A and 38B comprise a flow chart illustrating a sequence of events in a two-player, one round game with raising but no check-raising.

FIG. 39 is an example of a two-dimensional model of the present invention.

FIG. 40 illustrates action sequences corresponding to different hand ranks in one embodiment of the invention.

FIG. 41 shows the model of FIG. 39 divided into regions using the action sequence triggering variables of FIG. 40.

FIG. 42 illustrates games in the model of FIG. 41 that correspond to resolution step 3824 of Table 21.

FIG. 43 illustrates games in the model of FIG. 41 that correspond to resolution step 3838 of Table 21.

FIG. 44 illustrates games in the model of FIG. 41 that correspond to resolution step 3851 of Table 21.

FIG. 45 illustrates games in the model of FIG. 41 that correspond to resolution step 3866 of Table 21.

FIG. 46 illustrates games in the model of FIG. 41 that correspond to resolution step 3812 of Table 21.

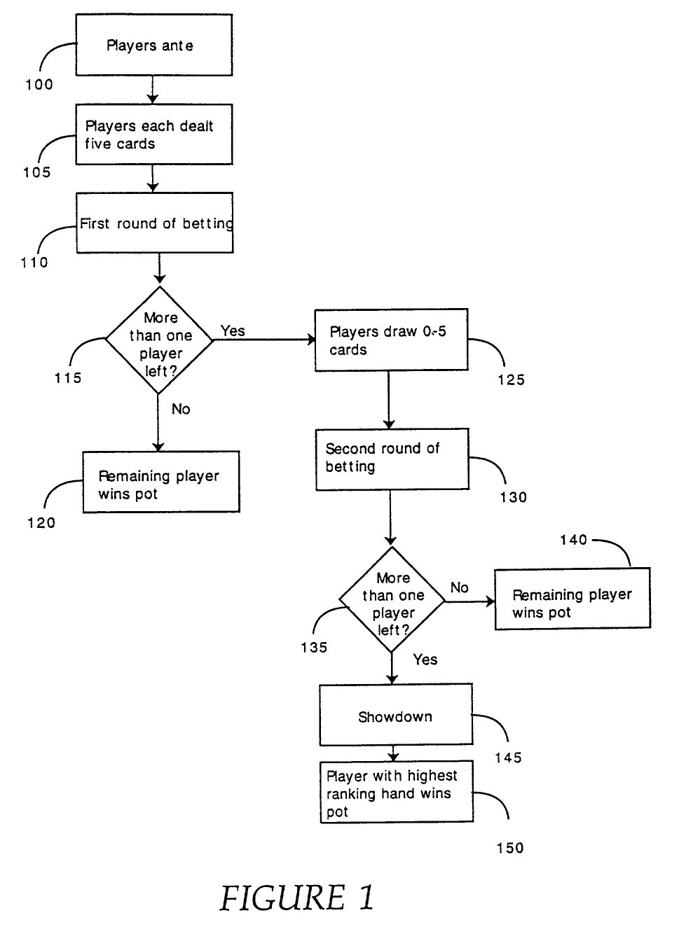

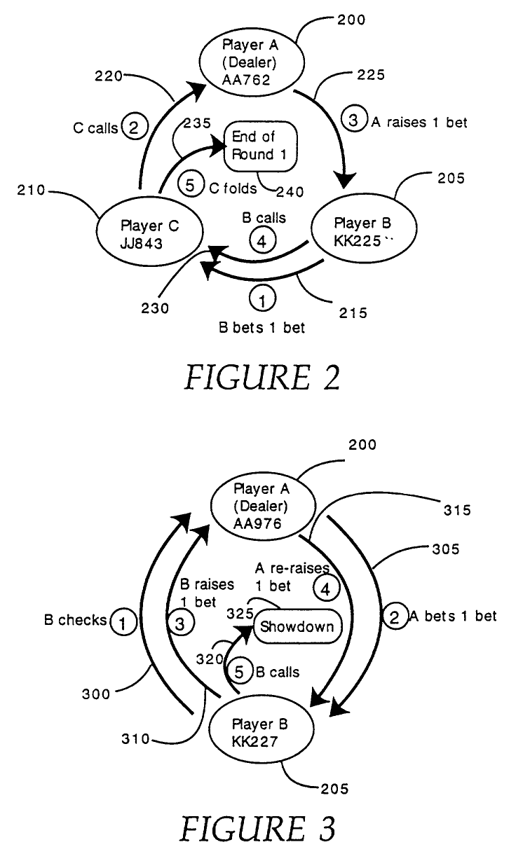

### DETAILED DESCRIPTION OF THE INVENTION

A computer gaming system is described. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

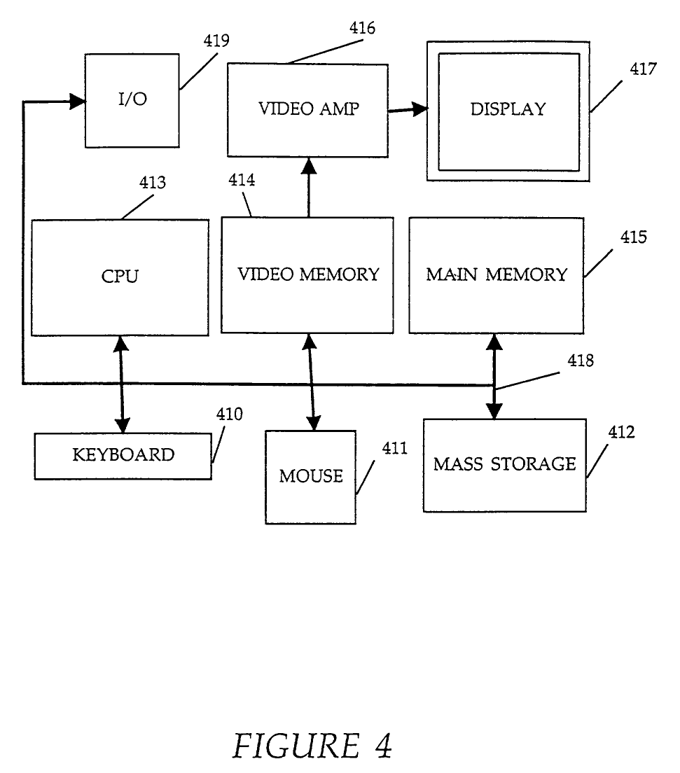

The present invention can be implemented on a general purpose computer such as illustrated in FIG. 4. A keyboard 410 and mouse 411 are coupled to a bi-directional system bus 418. The keyboard and mouse are for introducing user input to the computer system and communicating that user input to CPU 413. The computer system of FIG. 4 also includes a video memory 414, main memory 415 and mass storage 412, all coupled to bidirectional system bus 418 along with keyboard 410, mouse 411 and CPU 413. The mass storage 412 may include both fixed and removable media, such as magnetic, optical or magnetic optical storage systems or any other available mass storage technology. Bus 418 may contain, for example, 32 address lines for addressing video memory 414 or main memory 415. The system bus 418 also includes, for example, a 32-bit DATA bus for transferring DATA between and among the components, such as CPU 413, main memory 415, video memory 414 and mass storage 412. Alternatively, multiplex DATA/address lines may be used instead of separate DATA and address lines.

CPU 413 may be any suitable microprocessor such as, for example, the Pentium™ processor manufactured by Intel. Main memory 415 is comprised of dynamic random access memory (DRAM). Video memory 414 is a dual-ported video random access memory. One port of the video memory 414 is coupled to video amplifier 416. The video amplifier 416 is used to drive the cathode ray tube (CRT) raster monitor 417. Video amplifier 416 is well known in the art and may be implemented by any suitable means. This circuitry converts pixel DATA stored in video memory 414 to a raster signal suitable for use by monitor 417. Monitor 417 is a type of monitor suitable for displaying graphic images.

The computer system described above is for purposes of example only. The present invention may be implemented in any type of computer system or programming or processing environment. The invention may be implemented by means of software programming on this or another computer system.

Overview

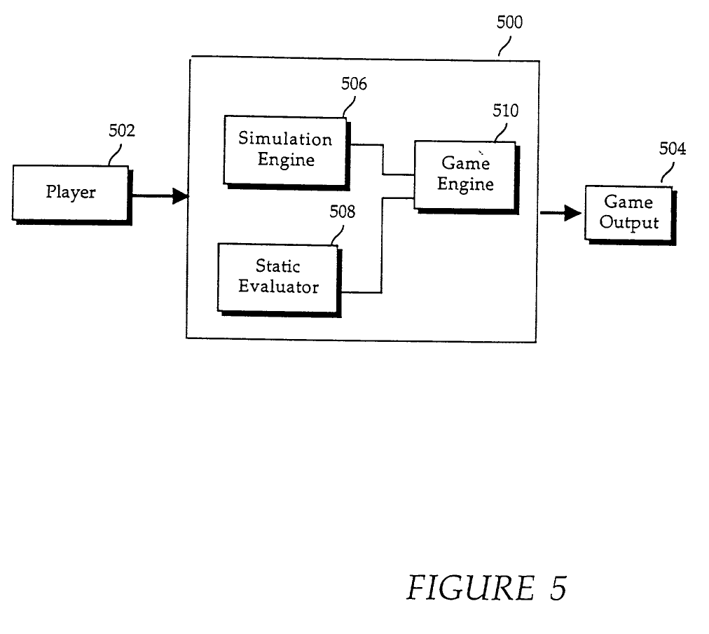

Embodiments of the invention comprise an intelligent gaming system in which a user-player is pitted against one or more intelligent, simulated opponents. In another embodiment, the gaming system further allows the user to play against an intelligent, simulated opponent and against a predetermined set of results or aspects of the game. In one embodiment, the gaming system is an intelligent poker playing system in which a user-player plays poker against an intelligent, simulated poker player and a predetermined payoff table. FIG. 5 provides an example of the system components according to an embodiment of the invention.

System 500 comprises game engine 510, simulation engine 506 and static evaluator 508. Game engine 510, simulation engine 506 and static evaluator 508 can be implemented as software that runs in the system of FIG. 4, for example. System 500 interacts with player 502 to obtain input from player 502. Simulation engine 506 generates actions for the simulated player that becomes input to game engine 510. Input from player 502 and simulation engine 506 is received and processed by game engine 510. System 500 generates output 504 that is displayed to player 502. Output 504 includes messages prompting player 502 for input, messages describing the action(s) taken by the simulated player, and status messages that describe an interim or final status of the game (i.e., whether the simulated player or player 502 is winning the game).

Simulation engine 506 identifies the action(s) that the simulated player takes during the course of a game. Simulation engine 506 evaluates the current state of the game including the actions that have already been taken by the players and chooses an action or actions for the simulated player from among the set of currently valid actions. The action(s) identified by simulation engine 506 and player 502 are processed by game engine 510.

Player 502 can compete against some static measurements in some embodiments of the invention. Static evaluator 508 compares some aspect or level of play by player 502 against a predetermined set of criteria. If player 502 achieves an acceptable level of play based on the predetermined set of criteria, player 502 wins the static competition.

Intelligent Poker Playing System

The invention is described herein with reference to an intelligent poker playing system and in particular to “five card draw.” However, it should be apparent that the invention can be applied to other card games including other poker games (e.g., “five card stud,” “seven card stud,” “hold'em,” and “Omaha”). The invention can be applied to any game in which strategies are used to identify an action during the game. The following provides a process flow for system 500 that implements a poker gaming system.

Further, the intelligent poker playing system is described using a single user-player pitted against one intelligent, simulated player. However, it should be apparent that the invention can be practiced with varying numbers of user-players and intelligent, simulated players. Thus, for example, one user-player can be pitted against more than one intelligent, simulated player, or vice versa. Further, multiple user-players can be pitted against multiple intelligent, simulated players.

In “five card draw,” each player is dealt five cards after placing an initial bet. A player evaluates his hand and adopts a strategy for playing the hand. A player's strategy determines the action(s) taken by the player. For example, in a two player “five card draw” poker game, player 1, P1, can adopt one strategy, if he believes that his hand is likely to be a “winning” hand. In that case, P1 opens the betting and then reraises if player 2, P2, raises P1's bet. If P1 believes that his hand has less potential to beat P2's hand, P1 can adopt a strategy to open with a bet, but fold, if P2 raises P1's opening bet. Even if P1 believes his hand is not that strong, P1 may adopt a strategy to try to bluff P2 into believing that his hand is a “winning” hand. In that case, P1 can open with a bet and reraise P2's bet. P1's strategy may be simply to fold when P1 believes that his hand has no value.

P1 can modify or adopt a new strategy during the game. The size of the pot may cause P1 to change strategies, for example. Further, P1 may adopt different strategies between rounds (e.g., before and after the draw). Similarly, P2 can adopt one or more strategies during a game. Simulation engine 506 can simulate the play of either P1 or P2.

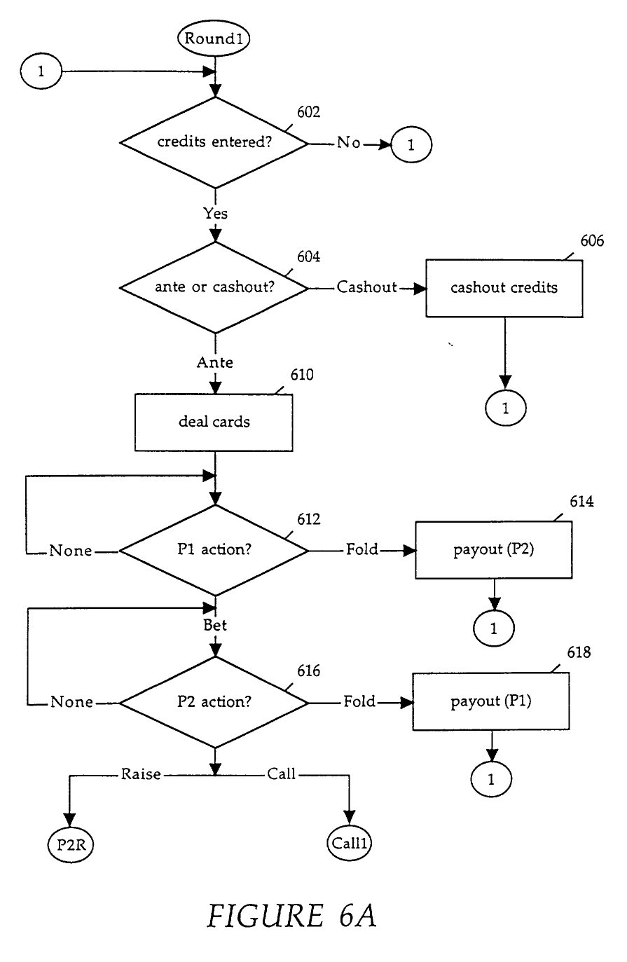

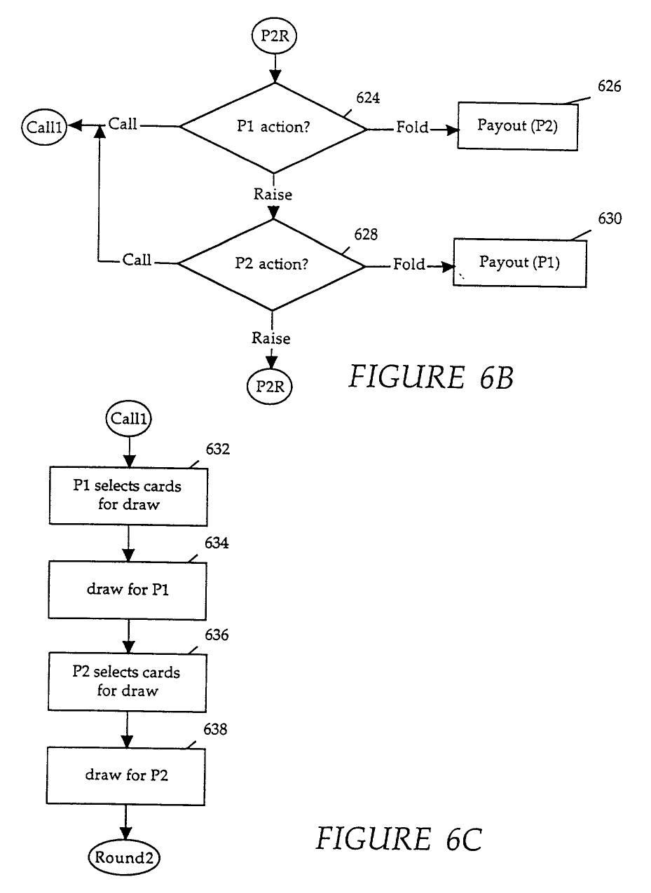

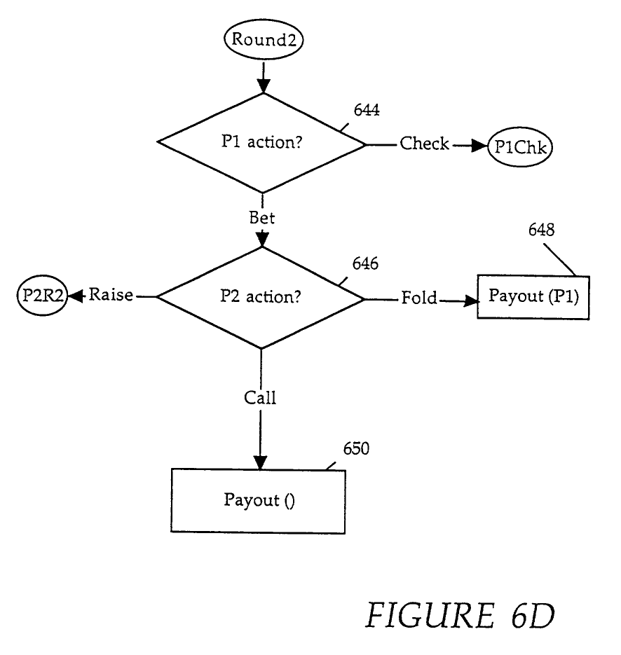

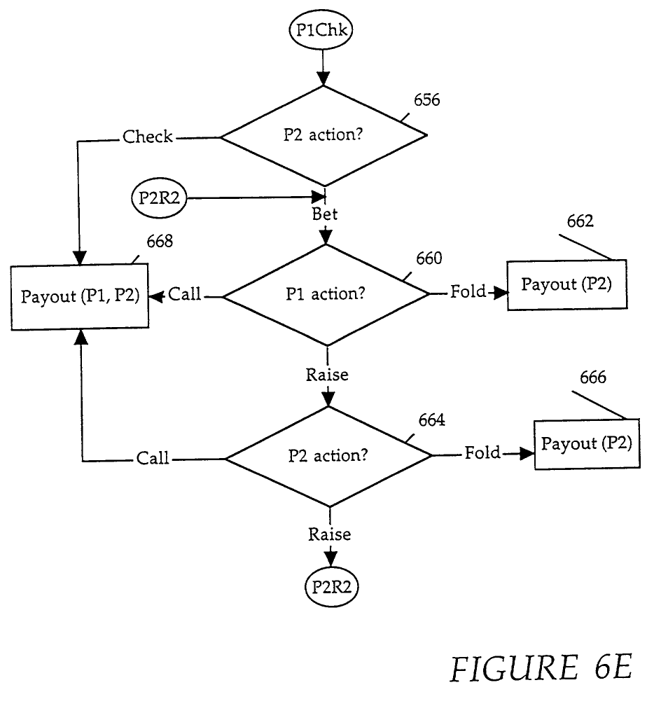

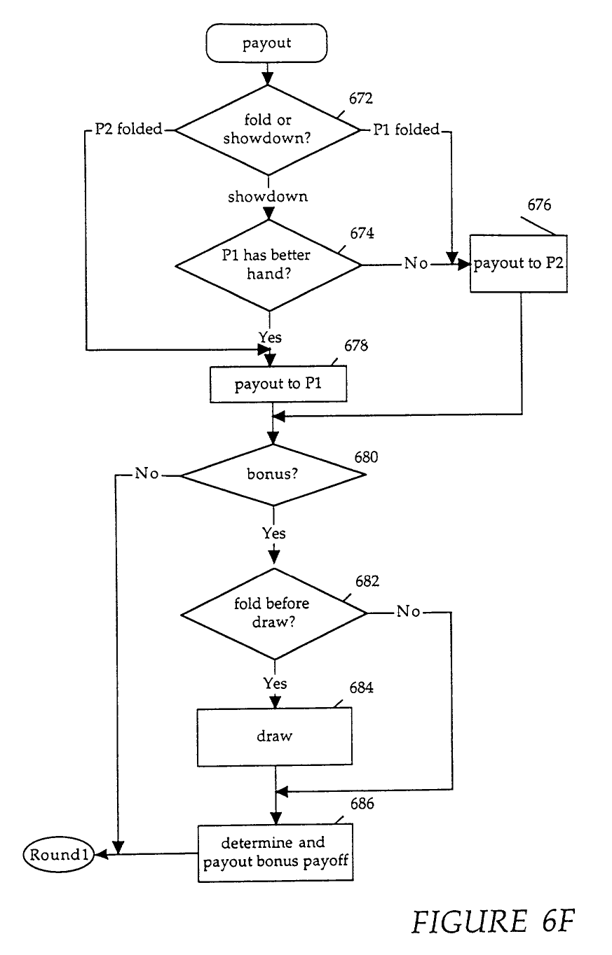

FIGS. 6A-6F provide a process flow for a video “five card draw” poker game between two players according to an embodiment of the invention. Either P1 or P2 is player 502 with the other being simulated using simulation engine 506. The simulated player can be P1 in one game and P2 in another game. After player 502 enters money (or credits or tokens), the cards are dealt to each player and a first round of betting commences.

At step 602, a determination is made whether player 502 has entered some amount of credit (or token). After player 502 enters credits, the game begins with each player contributing an initial amount to the pot (i.e., “an ante”). Alternatively, player 502 can cashout to retrieve the credits. Thus, at step 604, a determination is made whether player 502 “anted” or made a “cashout” request. If it is determined that player 502 entered a “cashout” request, processing continues at step 606 to return the player's credits. From step 606, processing continues at step 602 to await the start of another game.

If player 502 “anted”, processing continues at step 610 to deal the cards to P1 and P2. At step 612 (“P1 action?”), a determination is made whether P1's action is to bet or to fold. If P1folds at step 612, processing continues at step 614 to payout the pot to P2 (see FIG. 6F for an example of a payout and static evaluation process flow according to an embodiment of the invention). Processing continues at step 602 to await the start of another game or termination of play.

If P1's action was to bet at step 612, processing continues at step 616 to wait for P2's action. P2 has the option to fold, raise, or call. If P2 folds at step 616, processing continues at step 618 to process the payout to P1and processing continues at step 602.

If P2 raises P1's bet, processing continues at step 624 to wait for P1's action. P1 can call, raise P2's raise, or fold. If P1 folds, the pot is paid out to P2 at step 626. If P1 raises P2's raise, processing continues at step 628 to wait for P2's response. If P2 raises P1's raise at step 628, processing continues at step 624 to await P1's action. The sequence of one player raising another player can continue until a raise limit is reached, or one player calls the other's raise. To implement a raise limitation, a step can be added to the steps of FIG. 6B to examine the number of raises against a raise threshold. If the number of raises has reached the threshold, a player's valid actions can be limited to either folding or calling. Further, if either P1 or P2 call the other player's bet (at steps 624 or 628, respectively), processing continues at step 632.

If either player calls the other player's bet, the first round of betting ends and processing continues at step 632 at which each player may draw cards. At step 632, P1 selects the cards to be discarded. A set of replacement cards is drawn by P1 at step 634. Similarly, at steps 636 and 638, P2 discards and draws zero or more cards.

Processing continues at step 644 (FIG. 6D) where the second round opens with P1's action. P1 can either pass (i.e., check) or bet. If P1 passes, processing continues at step 656 (FIG. 6E) to await P2's response. If P2 checks in response to P1's check, a showdown occurs with a payout being given at step 668 to the player with a highest ranking hand.

If P1 opens the second round of betting at step 644 with a bet, processing continues at step 646 to await P2's action. P2 can raise, call or fold in response to P1's bet. If P2 raises P1's bet, processing continues at step 660 to await P1's action. If P2 folds at step 646 after P1 opens with a bet, processing continues at step 648 to award the pot to P1. If P2 calls P1's bet, processing continues at step 650 to pay the pot to the player with the higher ranking hand.

If P2 raises P1's opening bet or bets after P1 passes, processing continues at step 660 to await P1's responsive action. P1 can call, fold or raise. In an embodiment in which check-raising is not allowed, however, P1 would only have the option to call or fold at step 660. If P1 folds, the pot is paid to P2 at step 662. If P1 calls, the pot is paid to the player with the higher ranking hand. If P1 raises P2's bet, processing continues at step 664 to await P2's response. Steps 660 and 664 can repeated with each player responding to the other's raise until one of the player's calls, or runs out of money.

Payout and Static Evaluator

FIGS. 6A-6E refer to a payout step that awards the pot to the winner of the game. Where one of the players folds, the winner is the player that did not fold. Where neither folded and play ended in a showdown, the winner is the one having a higher ranking hand. The pot is paid to the winner. In an embodiment of the invention, the system further includes a payout to player 502 when player 502 has a hand ranking that meets or beats a threshold hand ranking. Static evaluator 508 compares player 502's hand and the threshold to determine whether player 502 is a winner. FIG. 6F provides an example of a payout and static evaluation process flow according to an embodiment of the invention.

At step 672, a determination is made whether the game ended in a showdown or because one of the players folded. If one of the players folded, processing continues by awarding the pot to the other player. Thus, if it is determined at step 672 that P1 folded, the pot is awarded to P2 at step 676. If P2 folded, the pot is awarded to P1 at step 678.

At step 680, if it is determined that the static evaluation feature of the system is active, processing continues at step 682 to allow player 502 to play against a predetermined payoff table (i.e., bonus play). The process flow of FIG. 6F allows player 502 to play the bonus round whether or not player 502 folded. Alternatively, static evaluator 508 can limit bonus play such that player 502 is prohibited from bonus play when player 502 folded.

At step 682, a determination is made whether the fold action occurred prior to the draw. If the game against the simulated player ended in the first round, static evaluator 508 allows player 502 to draw zero to five cards at step 684. After player 502 is allowed a draw (either in simulated or bonus play), static evaluator 508 determines whether a bonus is payable to player 502 and pays any such bonus at step 686. The determination is based on a predetermined set of criteria such as the ranking assigned to a player's hand. Referring to Table 1, for example, a threshold can be set at three of a kind. Thus, a bonus is paid for a hand rank in category six of Table 1 (i.e., three of a kind). The threshold for payment of a bonus can be raised or lowered. For example, the threshold can be raised to pay a bonus for hands in category 4.

A bonus can be paid based on a graduated payback structure for a hand that meets or exceeds the threshold. The amount paid as a bonus can be a set amount for each card ranking. Alternatively, a graduated bonus can be paid depending on the rank of the hand. Table 8 provides an example of a graduated bonus structure.

TABLE 8
Graduated Payback

| Rank | Bonus |
|---|---|
| Pair of Jacks or Better | 1 |
| Two Pair | 2 |
| Three of a Kind | 3 |
| Straight | 4 |
| Flush | 5 |
| Full House | 8 |
| Four of a Kind | 80 |
| Straight Flush | 100 |
| Royal Flush | 488 |

In the graduated jackpot example provided in Table 8, a bonus is paid to player 502 for a hand ranking of a pair of jacks or better. If, for example, player 502 has three of a kind, he is paid 3 units (e.g., three dollars). If player 502 has a royal flush, he is paid 488 units. If player 502 has a pair of tens, he does not receive a payback.

Static evaluator 508 can be used to award a jackpot amount that reflects contributions from multiple players including player 502. When a player meets or exceeds the threshold ranking, the jackpot is paid out to that player. Player 502 can therefore compete against other system users to win the jackpot that includes the contributions made by other players into the jackpot. Each player plays against the predetermined bonus threshold. Each user can interact with the same or different instances of system 500 to contribute an amount to the bonus jackpot.

First Round

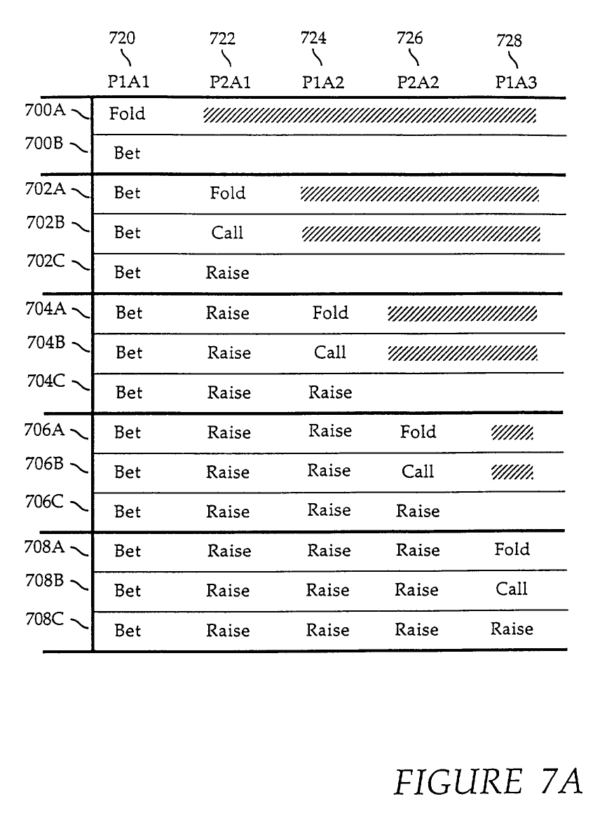

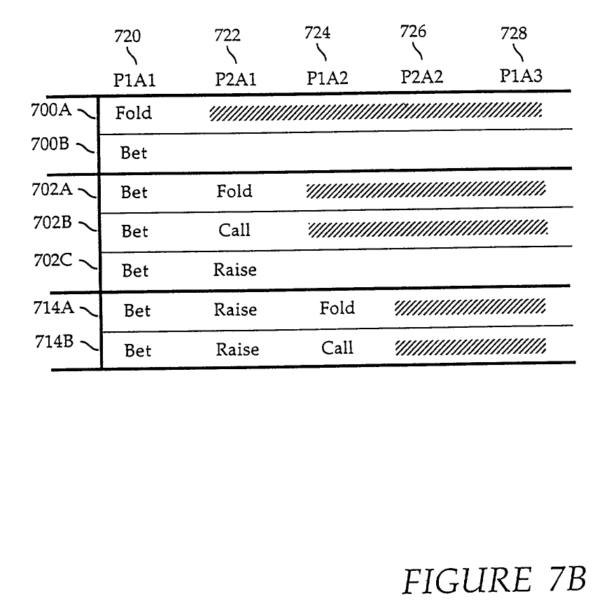

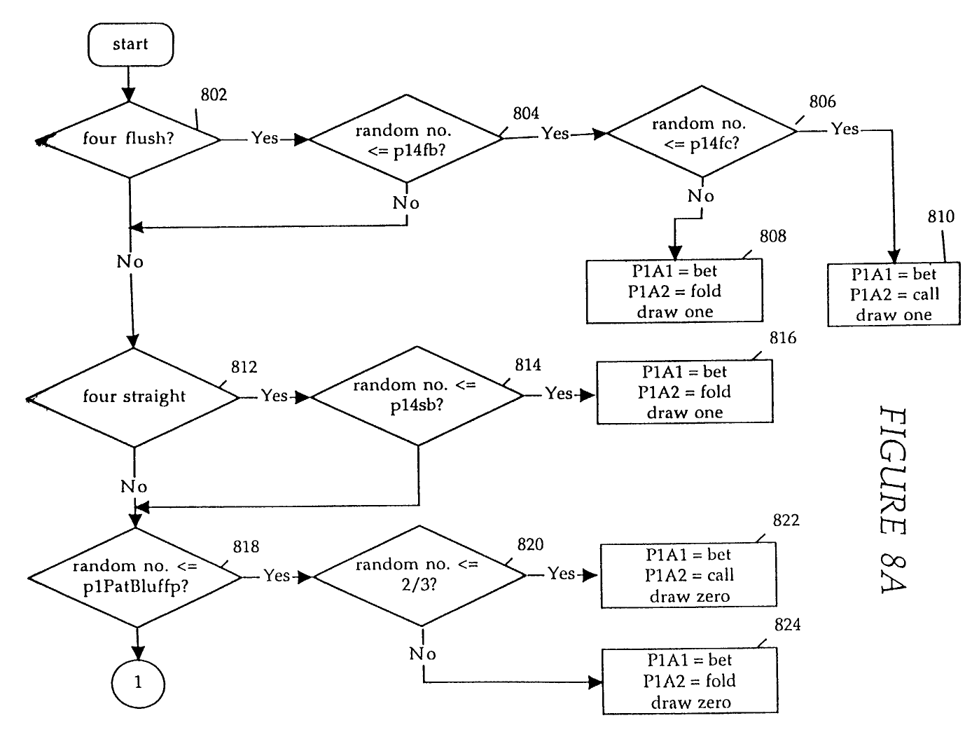

As illustrated in FIGS. 6A-6F, the first round of the intelligent poker playing system includes points at which a player (e.g., player 502 or the simulated player) must take an action. A player selects an action from the set of available actions that is a subset of the set of actions (e.g., pass or check, fold, call, bet and raise). P1 and P2 continue the first round until one of the players either calls or folds. FIG. 7A illustrates possible first round actions according to one embodiment of the invention.

Columns 720-728 identify the five action points in the first round. For example, column 720 corresponds to step 612 of FIG. 6A. Columns 722, 724, 726 and 728 correspond to steps 616, 624, 628, and 624, respectively, of FIGS. 6A-6B. Rows 700A-700B, 702A-702C, 704A-704C, 706A-706C, and 708A-708C indicate the specific actions available to the players. For example, column 720 (P1A1) represents the first action by P1. In this embodiment, according to rows 700A-700B, the possible actions for P1 for the P1A1 action are either bet or fold (in other embodiments, other actions for P1A1 may be allowed, such as, for example, bet or pass). If P1 folds, P2 is awarded the pot and play ends. Therefore, no actions are identified for columns 722-728.

Rows 702A-702C illustrate the possible first actions for P2 (P2A1), if P1A1 is a bet. Referring to column 722, P2A1 can be a fold, call or raise. If P2 folds in response to P1's bet (row 702A), the pot is paid to P1 and play ends. If P2 calls (row 702B) there is a showdown, and the pot is paid to the player with the highest hand. Rows 704A-704C illustrate the possible second actions for P1 (P1A2), if P2A1 is a raise (i.e., fold, call or raise). If P1A2 is a fold (row 704A), the pot is paid to P2 and play ends. If P1A2 is a call (row 704B), there is a showdown and the pot is paid to the player with the highest hand. If P1A2 is a raise, play turns to P2 for an action. P2's response (P2A2) is represented in rows 706A-706B. If P2A2 is a fold or call, play ends. If P2A2 is a raise, P1 can respond (P1A3) by folding, calling or raising (rows 708A-708C).

If P1 and P2 continue to raise as illustrated, play can continue (i.e., P1An and P2An). In fact, play can continue indefinitely until a player calls the other's bet, folds, or runs out of money. Referring to FIG. 6B, the process flow can continue at steps 624 and 628 until either P1 or P2 folds or calls. Alternatively, system 500 can limit the number of possible raises. That is P1 and P2 are limited in the number of times each can raise the other's bet.

FIG. 7B illustrates possible first round actions in a game where the number of raises is limited according to one embodiment of the invention. Referring to rows 700A-700B, P1A1 can be a fold or bet. As illustrated in rows 702A-702C, in response to a betting action for P1A1, P2A1 can be a fold, call or raise. However, referring to rows 714A-714B (P1A2), P1 is limited to either calling P2's raise or folding. Therefore, the first round is guaranteed to end no later than P1A2.

The available actions for P1 and P2 are illustrated in FIGS. 7A-7B. A player must choose an action at each action point (e.g., P1A1, P2A1, P1A2, etc.). A player typically develops a strategy for playing and selects an action based on the strategy. A player's strategy determines the action(s) taken by the player. A player's strategy in the first round is typically based on the player's hand. A hand that a player believes to be a “winning” hand may prompt a different strategy than one that the player believes is a “losing” hand. For example, a player may consider that three of a kind or better is a “winning” hand. Another player may consider that two pair or better to be a “winning” hand. Conversely, one pair or lower may be considered a “losing” hand. Thus, for example, a player may fold with a one pair or lower hand. However, a player may adopt the strategy typically used with a “winning” hand even though he perceives his hand to be a “losing” hand in an effort to bluff the other player into folding.

Example Embodiment of First Round Strategy

In the first round, it is assumed that P1 and P2 have an equal chance of winning. That is, each player has an equal chance of being dealt a “winning” hand. In one embodiment, the initial strategy used by either player is based on the rank of the player's hand. In another embodiment of the invention, the initial strategy based on a hand's rank is ignored in favor of another strategy. The strategy identifies the action a player takes at an action point, and the actions taken to reach an action point. In a preferred embodiment, the first round strategy further identifies the number of cards the player is to draw at the conclusion of round one.

Since player 502 can be either P1 or P2, a technique is provided to identify a first round strategy for either P1 or P2. While a particular strategy identifies the action to take given the other player's action, the selection of the simulated player's strategy is independent of the strategy adopted by player 502. Thus, the simulated player's strategy is not simply an imitation of the action(s) taken by player 502.

In one embodiment of the invention, a set of first round action sequence triggering variables are identified that identify a player's strategy. Each variable has an associated numeric value that represents the percentage of times that a player adopts the strategy associated with the variable. The strategy identifies the action to be taken by a player at the player's action points.

In addition, the strategy identifies the drawing action. For certain hands, the number of cards to draw is straightforward based on the player's hand. For example, both P1 and P2 draw no cards with any straight, flush or full house; draw 1 card with two pair; draw three cards with a pair; draw three cards with an ace-high hand. P1 will occasionally draw 1 card to four-card flushes or four-card straights, or may bluff and stand pat (draw no cards) with an otherwise non-betting hand. A strategy specifies a particular number of cards for the draw, or specifies that the draw is based on the hand.

One set of action sequence triggering variables is associated with P1 while another set is associated with P2. Each player's variables are used to determine the action sequences associated with a particular strategy used in round one. The values assigned to each variable are used to determine whether or not to adopt the action(s) associated with the variable. Table 9 provides examples of variables used to determine P1's first round strategy as well as sample values and descriptions. It should be apparent that other values can be used for these variables and that other variables can be used as a supplement or replacement for these variables.

TABLE 9
Player 1 Variables

| Variable | Action 1 | Action 2 | | |
|---|---|---|---|---|
| Name | (P1A1) | (P1A2) | Value | Description |
| p1PatBluffP | bet | | 0.003664 | Probability that P1 |
| | | | | bluffs and stands pat |
| | | | | with a no pair hand |
| P14fc | bet | call | 0.8435 | Probability that P1 |
| | | | | bets and calls, if raised |
| | | | | by P2, with a four |
| | | | | flush hand and draws |
| | | | | 1 card. |
| p14fb | bet | fold | 1.0 | Probability that P1 |
| | | | | bets with a four flush |
| | | | | hand and then folds (if |
| | | | | raised) or draws 1 card |
| | | | | (if P2 called). |
| p14sb | bet | fold | 0.24 | Probability that P1 |
| | | | | bets with a four |
| | | | | straight hand and then |
| | | | | folds (if raised) or |
| | | | | draws 1 card (if P2 |
| | | | | called). |
| p1qlop | bet | fold | 0.0 | Probability that P1 |
| | | | | opens (bets) with a |
| | | | | queen high or lower |
| | | | | hand. |
| p1qlca | bet | call | 0.0 | Probability that P1 |
| | | | | opens and calls (if |
| | | | | raised) with a queen |
| | | | | high or lower hand. |
| p1khop | bet | fold | 0.28 | Probability that P1 |
| | | | | opens with a king |
| | | | | high hand. |
| p1khca | | call | 0.0 | Probability that P1 |
| | | | | calls with a king |
| | | | | high hand. |
| p1ahop | bet | | 1.0 | Probability that P1 |
| | | | | opens with an ace |
| | | | | high hand or better. |
| p1ahca | bet | call | 1.0 | Probability that P1 |
| | | | | calls with an ace |
| | | | | high hand or better. |

Note:
P1 bets and calls if raised with all hands better than ace high.

The strategies associated with the variables of Table 9 assume a game in which raises are limited as described with reference to FIG. 7B. Referring to FIG. 7B, P1 has two action points, P1A1 and P1A2, in round one. The possible actions for P1A1 are fold or bet. If the strategy specifies that P1A1 is a bet action, a P1A2 action is specified. The possible P1A2 actions are fold or call. Thus, if P2 raises in response to a P1A1 bet action, P1A2 specifies whether P1 is to call or fold in response to P2's P2A1 action. The strategy adopted by P1 identifies the actions for the P1A1 action point and, if necessary, the P1A2 action point.

The strategy that is adopted by P1 is determined using the variables identified in Table 9. A value is assigned to a variable that represents the percentage of time that a variable's strategy is adopted. This value is examined before a variable's strategy is adopted. For example, a value of 50 percent (i.e., 0.50) associated with a variable suggests that the variable's strategy should be adopted fifty percent of the time. A random number is used in one embodiment that ranges from 0 to 1. A variable's percentage is compared against the random number to determine whether the variable's action(s) is used.

Each variable is associated with a hand rank. That is, one or more variables are selected to determine a player's strategy based on the ranking of the player's hand. Table 10 categorizes the variables of Table 9 into their respective rankings.

TABLE 10
Player 1 Variables

| | Variables |
|---|---|
| Hand | Player 1 |
| Straight Flush | * |
| Four of a Kind | * |
| Full House | * |
| Flush | * |
| Straight | * |
| Three of a Kind | * |
| Two Pair | * |
| One Pair | * |
| No Pair | p1PatBluffp |
| Ace High | p1ahop, p1ahca |
| King High | p1khop, p1khca |
| Queen High | p1qlop, p1qlca |
| Four Flush | p14fc, p14fb |
| Four Straight | p14sb |

*P1 always bets and calls if raised with all hands better than ace-high.

To illustrate, assume that P1 has a four flush hand. Referring to Table 10, the p14fc and p14fb variables are associated with a four flush. Referring to Table 9, if the strategy suggested by the p14fc variable is adopted, P1 bets at action point P1A1 and calls at action point P1A2. If the p14fb variable is used, P1 bets at action point P1A1 and folds at action point P1A2. The values associated with the p14fc and p14fb variables are used to determine which strategy (i.e., the bet-call strategy of p14fc or the bet-fold strategy of p14fb) is adopted. The values assigned to the p14fc and p14fb variables are 0.8435 and 1.0, respectively. That is, the bet-call strategy is adopted eighty-five percent of the time when P1 receives a four flush. The remaining portion of the time, the bet-fold strategy is adopted for P1.

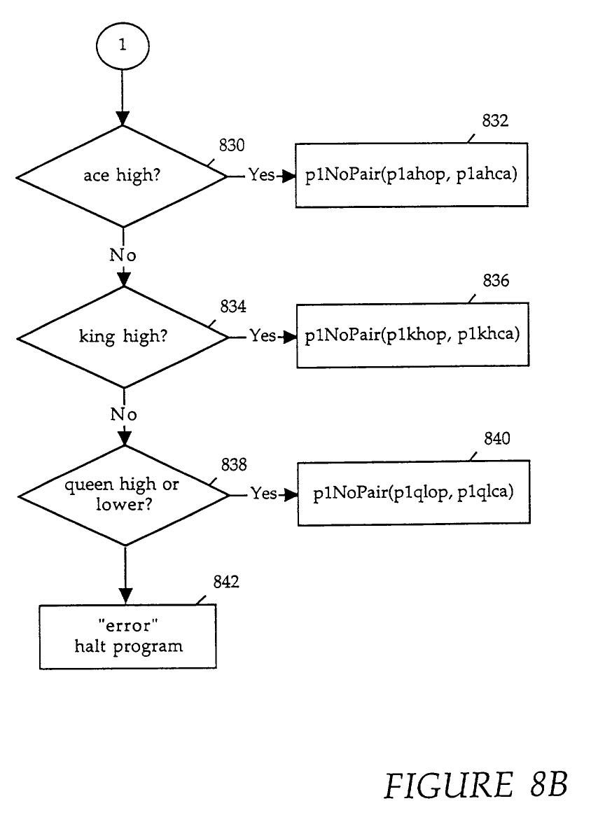

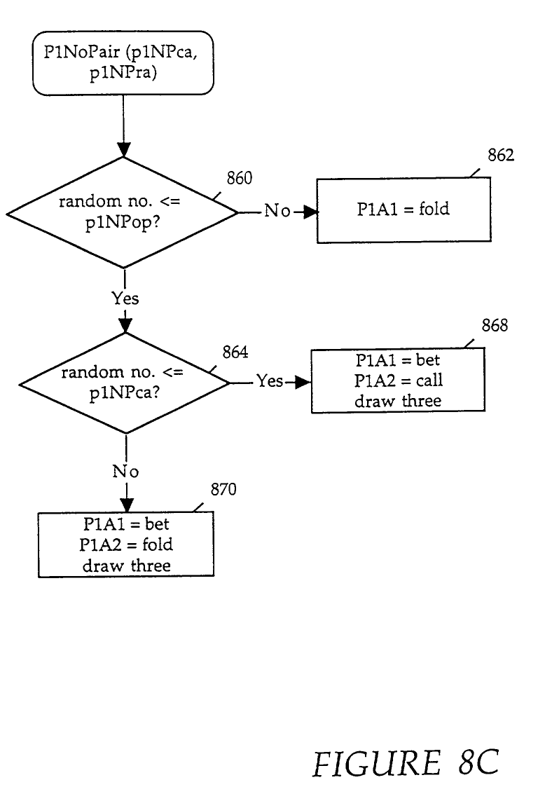

FIGS. 8A-8C provide a process flow for identifying a first round strategy for player P1 when P1 receives a hand with a rank less than one pair according to an embodiment of the invention. If P1 receives a hand with a rank of greater than or equal to one pair, P1 will adopt the bet-call strategy. Once the ranking of the hand is determined, the variables associated with the ranking are used to select a strategy and identify the action(s) to be taken by P1. Where a draw action is not determined based on the hand, a specific draw is specified for P1. In some cases, a random number is compared against the value of a variable in Table 10 to determine whether to adopt the strategy associated with the variable.

At step 802, a determination is made whether P1 has a four flush. If so, processing continues at step 804 to determine whether the random number is less than or equal to p14fb. If not, processing continues at step 812. If it is determined, at step 804, that the random number is less than or equal to p14fb, processing continues at step 806. A determination is made at step 806 whether the random number is less than or equal to p14fc. If not, processing continues at step 808 to specify a bet action for P1A1, a fold action for P1A2, and a one card draw. If the random number is less than or equal to p14fc, processing continues at step 810 to specify a bet action for P1A1, a call action for P1A2, and a one card draw.

If it is determined (at step 802) that P1 does not have a four flush or that the random number is greater than p14fb (at step 804), processing continues at step 812. A determination is made at step 812 whether P1 has a four straight. If so, processing continues at step 814 to determine whether the random number is less than or equal to p14sb. If not, processing continues at step 818. If the random number is determined to be less than p14sb at step 814, processing continues at step 816 to specify a bet action for P1A1, a fold action for P1A2, and a one card draw.

In the preceding steps, a determination is made whether P1 should bluff with a four flush or four straight hand. In steps 818 and 820, a determination is made whether to bluff even though a bluff is not indicated in the preceding steps. Thus, at step 818, a determination is made whether the random number is less than or equal to p1PatBluffp. If so, processing continues at step 820 to determine whether the random number is less than or equal to two-thirds. If not, processing continues at step 824 to specify a bet action for P1A1, a fold for P1A2 and no draw. If so, processing continues at step 822 to specify a bet action for P1A1, a call action at P1A2 and no draw.

Whether or not a bluff is indicated in steps 818 and 820, processing continues at step 830 to determine whether P1 has an ace high or better (step 830), king high (step 834), or queen high or lower hand (step 838). If so, processing continues at 860 of FIG. 8C to compare the variables associated with P1's particular hand with the random number. Steps 830, 834, and 838 reference the flow of FIG. 8C and specify the variables that are used in the steps of FIG. 8C. For example, if it is determined at step 834 that P1's hand is a king high hand, variables p1khop and p1khca are used with the steps of FIG. 8C. That is, p1NPop is equivalent to p1khop and p1NPca is equivalent to p1khca.

Referring to FIG. 8C, a determination is made whether the random number is less than or equal to p1NPop (e.g., p1NPop is equivalent to p1qlop where P1 has a queen high or lower hand). If not, processing continues at step 862 to specify a fold action for P1A1. If so, processing continues at step 864 to determine whether the random number is less than or equal to p1NPca (e.g., p1NPca is equivalent to p1qlca where P1 is a queen high or lower hand). If not, processing continue at step 868 to specify a bet action for P1A1, a call action for P1A2, and a three card draw. If the random number is greater than p2NPca, processing continues at step 870 to specify a bet action for P1A1, a fold action for P1A2, and a three card draw.

A set of variables are also defined for P2 that are used to determine P2's first round strategy. Table 11 provides examples of variables used to determine P2's first round strategy as well as sample values and descriptions. It should be apparent that other values can be used for these variables and that other variables can be used as a supplement or replacement for these variables.

TABLE 11
Player 2 Variables

| Variable | Action 1 | | |
|---|---|---|---|
| Name | (P2A1) | Value | Description |
| p2PatBluffP | raise | 0.002597 | Probability that P2 bluffs by |
| | | | standing pat. |
| p24FBluffp | raise | 0.8435 | Probability that P2 bluffs as |
| | | | having two pair and draws |
| | | | one with a four flush. |
| p2NoPairBluffP | raise | 0.12 | Probability that P2 raises and |
| | | | draws three cards with a no |
| | | | pair hand |
| p2qlca | call | 0.0 | Probability that P2 calls with |
| | | | a queen high or lower hand. |
| p2qlra | raise | 0.12 | Probability that P2 raises with |
| | | | a queen high or lower hand. |
| p2khca | call | 0.0 | Probability that P2 calls with |
| | | | a king high hand. |
| p2khra | raise | 0.12 | Probability that P2 raises with |
| | | | a king high hand. |
| p2ahca | call | 0.3 | Probability that P2 calls with |
| | | | an ace high hand. |
| p2ahra | raise | 0.12 | Probability that P2 raises with |
| | | | an ace high hand. |
| p2raise | raise | 0.0-1.0 | Probability that P2 raises with |
| | | | a particular pair. |
| p2call | call | 0.0-1.0 | Probability that P2 calls with |
| | | | a particular pair. |
| p2fold | fold | 1.0- | Probability that P2 folds with |
| | | p2raise- | a particular one pair hand. |
| | | p2call | |

Note:
P2 raises with all hands better than a pair.

The strategies associated with the variables of Table 11 assume a game in which raises are limited as described with reference to FIG. 7B. That is, P2 has one action point, P2A1. At P2A1, P2 can fold, call or raise the opening bet by P1. The strategy adopted by P2 identifies the action for the P2A1 action point. The strategy that is adopted by P2 is determined using the variables identified in Table 11 and the rank of P2's hand.

As with P1's variables, a value is assigned a variable that represents the percentage of times that a variable's strategy is adopted. Further, each variable is associated with a hand rank. Table 12 categorizes the variables of Table 11 based on their associated hand.

TABLE 12
Hands and Associated P2 Variables

| | Variables |
|---|---|
| Hand | Player 2 |
| Straight Flush | * |
| Four of a Kind | * |
| Full House | * |
| Flush | * |
| Straight | * |
| Three of a Kind | * |
| Two Pair | * |
| One Pair | p2raise, p2call |
| No Pair | p2NoPairBluffp, |
| | p2PatBluffp |
| Ace High | p2ahca, p2ahra |
| King High | p2khca, p2khra |
| Queen High | p2qlca, p2qlra |
| Four Flush | p24FBluffp |
| Four Straight | p2PatBluffp |

* P2 raises with all hands better than a pair.

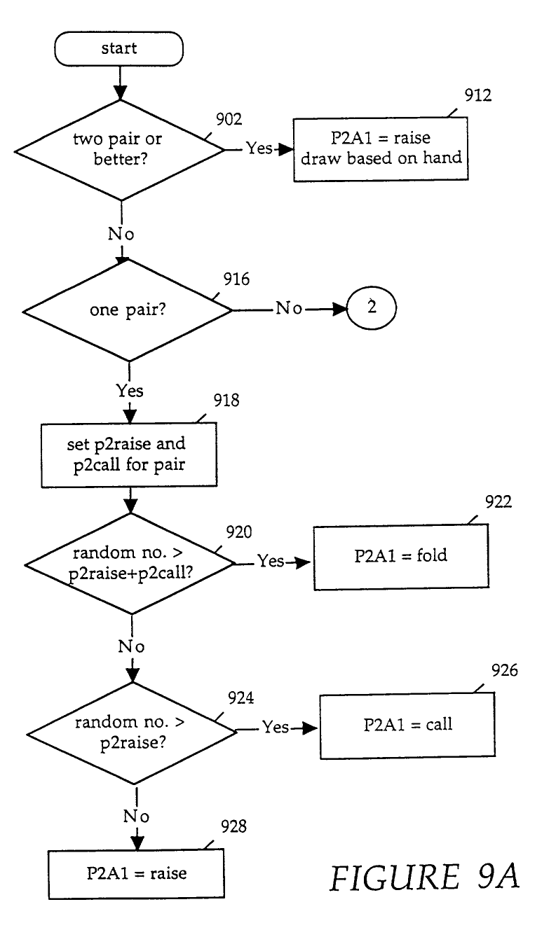

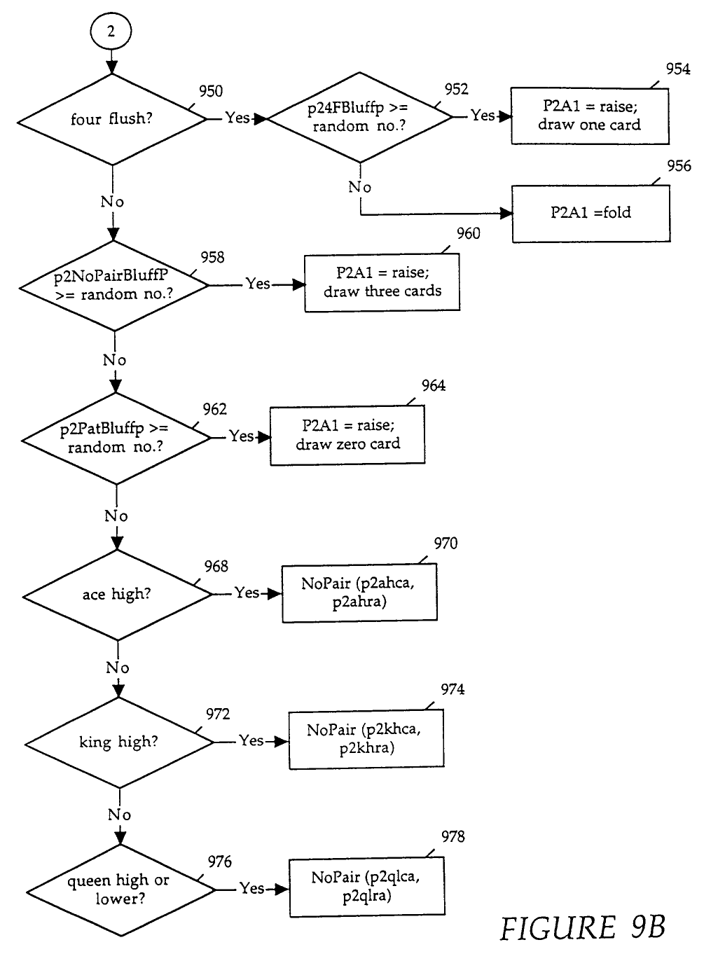

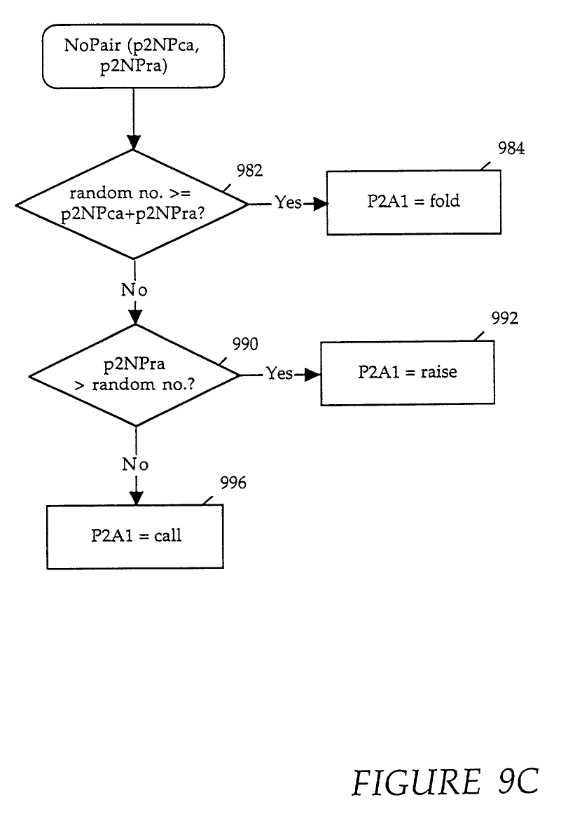

FIGS. 9A-9C provide a process flow for identifying a first round strategy for player P2 according to an embodiment of the invention. A ranking for P2's hand is identified. Once the ranking is determined, the variables associated with the ranking are used to select a strategy and identify the action(s) to be taken by P2. Where a draw action is not determined based on the hand, a specific draw is specified for P2.

At step 902 a determination is made whether P2's hand is a two pair or better hand. If P2 as a two pair or better hand (e.g., a straight), processing continues at step 912 to specify a raise action for P2A1 and a draw based on P2's hand.

If it is determined at step 902 that P2 has less than a two pair hand, processing continues at step 916 to determine whether P2 has a one pair hand. If so, processing continues at step 918 to obtain values for the variables p2raise and p2call given the actual one pair in P2's hand. Table 13 provides an example of values assigned to the p2raise and p2call variables for each pair type in one embodiment.

TABLE 13
Hands and Associated P2 Variables

| Pair | p2raise | p2call |
|---|---|---|
| Twos | 0.0 | 0.0 |
| Threes | 0.0 | 1.0 |
| Fours | 0.0 | 1.0 |
| Fives | 0.0 | 1.0 |
| Sixes | 0.75 | 0.25 |
| Sevens | 1.0 | 0.0 |
| Eights | 0.9 | 0.1 |
| Nines | 0.5 | 0.5 |
| Tens | 0.2 | 0.8 |
| Jacks | 1.0 | 0.0 |
| Queens | 1.0 | 0.0 |
| Kings | 1.0 | 0.0 |
| Aces | 1.0 | 0.0 |

The values of p2raise in Table 13 indicate the percentage of time that P2 raises with the given pair. The values of p2call indicate the percentage of time that P2 calls, but does not raise. Thus, for example, with a pair of sixes, P2 raises 75% of the time, and calls the remaining 25% of the time. P2 folds the remaining portion of the time, if any. Thus, p2fold=1−p2raise−p2call.

Other values for p2raise or p2call can be associated with each pair. Once values are obtained for p2raise and p2call at step 918, processing continues at step 920 to determine whether the random number is greater than the sum of p2raise and p2call. If so, processing continues at step 922 to specify a fold action for P2A1. If not, a determination is made at step 924 as to whether the random number is greater than p2raise. If yes, a call action is specified for P2A1 at step 926. If no, processing continues at step 928 to specify a raise action for P2A1.

If it is determined at step 916 that P2's hand is lower than one pair, processing continues at step 950 to determine whether P2 has a four flush hand. If so, processing continues at step 952 to determine whether to bluff with a four flush hand. A determination is made whether p24FBluffp is greater than or equal to the random number. If not, processing continues at step 956 to specify a fold action for P2A1. If so, processing continues at step 954 to specify a raise action for P2A1 and a one card draw.

If it is determined at step 950 that P2 does not have a four flush hand, processing continues at step 958 to determine whether p2NoPairBluffP is greater than or equal to the random number. If so, processing continues at step 960 to specify a raise for P1A1 and a three card draw. If it is determined at step 958 that p2NoPairBluffP is less than the random number, processing continues at step 962. A determination is made at step 962 whether p2PatBluffp is greater than or equal to the random number. If so, processing continues at step 964 to specify a raise for P2A1, and a zero draw.

If a bluff strategy is not adopted for P2, processing continues at steps 968, 972 and 976 to determine whether P2 has an ace high, king high, or queen high or lower hand. In each case, processing continues at step 982 to examine the variables associated with the ace high, king high or queen high or lower hands to determine whether P2 should raise, call or fold in response to an opening bet by P1. Depending on the outcome of steps 968, 972, and 976, the steps of FIG. 9C are performed using the variables associated with an ace high, king high or queen high or lower hand. For example, if it is determined at step 972 that P2 has a king high hand, processing executes the steps of FIG. 9C are processed using the p2khca and p2khra variables. The variables are referred to generically as p2NPca and p2NPra, respectively. Similarly, if it is determined at step 976 that P2 hand is a queen high or lower hand, the steps of FIG. 9C are performed using the p2qlca and p2qlra variables.

Referring to FIG. 9C, a determination is made at step 982 as to whether the random number is greater than the sum of p2NPra and p2NPca. If so, processing continues at step 984 to specify a fold operation for P2A1. If not, processing continues at step 990.

At step 990, a determination is made whether the p2NPra is greater than the random number. If yes, processing continues at step 992 to specify a raise operation for P2A1. If not, processing continues at step 996 to specify a call operation for P2A1.

Second Round

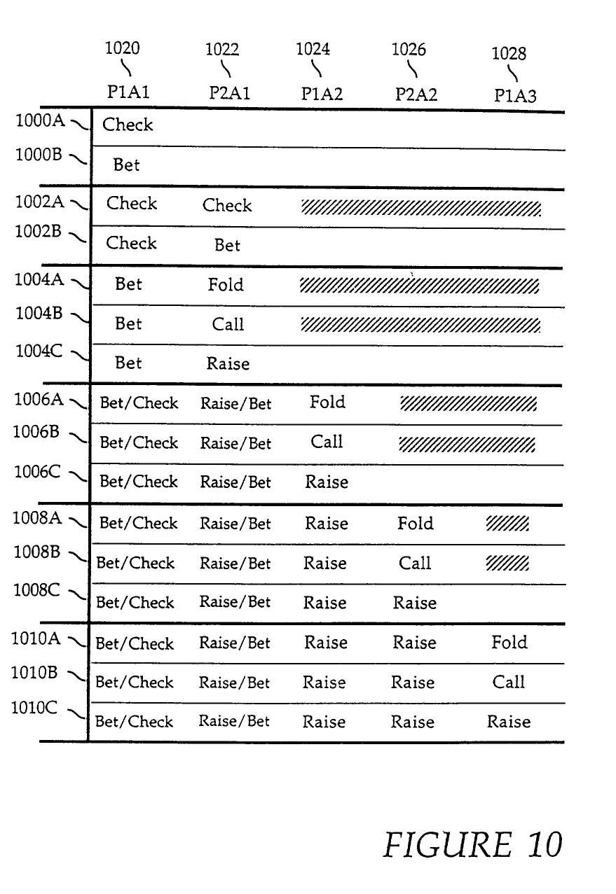

Like the first round of the intelligent poker playing system, the second round includes points at which a player (e.g., player 502 or the simulated player) must take an action. A player selects an action from the set of available actions that is a subset of the set of actions (e.g., pass or check, fold, call, bet and raise). If raising is unlimited, the second round continues until one of the players either calls or folds. FIG. 10 illustrates possible second round actions according to one embodiment of the invention.

Columns 1020-1028 identify five action points in the second round. For example, column 1020 corresponds to step 644 of FIG. 6D. Column 1022 corresponds to step 646 if P1's for action is a bet, or to step 656 when P1 checks. Columns 1024, 1026 and 1028 correspond to steps 660, 664, and 660, respectively. Rows 1000A-1000B, 1002A-1002C, 1004A-1004C, 1006A-1006C, 1008A-1008C and 1010A-1010C indicate the specific actions available to the players at given action points. For example, column 1020 (P1A1) represents the first action by P1. Rows 1000A-1000B identify the possible actions for P1 at the P1A1 action point (e.g., check or bet). At the P1A1 action point, no other actions have yet taken place. Therefore, no actions are identified for columns 1022-1028.

Rows 1002A-1002C illustrate the first actions for P2 (P2A1), if P1A1 is a check. Referring rows 1002A-1002B in column 1022, P2A1 can be a check or bet. If P2 checks in response to P1's check (row 1002A), there is a showdown. The pot gets paid to the player with the highest hand, and the game ends. Rows 1004A-1004C indicate that the first action for P2 can be a fold, call or raise if P1A1 is a bet. Rows 1006A-1006C through 1010A-1010C illustrate the possible actions for P1A2, P2A2 and P1A3, respectively as either fold, call or raise actions.

If P1 and P2 continue to raise, play can continue (i.e., P1An and P2An). In fact, second round play can continue indefinitely until a player calls the other's bet or folds. Alternatively, system 500 can limit the number of possible raises. That is P1 and P2 are limited in the number of times each can raise the other's bet.

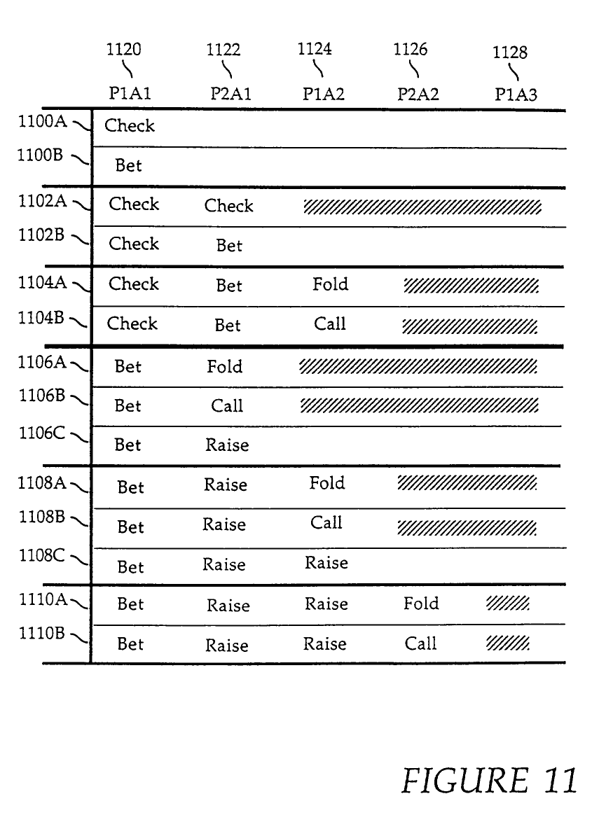

FIG. 11 illustrates possible second round action in a game where there is a raise limit according to one embodiment of the invention. Rows 1100A, 1102A-1102B, and 1104A-1104B illustrate the action where P1A1 is a check. Rows 1100B, 1106A-1106C, 1108A-1108C and 1110A-111OC illustrate the action where P1A1 is a bet. In FIG. 10, P1 could raise after checking (see rows 1004A-1004C). However, in FIG. 11, P1 is limited to either a fold or call action (see rows 1104A-1104B). That is, check raising is not allowed. Further, P2 is not allowed to raise in P2A2. Referring to rows 1110A-1110B, P2 has the option of either folding or calling at action point P2A2. Therefore, the first round is guaranteed to end no later than at P2A2.

The available actions for P1 and P2 for the second round are illustrated in FIGS. 10 and 11. Like the first round, a player must choose an action at each action point (e.g., P1A1, P2A1, P1A2, etc.). The actions are specified based on the strategy chosen by the player.

Second Round

As in the first round, there are a set of action sequence triggering variables that are used to determine a player's strategy for the second round. Each variable has an associated value that can be examined to develop a player's second round strategy. In one embodiment, the values of the variables are pre-calculated and stored in a table. In an alternate embodiment, instead of using variable values previously generated, the values can be generated dynamically during the game thereby eliminating the need to store the values. A set of criteria is used to either generate the values at runtime or to identify the row in the table that contains the values for the variables.

Second Round Strategy Look-up Table Operation

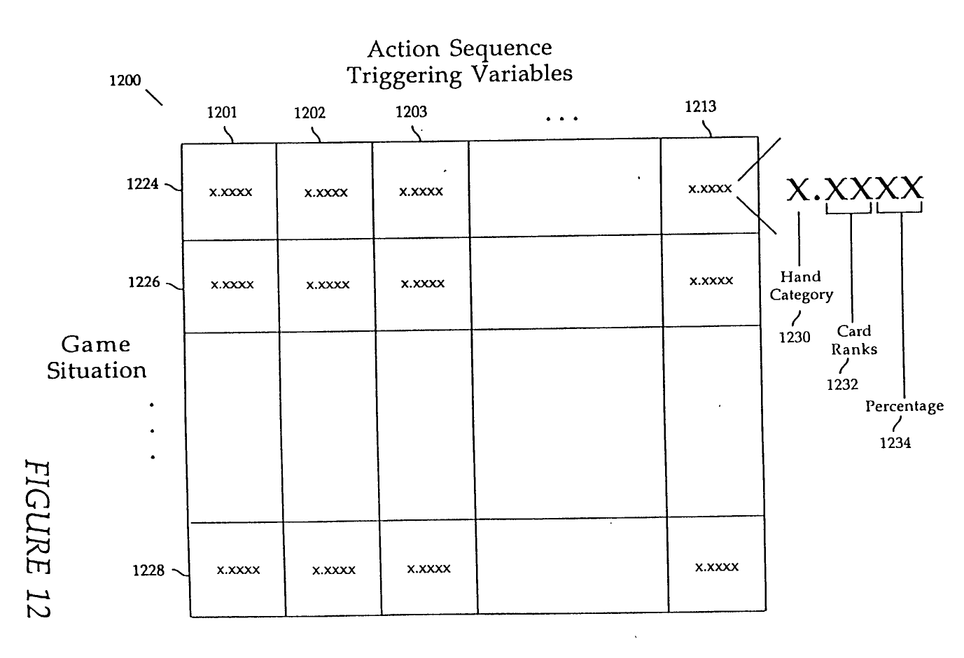

An example of a second round strategy lookup table used in one embodiment of the invention is shown in FIG. 12. Table 1500 includes columns 1201-1213. Column 1201 is an extra column that contains a default value of 1 that is not used. Columns 1202-1213 of table 1500 correspond to the action sequence triggering variables used in the second round. Rows 1224-1228 represent sets of values that are assignable to the second round variables.

Each value in rows 1224-1228 uses format 1230. Format 1230 comprises hand category 1230, card rank 1232, and percentage 1234. Hand category 1230 and card rank 1232 are translated into hand ranks as follows. The integer before the decimal (i.e., hand category 1230) is a number from 0 to 8 representing one of nine hand categories as indicated in Table 14:

TABLE 14
Hand Category Codes

| Number | Category |
|---|---|
| 0 | no pairs |
| 1 | one pair |
| 2 | two pairs |
| 3 | three of a kind |
| 4 | straight |
| 5 | flush |
| 6 | full house |
| 7 | four of a kind |
| 8 | straight flush |

The first two digits to the right of the decimal point (i.e., card rank 1232) are numbers from 02 to 14 corresponding to card ranks from deuces (twos) to aces as shown in Table 15:

TABLE 15
Card Rank Codes

| Number | Category |
|---|---|
| 02 | deuce |
| 03 | three |
| 04 | four |
| 05 | five |
| 06 | six |
| 07 | seven |
| 08 | eight |
| 09 | nine |
| 10 | ten |
| 11 | jack |
| 12 | queen |
| 13 | king |
| 14 | ace |

The remaining digits (i.e., percentage 1234) represent the percentage of time the particular hand specified by hand category 1230 and card rank 1232 is played according to the associated action sequence.

For example, given a value of “1.1231”, the “1,” according to Table 14, means a pair. The next two digits, “12,” according to Table 15, corresponds to “queen.” The next two digits, “31,” represent 0.31 or 31% of the time. According to Table 14, if the variable having the value 1.1231 represents the lowest hand with which P1 will bet, then P1 will bet with a pair of queens 31% of the time. The remaining time, P1 will pass with a pair of queens. The percentage is relevant only if the current hand is of the exact rank specified by the variable. P1 will pass with the next lower hand (pair of jacks), and bet with the next higher hand (pair of kings).

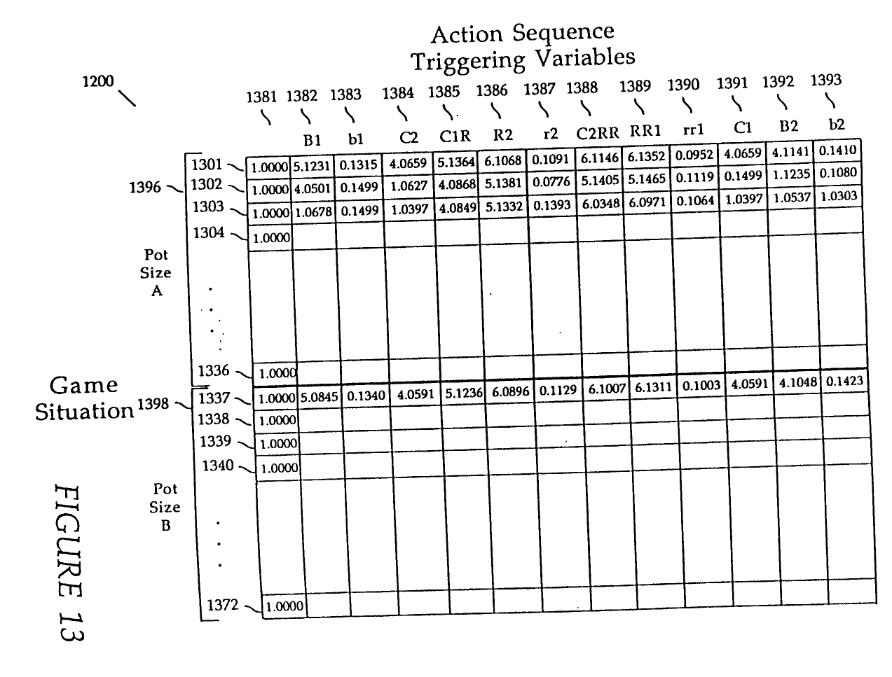

FIG. 13 illustrates actual columns for table 1500 of FIG. 12 according to an embodiment of the invention. Table 15 describes the action sequence triggering variables identified in FIG. 13.

TABLE 16
Explanations of Columns of FIG. 13

| Column | Variable Name | Definition |
|---|---|---|
| 1382 | B1 | Lowest hand with which P1 will bet |
| | | legitimately. |
| 1383 | b1 | Highest hand with which P1 will bluff-bet and |
| | | fold if raised. |
| 1384 | C2 | Lowest hand with which P2 calls if P1 bets. |
| 1385 | C1R | Lowest hand with which P1 will call if P2 |
| | | raises. |
| 1386 | R2 | Lowest hand with which P2 raises if P1 bets. |
| 1387 | r2 | Highest hand with which P2 bluff-raises if P1 |
| | | bets. |
| 1388 | C2RR | Lowest hand with which P2 calls if P1 reraises. |
| 1389 | RR1 | Lowest hand with which P1 reraises if P2 |
| | | raises. |
| 1390 | rr1 | Highest hand with which P1 bluff reraises. |
| 1391 | C1 | Lowest hand with which P1 calls if P2 bets |
| | | after P1 passes. |
| 1392 | B2 | Lowest hand with which P2 bets if P1 passes. |
| 1393 | b2 | Highest hand with which P2 bluff-bets if P1 |
| | | passes. |

Some of the variables are used to determine P1's strategy while others are used for P2. Table 17 identifies the variables used for P1 and the actions affected by each variable.

TABLE 17
Second Round Variables for P1

| | Variable | Action 1 | Action 2 | |
|---|---|---|---|---|
| Column | Name | (P1A1) | (P1A2) | Description |
| 1382 | B1 | bet | fold | Lowest hand with which P1 |
| | | | | will bet legitimately. |
| 1383 | b1 | bet | fold | Highest hand with which |
| | | | | P1 will bluff-bet and |
| | | | | fold if raised. |
| 1385 | C1R | bet | call | Lowest hand with which P1 |
| | | | | will call if P2 raises. |
| 1389 | RR1 | bet | reraise | Lowest hand with which P1 |
| | | | | reraises if P2 raises. |
| 1390 | rr1 | bluff-bet | reraise | Highest hand with which |
| | | | | P1 bluff-bets and reraises, |
| | | | | if raised. |
| 1391 | C1 | pass | call | Lowest hand with which P1 |
| | | | | calls if P2 bets after P1 |
| | | | | passes. |

Table 18 identifies the variables for P2 and their associated action points.

TABLE 18
Second Round Variables for P2

| | Variable | Action 1 | Action 2 | |
|---|---|---|---|---|
| Column | Name | (P2A1) | (P2A2) | Description |
| 1384 | C2 | call | | Lowest hand with which P2 |
| | | | | calls if P1 bets. |
| 1386 | R2 | raise | fold | Lowest hand with which P2 |
| | | | | raises if P1 bets. |
| 1387 | r2 | Bluff- | fold | Highest hand with which |
| | | raise | | P2 bluff-raises if P1 bets |
| 1388 | C2RR | raise | call | Lowest hand with which P2 |
| | | | | calls if P1 reraises. |
| 1392 | B2 | bet | fold | Lowest hand with which P2 |
| | | | | bets if P1 passes. |
| 1393 | b2 | Bluff-bet | fold | Highest hand with which |
| | | | | P2 bluff-bets if P1 passes. |

Referring to FIG. 13, each row of table 1500 corresponds to a particular game situation at the end of the first round/beginning of the second round in terms of the number of cards drawn by each player and the size of the pot. For each player, there are six possible number of cards drawn: 0, 1, 2, 3, 4, 5. Accordingly, there are 36 different draw variations for each pot size. In FIG. 13, table 1500 contains 72 rows, which correspond to 36 draw variations for each of two pot sizes. The first 36 rows of FIG. 13 (i.e., rows 1301-1336) correspond to a pot size of 3 (each player having anted ½ and bet 1). Rows 1337-1372 correspond to a pot size of 5 (each player having anted ½ and bet 2). For each set of 36 rows, the first row corresponds to P1 drawing 0 cards, P2 drawing 0 cards. The second row corresponds to P1 drawing 0 cards, P2 drawing 1 card. The third row corresponds to P1 drawing 0 cards, P2 drawing 2 cards, and so on. The general formula that determines, for each set of 36 rows, the row number that corresponds to a draw variation is:

1. Pot Size 3:

Row Number=[(no. of cards P1 draws)(6)+(no. of cards P2 draws)+1];

and

2. Pot Size 5:

Row Number=[(no. of cards P1 draws)(6)+(no. of cards P2 draws)+37].

For example, if P1 draws 3 cards and P2 draws 5 cards, the corresponding row number within a set of 36 rows is:

[(3)(6)+(5)+1]=Row 24

Accordingly, if the pot is three after the first round, for a game in which P1 draws 3 cards and P2 draws 5 cards, the row that applies is row 24 of the table 1500. If the pot is five, the row that applies is row 60 (24+36).

To use table 1500, a determination is made as to which game situation (number of cards drawn by each player and size of pot) applies. The appropriate row number is identified, and the variable values corresponding to P1 or P2 as appropriate are extracted from columns 1382-1393 of that row. The values of the variables can be used to identify action sequence intervals. The current hand is compared to the hands indicated by the variable values, and a determination is made as to the location of the current hand with respect to action sequence intervals defined by the variables. The indicated action sequence is then followed.

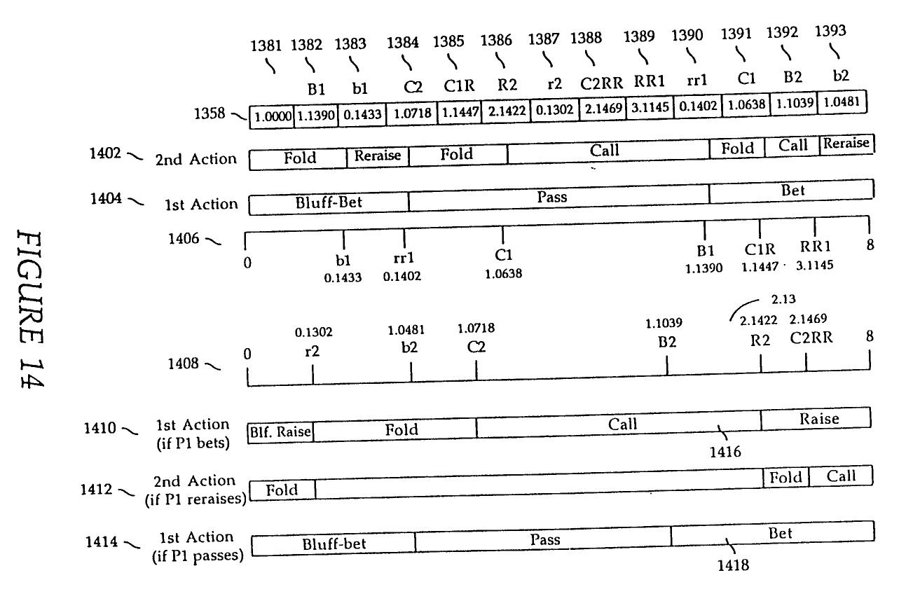

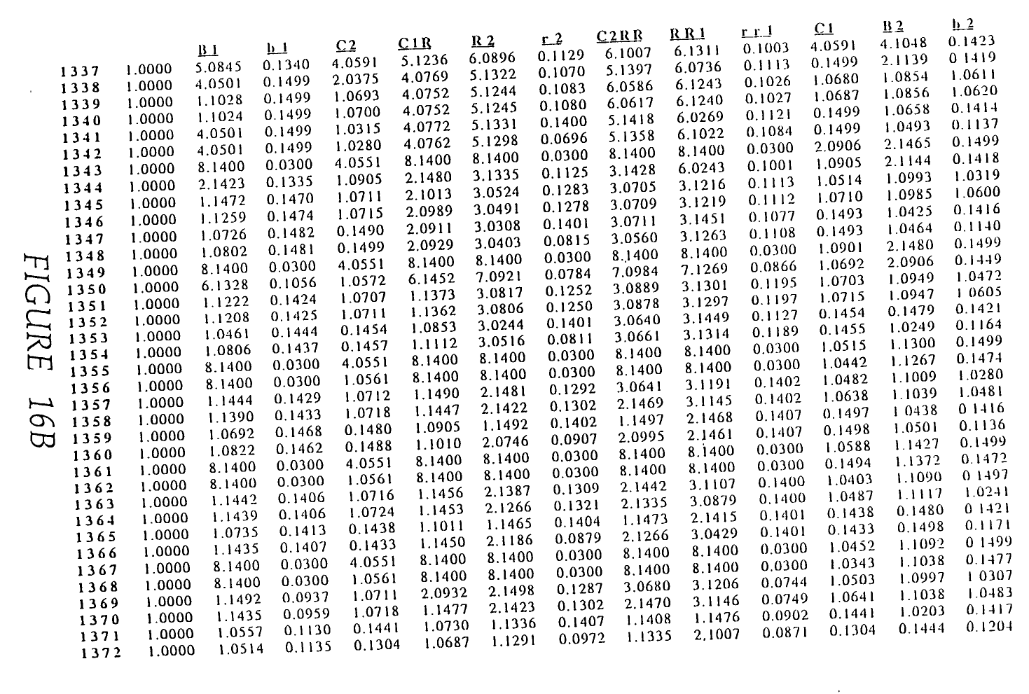

FIG. 14 illustrates the action sequence intervals given sample values for the action sequence triggering variables according to one embodiment of the invention. Row 1358 of table 1500 (see FIG. 16B) is illustrated having values in columns 1382-1393 for the action sequence triggering variables. Row 1358 corresponds to the row of table 1500 that is used when both P1 and P2 drew three cards in the first round, and the pot is equal to 5. In this example, P2 is the simulated player and P2's hand after the draw is two pair with a pair of kings being the highest pair. P2's hand thus has a value, using the format 1230 of Tables 11, 12 and 13, of “2.13” (2=two pairs, 13=kings). The applicable row of the table of 1200 is [(3)(6)+3+1+36]=58 (i.e., row 1358).

In FIG. 14, the values in columns 1382-1393 and their associated variables are aligned along hand strength axes 1406 (P1 variables) and 1408 (P2 variables). The corresponding action choices are indicated by bars 1402, 1404, 1410, 1412, and 1414.

A player's hand is translated into a value that specifies hand category 1230 and card rank 1232 using Tables 11, 12, and 13. The value is placed along the player's hand strength axis (e.g., axes 1406 or 1408). For P1, the position of the value along a hand strength axis is used as a reference to the action choices 1402 for P1A2 and action choices 1404 for P1A1. Similarly, the position of P2's hand value along axis 1408 is used as a reference to the action choices 1410 and 1414 for P2A1 and action choices 1412 for P2A2.

For example, the values for variables C2, R2, r2, C2RR, B2 and b2 are used to position the variables along hand strength axis 1408. P2's hand is used to calculate a hand value of 2.13 as discussed above. Looking at hand strength axis 1408, it is found that P2's hand of 2.13 falls between B2 (1.1039) and R2 (2.1422). The action sequence indicated for P2A1 given P2's current hand, as shown in action choices 1410 and 1414, is to call if P1 bets (action choices 1410), and to bet if P1 passes (action choices 1414).

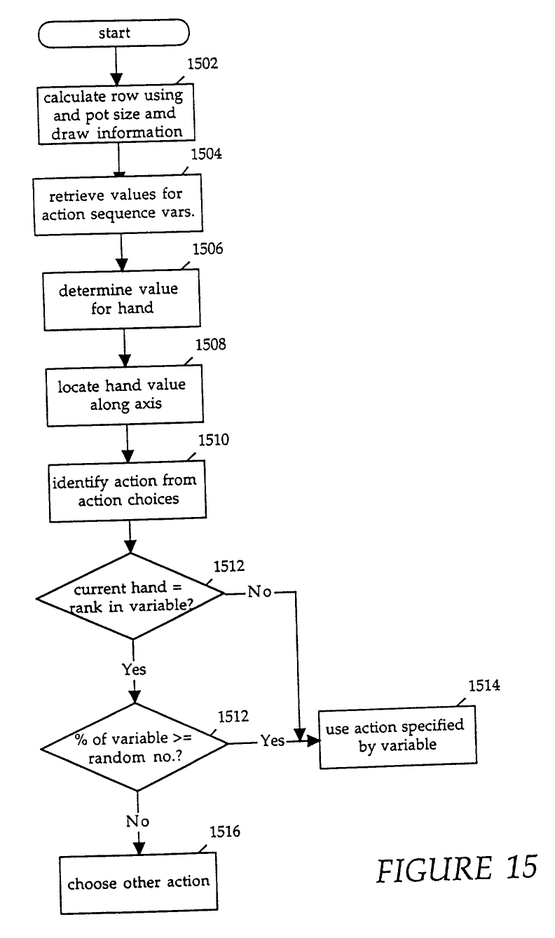

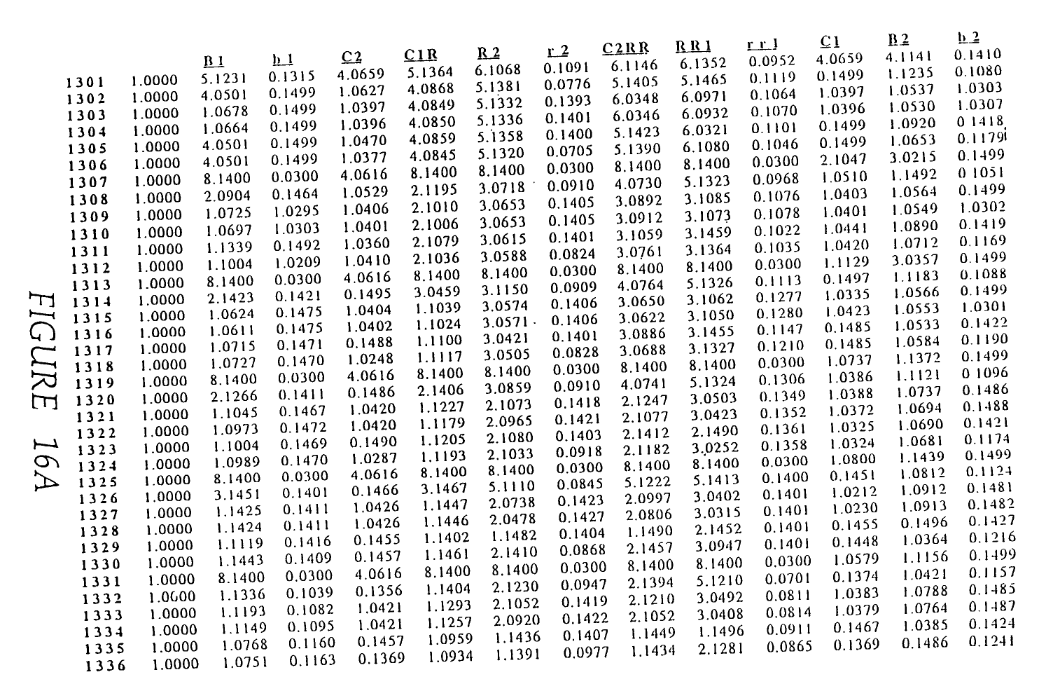

FIG. 15 provides a second round process flow that uses table 1500 of FIGS. 12-14 according to one embodiment of the invention.

At step 1502, the row of table 1500 is calculated using the pot size and draw information. At step 1504, the values for the action sequence triggering variables are retrieved for table 1500. A value is calculated for the simulated player's hand at step 1506. At step 1508, the positioning of the hand's value is determined relative to the variables positioned along the hand strength axis. At step 1510, an action is identified from the action choices.

Percentage 1234 associated with a variable is used where the player's hand is the exact rank specified for the variable. Thus, at step 1512, a determination is made at step 1512 whether the current hand is equal to the rank specified in the variable. If not, the action specified by the variable identified in step 1508 is adopted at step 1514. If so, a determination is made at step 1512 to determine whether the variable's percentage 1234 is greater than or equal to the random number. If it is, processing continues at step 1514 to use the action associated with the variable identified in step 1508. If not, processing continues at step 1516 to select the action different from the action associated with the variable specified for the next higher or lower hand than the hand specified in the variable, as appropriate. For example, in the previous example, if P2 has a pair of aces (2.14), P2 will raise if the random number is less than or equal to 0.22 (since r2=2.1422). Otherwise, P2 will call (the action indicated for the next lower hand) with its pair of aces.

FIGS. 16A-16B provide values for action sequence triggering variables for example pot sizes of 3 and 5 discussed above. FIG. 16A includes rows 1301-1336 used for a post size of 3. FIG. 16B has rows 1337-1372 for a pot size of 5.

Second Round Strategy Dynamic Generation

In one embodiment that dynamically generates action sequence triggering variables, the action sequence triggering variables are generated so as to optimize the economic return to the gaming system of the invention. The method used to generate the action sequence triggering variables may be used with a variety of card games, including, without limitation, poker and variations of poker. The use of the invention with games of varying complexity is described below. The example games described include:

A two-player, one round game with no raising.

A two-player, one round game with raising but no check raising.

A two player, one round game with check raising.

The values generated by the method of the invention may be generated as needed, or may be generated once and stored in a look-up table for subsequent use.

Two-player One Round Game with No Raising

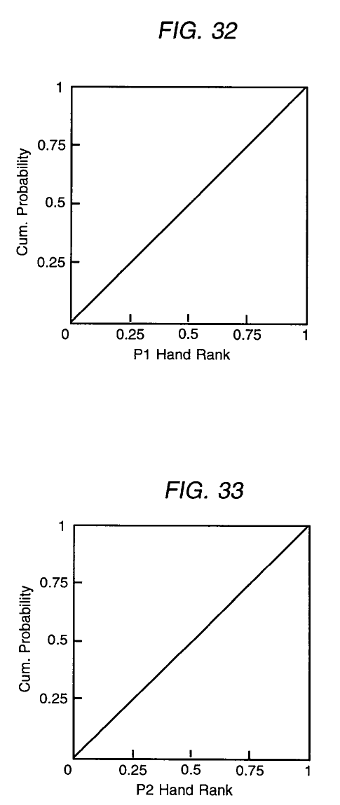

A simple variation of the game of poker is a two-player, one-round game with no raising. In this game, there are two players. Each player is dealt a hand having a strength or ranking between 0 and 1. For each player, the probability of having any particular ranking x in this example is deemed to be uniform on the interval between 0 and 1. The resulting cumulative distribution functions for each of P1 and P2 is illustrated in FIGS. 32 and 33, respectively. Each player pays an ante in the amount of P/2, such that the total ante is amount P. Player 1 (P1) opens the betting, and has two choices: pass or bet P. If P1 passes, there is an immediate showdown. If P1 bets, Player 2 (P2) may either call by betting P or fold.

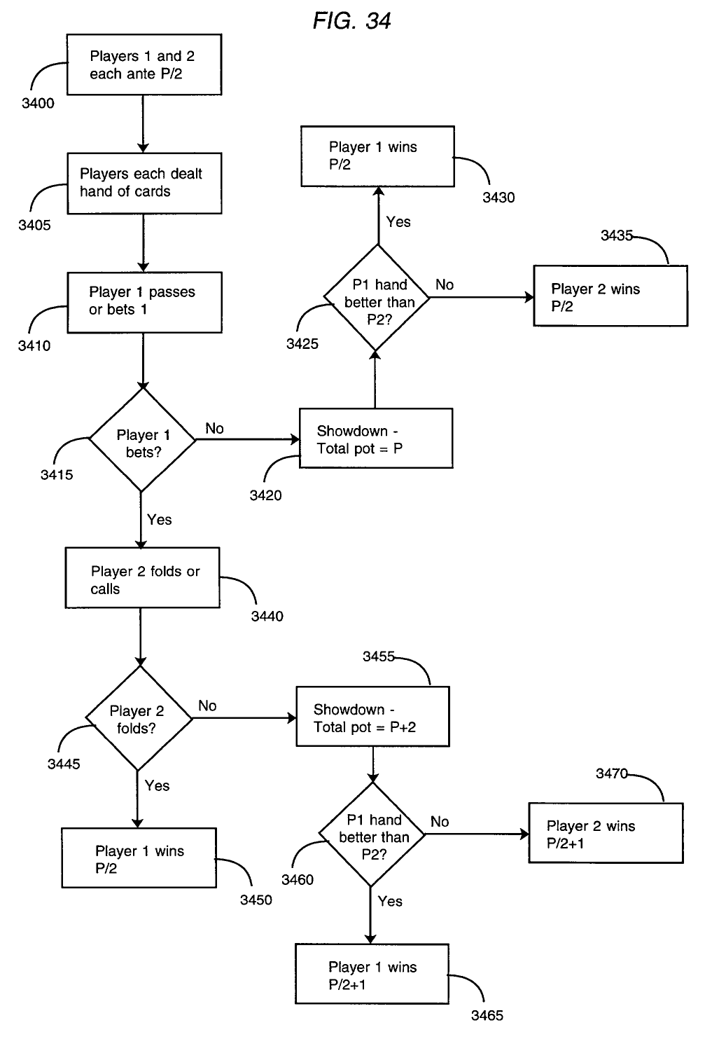

FIG. 34 illustrates the sequence of events in this game. At step 3400, P1 and P2 each pay an ante in the amount of P/2, such that the pot is amount P. At step 3405, each player is dealt a hand whose value is between 0 and 1. According to the cumulative distribution functions shown in FIGS. 32 and 33, each of P1 and P2 have an equal chance of getting any hand value between 0 and 1.

At step 3410, P1 either passes or bets. If player P1 passes, there is an immediate showdown at block 3420. Since no bets have been added to the pot, the pot contains only the ante of total amount P. The highest hand wins the pot. If P1's hand is better than P2's hand, P1 wins P/2 (the size of the pot, P, minus the amount P1 put into the pot, P/2) at step 3430. If P2's hand is better than P1's, P2 wins P/2 at step 3435. In this case, P1 loses P/2.

If P1 bets 1 at step 3410, the pot increases to P+1, and P2 either folds or calls at step 3440. If P2 folds, P1 wins the pot at step 3450, winning a net amount of P/2 (the size of the pot, P+1, minus the amount P1 put into the pot, P/2+1). It is worth noting that at step 3450, because P1 bet and P2 folded, there is no showdown, and P1 wins regardless of the rank of P1's hand or the rank of P2's hand.

If P2 calls at step 3440, the pot increases to P+2, and there is a showdown at step 3455. If P1's hand is better than P2's, P1 wins the pot at step 3465. P1's net winnings are P/2+1 (the size of the pot, P+2, minus the amount P1 put into the pot, P/2+1). If P2's hand is better than P1's, P2 wins the pot at step 3470. P2's net winnings are P/2+1 (the size of the pot, P+2, minus the amount P2 put into the pot, P/2+1). P1 loses the amount P1 put into the pot, P/2+1.

The method of the invention may be used to generate strategies for maximizing the average expected return for both P1 and P2. In one embodiment, a multi-dimensional model of the game is created. The number of dimensions is equal to the number of players. Because there are two players in the game of FIG. 34, in this embodiment, the model is a two dimensional model.

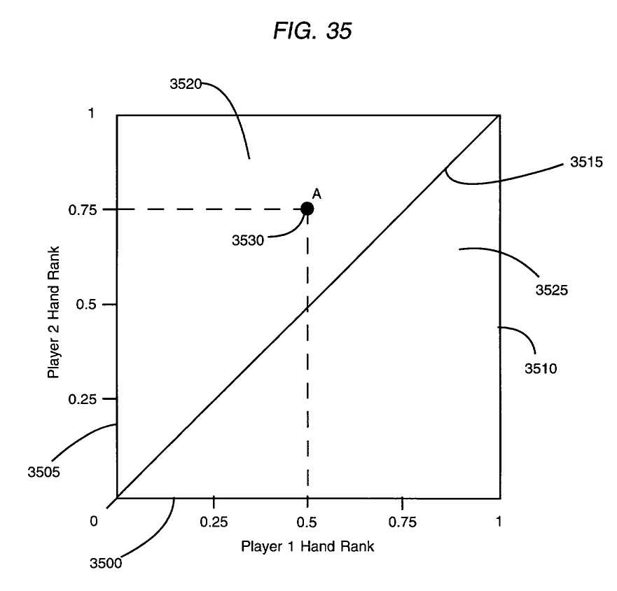

FIG. 35 shows a model for the game of FIG. 34 according to one embodiment of the invention. Axes 3500 and 3505, representing P1's and P2's possible hands, respectively, are arranged orthogonal to each other with a common origin, forming a resulting area 3510. Each point in area 3510 represents a possible pair of hands that may be dealt to P1 and P2 in a game. For example, point “A” 3530 represents a game in which P1's hand is of rank 0.5 and P2's hand is of rank 0.75. If a showdown occurred in the game represented by point “A”, Player 2 would win. Line 3515 is the line representing games in which P1's and P2's hands are of equal rank. In the region 3520 above line 3515, P2's hand is of higher rank than P1's. In the region 3525 below line 3515, P1's hand is of higher rank than P2's. In general, in games in which showdowns occur, P1 wins in region 3525 and P2 wins in region 3520.

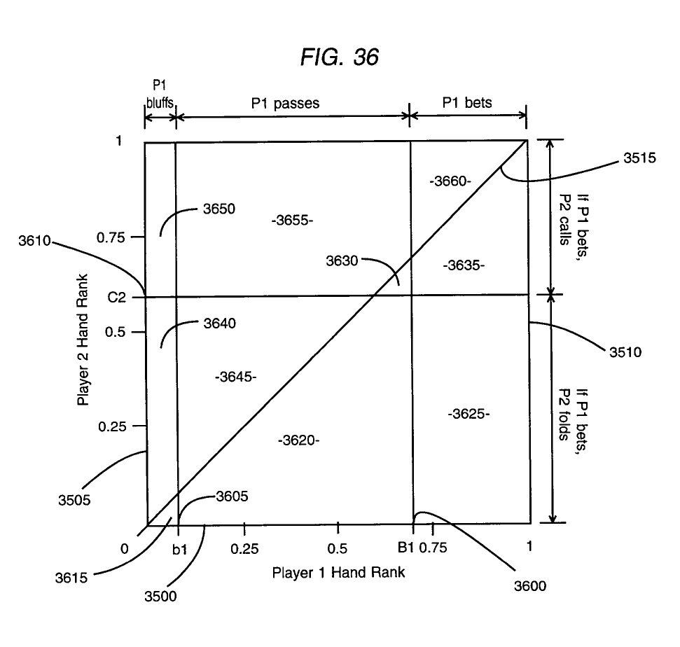

FIG. 36 illustrates a further development of the model of FIG. 35 according to the invention. As shown in FIG. 34, after the players are dealt their hands at step 3405, P1 must either pass or bet at step 3410. It is initially assumed that P1's game playing strategy is to bet for those hands for which P1 has the better chance of beating P2's hands (namely P1's highest ranking hands) and pass with lower ranking hands. The lowest ranking hand for which P1 bets is designated “B1.” Accordingly, in FIG. 36, point B1 is initially placed at an arbitrary point 3600 in the upper half of P1's distribution axis 3500.

However, as shown in FIG. 34, P1 not only wins games in which P1's hand proves to be of higher rank than P2's hand (i.e. at the showdowns that occur at steps 3420 and 3455), but also wins at step 3450 when P2 folds, regardless of the respective rank of P1's and P2's hands. Accordingly, P1 can benefit by bluff betting with a certain portion of P1's worst hands, hands with which P1 would almost certainly lose in a showdown, but with which P1 can win if P2 folds in response to P1's bet. It is therefore assumed that P1 will bluff bet for all hands whose rank is below a certain value. This highest rank of hand for which P1 will bluff bet is designated “b1” (lower case indicating a bluff) and is initially placed at an arbitrary point 3605 in the lower half of P1's distribution axis 3500.

In a similar manner, it is assumed that P2's strategy is to call with P2's higher ranking hands and fold with P2's lower ranking hands. The lowest ranking hand with which P2 calls is designated “C2”, and is located initially at a point 3610 in the upper half of P2's distribution axis 3505. It is assumed that P2 knows that P1 will occasionally bluff, and that to catch P1 bluffing, P2 must bet hands that of lower rank than hands with which P2 believes would be needed to win a showdown with P1. Accordingly, it is assumed that C2 is a lower value than B1.

Although B1, b1 and C2 are shown positioned at certain locations in FIG. 36, the locations themselves are arbitrary for purposes of using the method of the invention. The important factor is the relative positioning of the variables, namely B1>C2>b1.

As shown in FIG. 36, points b1, B1 and C2 along with dividing line 3515 divide region 3510 into a number of subregions 3615, 3620, 3635, 3630, 3635, 3640, 3645, 3650, and 3655. These subregions correspond to alternative outcomes for games that fall in the subregions if P1 and P2 use the assumed strategies.

Subregions 3615, 3620, 3625, 3630, and 3635 correspond to games in which P1's hand has a higher rank than P2's hand.

As shown in FIG. 36, subregion 3615 corresponds games in which P1 bluff-bets and P2 folds. Accordingly, the outcome in these games corresponds to step 3450 in FIG. 34. As shown in FIG. 34, P1 wins P/2 at step 3450.

Subregion 3620 corresponds to games in which P1 passes and then wins the immediately following showdown. The outcome in these games corresponds to step 3430 in FIG. 34. As shown in FIG. 34, P1 wins P/2 at step 3430.

Subregion 3625 corresponds to games in which P1 bets and then P2 folds. The outcome in these games, like the games in subregion 3615, corresponds to step 3450 in FIG. 34. Accordingly, P1 wins P/2 for these games.

Subregion 3630, like subregion 3620, corresponds to game in which P1 passes and then wins the immediately following showdown. P1 wins P/2 for these games.

Subregion 3635 corresponds to games in which P1 bets, P2 calls, and then P1 wins in a showdown. The outcome in these games corresponds to step 3465 in FIG. 34. In these games, P1 wins P/2+1.

The remaining subregions 3640, 3645, 3650, 3655, and 3660 correspond to games in which P2's hand has a higher rank than P1's hand.

Subregion 3640, like subregion 3615, corresponds to games in which P1 bluff bets and P2 folds. In these games, P1 wins P/2.

Subregion 3645 corresponds to games in which P1 passes and P2 wins the resulting immediate showdown. The outcome of these games corresponds to step 3435 in FIG. 34. As shown in FIG. 34, in these games P2 wins P/2 (P1 loses P/2).

Subregion 3650 corresponds to games in which P1 bluff bets, P2 calls, and P2 wins the resulting showdown. The outcome of these games corresponds to step 3470 in FIG. 34. As shown in FIG. 34, in these games P2 wins P/2+1 (P1 loses P/2+1).

Subregion 3655, like subregion 3645, corresponds to games in which P1 passes and P2 wins the resulting showdown. P2 wins P/2 in these games (P1 loses P/2).

Subregion 3660 corresponds to games in which P1 bets, P2 calls, and P2 wins the resulting showdown. Like subregion 3650, the outcome of these games corresponds to step 3470 in FIG. 34. P2 wins (and P1 loses) P/2+1 in these games.

Table 19 summarizes the outcomes for each of the players for each subregion of FIG. 36 in terms of the returns to the players for games in each subregion.

TABLE 19
Outcomes for Subregions of FIG. 36

| Region | Return to P1 | Return to P2 |
|---|---|---|
| 3615 | +P/2 | −P/2 |
| 3620 | +P/2 | −P/2 |
| 3625 | +P/2 | −P/2 |
| 3630 | +P/2 | −P/2 |
| 3635 | +(P/2 + 1) | −(P/2 + 1) |
| 3640 | +P/2 | −P/2 |
| 3645 | −P/2 | +P/2 |
| 3650 | −(P/2 + 1) | +(P/2 + 1) |
| 3655 | −P/2 | +P/2 |
| 3660 | −(P/2 + 1) | +(P/2 + 1) |

Because each of P1 and P2 have a uniform probability of being dealt any hand having a value between 0 and 1, the value of a hand as indicated along each of the card rank distribution axes 3500 and 3505 also represents the value of the cumulative distribution function for each of P1 and P2, respectively. Accordingly, the area of each subregion corresponds to the probability that games will occur in that subregion. The expected return to each player due to each subregion thus is the product of the area of the subregion multiplied by the outcome for games falling in that subregion. The total expected return for a player is the sum of those products for each area.

The areas of each of the subregions can be calculated from FIG. 36.

Subregion 3615 is a triangle of base b1 and height b1 (since line 3515 has a slope of 1). Accordingly, the area of Subregion 3615 is:

$$Area 3615 = \frac{{b1}^{2}}{2}$$

The area of subregion 3620 is equal to the area of a triangle of base B1 and height B1, minus the area of subregions 3615 and 3630. Subregion 3630 is a triangle of base (B1-C2) and height (B1-C2). The area of subregion 3630 is therefore:

$$Area 3630 = \frac{{( B1 - C2 )}^{2}}{2} = \frac{{B1}^{2}}{2 } - B1C2 + \frac{{C2}^{2}}{2}$$

Accordingly, the area of subregion 3620 is equal to:

$$\begin{matrix}Area 3620 = \frac{{B1}^{2}}{2} - \frac{{b1}^{2}}{2} - ( \frac{{B1}^{2}}{2} - B1C2 + \frac{{C2}^{2}}{2} ) \\ = B1C2 - \frac{{b1}^{2}}{2} - \frac{{C2}^{2}}{2}\end{matrix}$$

Subregion 3625 is a rectangle of base 1−B1 and of height C2. The area of subregion 3625 is therefore equal to:

Area 3625=(1−B1)C2=C2−B1C2

The area of subregion 3635 is equal to the area of a rectangle of base (1−B1) and of height (1−C2) minus the area of subregion 3660. Subregion 3660 is a triangle with base (1−B1) and height (1−B1). The area of subregion 3660 is therefore:

$$Area 3660 = \frac{{( 1 - B1 )}^{2}}{2} = \frac{1}{2} - B1 + \frac{{B1}^{2}}{2}$$

The area of subregion 3635 is therefore:

$$\begin{matrix}Area 3635 = ( 1 - B1 ) ( 1 - C2 ) - ( \frac{1}{2} - B1 + \frac{{B1}^{2}}{2} ) \\ = ( 1 - C2 - B1 + B1C2 ) - ( \frac{1}{2} - B1 + \frac{{B1}^{2}}{2} ) \\ = \frac{1}{2} - C2 + B1C2 - \frac{{B1}^{2}}{2}\end{matrix}$$

The area of subregion 3640 is equal to the area of a rectangle of base b1 and height C2 minus the area of subregion 3615. The area of subregion 3640 therefore is equal to:

$$Area 3640 = b1C2 - \frac{{b1}^{2}}{2}$$

The area of subregion 3645 is equal to the area of a triangle of base C2 and height C2 minus the area of subregion 3640. The area of subregion 3645 therefore is equal to:

$$\begin{matrix}Area 3645 = \frac{{C2}^{2}}{2} - ( b1C2 - \frac{{b1}^{2}}{2} ) \\ = \frac{{C2}^{2}}{2} - b1C2 + \frac{{b1}^{2}}{2}\end{matrix}$$

The area of subregion 3650 is equal to the area of a rectangle of base b1 and height 1−C2. The area of subregion 3650 is therefore equal to:

$$Area 3650 = ( b1 ) ( 1 - C2 ) = b1 - b1C2$$

Finally, the area of subregion 3655 is equal to the area of a rectangle of base (B1−b1) and height (1−C2) minus the area of subregion 3630. The area of subregion 3655 is therefore equal to:

$$\begin{matrix}Area 3655 = ( B1 - b1 ) ( 1 - C2 ) - ( \frac{{B1}^{2}}{2} - B1C2 + \frac{{C2}^{2}}{2} ) \\ = B1 - B1C2 - b1 + b1C2 - \frac{{B1}^{2}}{2} + B1C2 - \frac{{C2}^{2}}{2} \\ = - \frac{{B1}^{2}}{2} + B1 - b1 + b1C2 - \frac{{C2}^{2}}{2}\end{matrix}$$

Table 20 summarizes the returns to P1 for games in each subregion and the area of each subregion.

TABLE 20
Returns for P1 and Areas of Subregions

| Region | Return to P1 | Area(probability) |
|---|---|---|
| 3615 | +P/2 | $\frac{{b1}^{2}}{2}$ |
| 3620 | +P/2 | $B1C2 - \frac{{b1}^{2}}{2} - \frac{{C2}^{2}}{2}$ |
| 3625 | +P/2 | C2 − B1C2 |
| 3630 | +P/2 | $\frac{{B1}^{2}}{2} - B1C2 + \frac{{C2}^{2}}{2}$ |
| 3635 | +(P/2 + 1) | $\frac{1}{2} - C2 + B1C2 - \frac{{B1}^{2}}{2}$ |
| 3640 | +P/2 | $b1C2 - \frac{{b1}^{2}}{2}$ |
| 3645 | −P/2 | $\frac{{C2}^{2}}{2} - b1C2 + \frac{{b1}^{2}}{2}$ |
| 3650 | −(P/2 + 1) | b1 − b1C2 |
| 3655 | −P/2 | $- \frac{{B1}^{2}}{2} + B1 - b1 + b1C2 - \frac{{C2}^{2}}{2}$ |
| 3660 | −(P/2 + 1) | $\frac{1}{2} - B1 + \frac{{B1}^{2}}{2}$ |

According to method of the invention, the expected return to P1 is the sum of the product of the return for each subregion multiplied by the probability (area) of each subregion. Letting E1 be the expected return to P1:

$$\begin{matrix}E1 = \frac{P}{2} [ \begin{matrix}( \frac{{b1}^{2}}{2} ) + ( B1C2 - \frac{{b1}^{2}}{2} - \frac{{C2}^{2}}{2} ) + ( C2 - B1C2 ) + \\ ( \frac{{B1}^{2}}{2} - B1C2 + \frac{{C2}^{2}}{2} ) + ( b1C2 - \frac{{b1}^{2}}{2} ) - \\ ( \frac{{C2}^{2}}{2} - b1C2 + \frac{{b1}^{2}}{2} ) - ( - \frac{{b1}^{2}}{2} + B1 - b1 + \\ b1C2 - \frac{{C2}^{2}}{2} )\end{matrix} ] + \\ ( \frac{P}{2} + 1 ) [ ( \frac{1}{2} - C2 + B1C2 - \frac{{B1}^{2}}{2} ) - ( b1 - b1C2 ) - \\ ( \frac{1}{2} - B1 + \frac{{B1}^{2}}{2} ) ]\end{matrix}$$

Equation (0) may be simplified and rewritten as:

$$E1 = b1C2p - \frac{{b1}^{2} P}{2} - C2 + B1C2 - {B1}^{2} - b1 + b1C2 + B1 \qquad ( 1 )$$

Equation (1) is an expression for P1's expected return as a function of the pot P, and of variables b1, B2, and C2, resulting from application of the method of the invention.

Of the three variables, b1 and B1 are controlled by P1, while C2 is controlled by P2. The present invention assumes that P1 will seek values for b1 and B1 so as to maximize P1's return (El), while P2 will seek a value for C2 so as to minimize E1. To find such values, according to the method of the present invention, the partial derivatives of E1 with respect to each of the variables b1, B2 and C2 are taken and each set equal to zero. The result is three simultaneous equations that are used to solve for b1, B2 and C2:

$$\begin{matrix}\frac{\partial E1}{\partial b1} = C2P - b1P - 1 + C2 = 0 & ( 2 ) \\ \frac{\partial E1}{\partial B1} = C2 - 2 B1 + 1 = 0 & ( 3 ) \\ \frac{\partial E1}{\partial C2} = b1P - 1 + B1 + b1 = 0 & ( 4 )\end{matrix}$$

Solving equations (2), (3) and (4) simultaneously produces the following expressions for b1, B2 and C2 in terms of P:

$$\begin{matrix}b1 = \frac{P}{( 2 P + 1 ) ( P + 2 )} & ( 5 ) \\ B1 = \frac{{P}^{2} + 4 P + 2}{( 2 P + 1 ) ( P + 2 )} & ( 6 ) \\ C2 = \frac{3 P + 2}{( 2 P + 1 ) ( P + 2 )} & ( 7 )\end{matrix}$$

For example, if P=1, from equations (5)-(7), b1=1/9, B2=7/9, and C2=5/9. Using these values in equation (1), the resulting expected return to P1 for the game is approximately 0.056 units/game.

General Method of the Invention

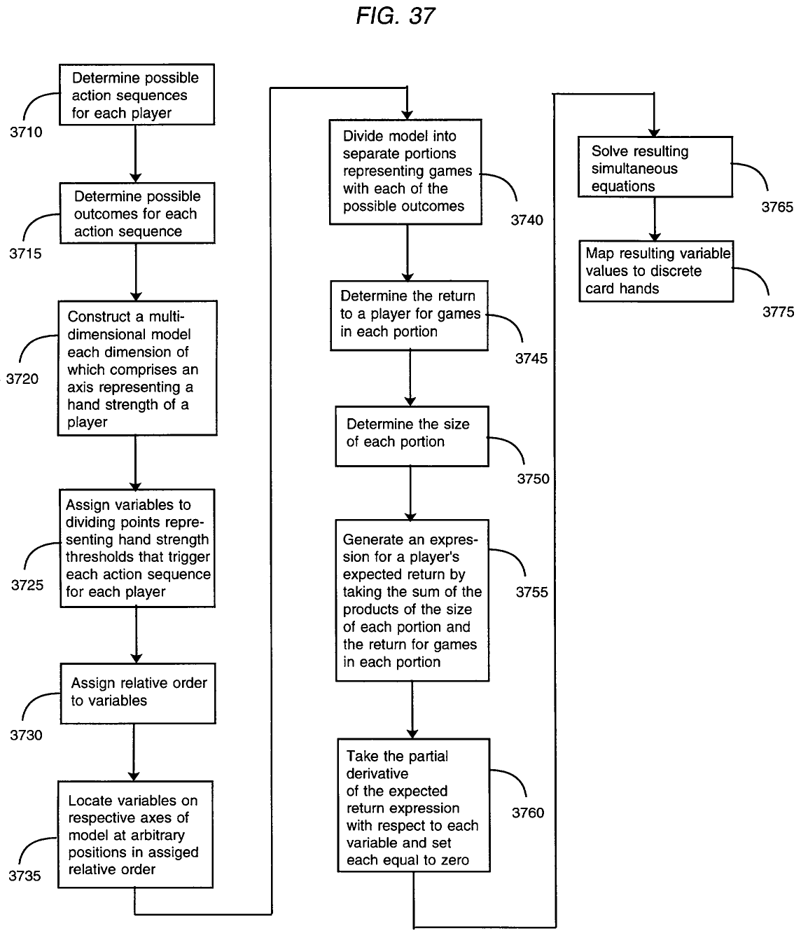

FIG. 37 is a flow chart illustrating steps used in one embodiment of the invention to generate card playing strategies. This method may be used, for example, for the one round equal contest embodied by the game of FIG. 34, as well as for other, more complex games. For example, the method may be used to generate values for the action sequence triggering variables listed in FIGS. 16A and 16B.

As shown in FIG. 37, the possible action sequences for each player are determined at step 3710. For example, in the game of FIG. 34, there are two possible action sequences for player 1 (pass or bet(bluffing or legitimately)) and two possible action sequences for player 2 (fold or call). In the example of FIG. 34, the action sequences consist of only a single action. In other games, action sequences may consist of multiple actions.

At step 3720, the possible outcomes for each action choice are determined. For example, if P1 bets in the game of FIG. 34, the possible outcomes are that (i) P2 folds (P1 wins P/2); (ii) P2 calls and P1 wins showdown (P1 wins P/2+1); and (iii) P2 calls and P2 wins showdown (P1 loses P/2+1).

At step 3720, a multidimensional model is created each dimension of which corresponds to an axis representing a hand strength of a player. For a two person game, an example of such a model is the two-dimensional area 3520 shown in FIG. 35 consisting of player 1 and 2 hand strength axes 3500 and 3505 and dividing line 3515. For a three-person game, a three dimensional model with three orthogonal axes is used.

At step 3725, variables are assigned to dividing points representing hand strengths that trigger each action sequence for each player. Examples of these variables are the variables b1, B1 and C2 of the example of FIG. 36.

At step 3730, a relative order is assigned to the variables. In the example of FIG. 36, the assigned order is B1>C2>b1.

At step 3735, the variables for each player are positioned on the axis representing that player's hand strength at arbitrary positions but in the assigned relative order. In the example of FIG. 36, b1 was placed on P1's axis at a hand strength smaller than the hand strength at which C2 was placed on P2's axis, which in turn was a value smaller than the hand strength at which B1 was placed on P1's axis.

At step 3740, the model is divided into separate portions representing games with each of the possible outcomes. Examples of these portions are subregions 3615, 3620, 3625, 3630, 3635, 3640, 3645, 3650, 3655 and 3660 of FIG. 36.

At step 3745, the return to a player for games in each portion are determined. Alternatively, these returns may be determined as part of determining the outcomes of the possible action sequences at step 3715.

The size of each portion is determined at step 3750. For a two-dimensional model (two players) the size of each portion is the area of the portion. For a three-dimensional model (three-players) the size of each portion is the volume of the portion.

At step 3755, an expression for a player's expected return is generated by taking the sum of the products of the size of each portion multiplied by the return for games in each portion. Equation (1) is an example of such an expression.

At step 3760, a set of simultaneous equations is generated by taking the partial derivative of the expected return expression generated in step 3755 with respect to each action sequence triggering variable, and setting the result of each partial derivation equal to zero. Equations (2), (3) and (4) are examples of simultaneous equations generated according to step 3760.

The resulting simultaneous equations are solved, either algebraically or numerically, at step 3765, generating values for the action sequence triggering variables that define optimized card playing strategies for each player.

In certain embodiments, numerical hand strength values for the action sequence triggering variables obtained in step 3765 are mapped to corresponding discrete card hands at step 3775. In one embodiment, a sequence triggering variable is mapped to the discrete card hand having a hand ranking closest to the value obtained for the action sequence triggering variable. In other embodiments, a sequence triggering variable is mapped to the hand whose rank is immediately above or immediately below the value of the sequence triggering variable.

Two Player, One Round Game with Raising/No Check Raising

A second example of a game to which the method of the present invention may be applied is a modification to the two player, one round game of FIG. 34 in which raising, but not “check-raising”, is allowed. “Check raising” is an action sequence in which, for example, player 1 initially checks or passes, player 2 bets, and then player 1 raises. In the present example, if player 1 checks, and player 2 bets, player 1 can only either fold or call. In addition, in this example game, only 2 raises (one by each player) are allowed per game.

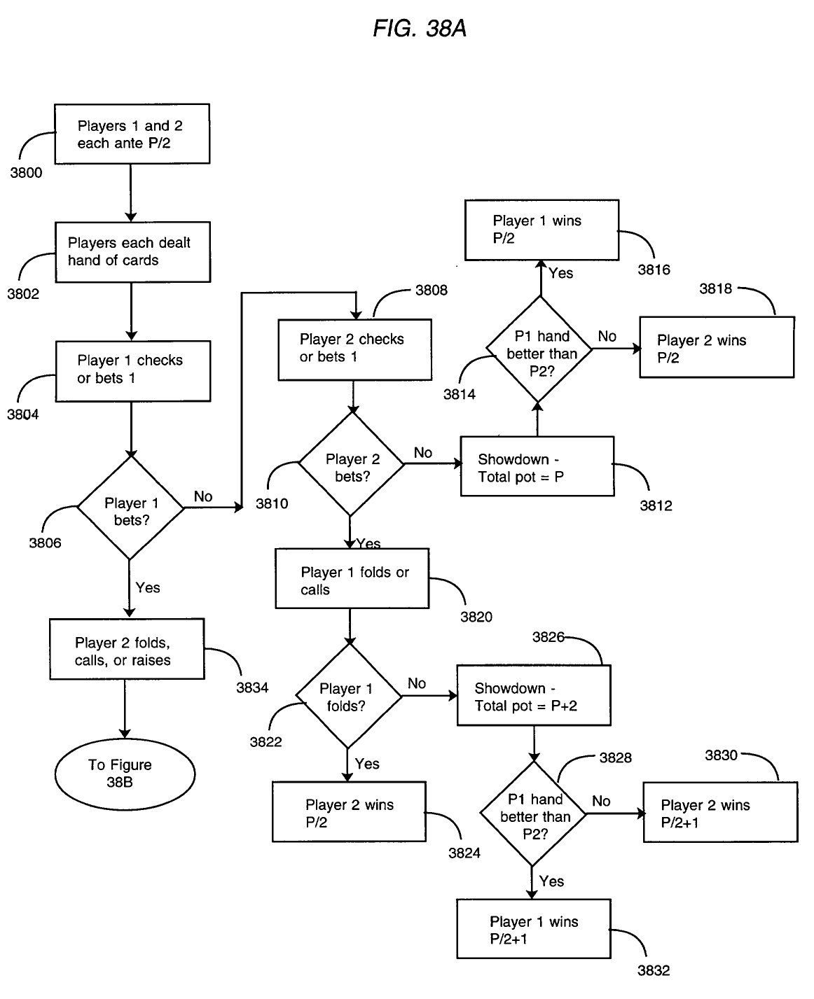

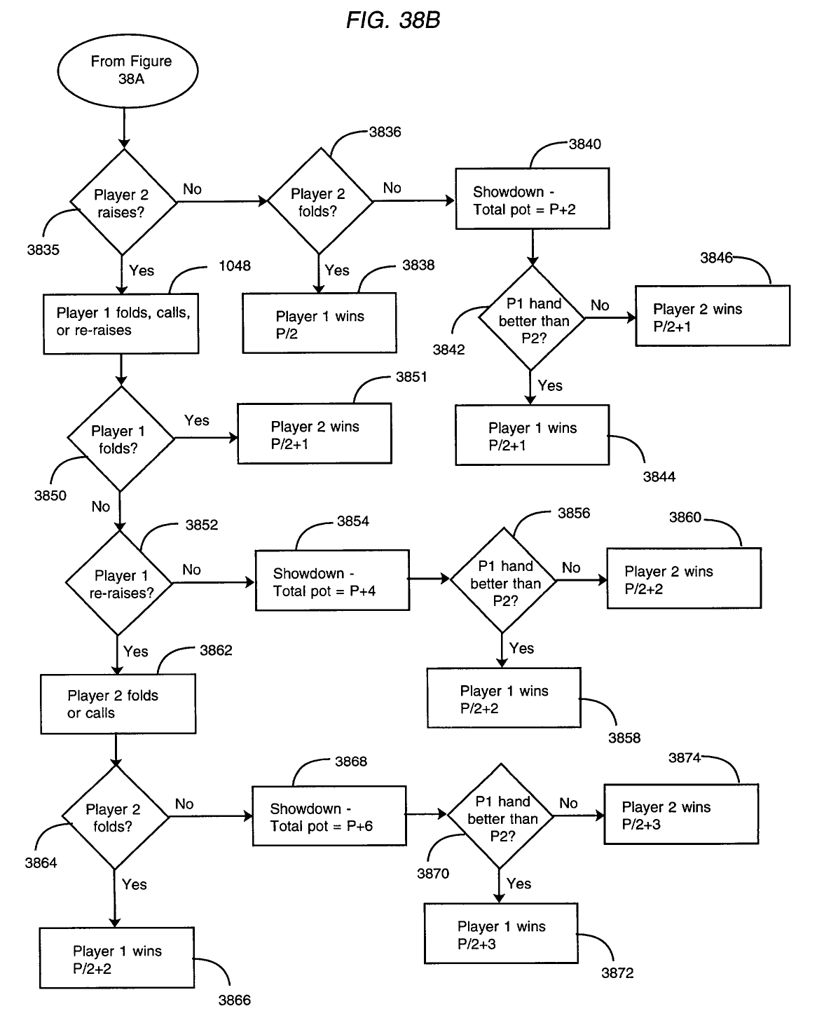

FIGS. 38A and 38B comprise a flow chart illustrating a sequence of events in a two-player, one round game with raising but no check-raising. As shown in FIG. 38A, the game starts at step 3800 with players 1 and 2 each paying an ante of P/2 (for a total ante of P). At step 3802, each player is dealt a hand of cards. At step 3804, player 1 (P1) checks (passes) or bets one. At step 3806, a determination is made as to whether P1 has bet or checked. If P1 has checked (not bet), player 2 (P2) may either check or bet 1 at step 3808. At step 3810, a determination is made as to whether P2 has checked or bet. If P2 has checked (not bet), there is a showdown at step 3812. The pot at this showdown contains only the total ante, P. At step 3814, a determination is made as to whether P1's hand is better than P2's. If P1's hand is better, P1 wins P/2 (total pot of P minus P1's investment of P/2) at step 3816. If P2's hand is better than P1's, P2 wins P/2 at step 3818.

If P2 bets instead of checks at step 3808, P1 may fold or call at block 3820. Because check raising is not allowed in this game, P1 may not raise here. At step 3822, a determination is made as to whether P1 folds. If P1 does fold, P2 wins P/2 at step 3824 (total pot of P+1 minus P2's investment of P/2+1).

If P1 calls (by putting a bet of 1 into the pot to match P2's bet) at step 3820, there is a showdown at step 3826. The total pot at this point is P+2 (each player has ante'd P/2 and bet one). At step 3828, a determination is made as to whether P1's hand is better than P2's. If P1's hand is better, P1 wins P/2+1 (total pot of P+2 minus P1's investment of P/2+1) at step 3832. If P2's hand is better, P2 wins P/2+1 at step 3830.

If P1 bets one instead of checking at step 3804, P2 may either fold, call, or raise at step 3834. From step 3834, the flow chart continues in FIG. 38B.

Referring to FIG. 38B, at steps 3835 and 3836, a determination is made as to whether P2 folds, calls, or raises at step 3832. If P2 folds, P1 wins P/2 (total ante of P plus P1's bet of one minus P1's investment of P/2+1) at step 3838. If P2 calls (by placing a bet of one into the pot to match P1's bet of one), there is a showdown at step 3840. At this point, the total pot is P+2 (total ante of P plus a bet of one by each of P1 and P2). At step 3842, a determination is made as to whether P1's hand is better than P2's. If P1's hand is better, P1 wins P/2+1 (total pot of P+2 minus P1's investment of P/2+1) at step 3844. If P2's hand is better, P2 wins P/2+1 at step 3846.

If P2 raises at block 3832 (by placing a total bet of two into the pot: one bet to match P1's bet of one and one bet to raise) P1 may either fold, call, or reraise at step 3848. At steps 3850 and 3852, a determination is made as to whether P1 folds, calls, or raises at step 3848. If P1 folds, P2 wins P/2+1 (total ante of P plus P1's bet of one plus P2's bet of two minus P2's investment of P/2+2) at step 3851.

If P1 calls (by placing a bet of one into the pot to match P2's raise of one) at step 3848, there is a showdown at step 3854. At this point, the total pot is P+4 (each player has ante'd P/2 and bet two). At step 3856, a determination is made as to whether P1's hand is better than P2's. If P1's hand is better, P1 wins P/2+2 (total pot of P+4 minus P1's investment of P/2+2) at step 3858. If P2's hand is better, P2 wins P/2+2 at step 3860.

If P1 reraises (by placing a total bet of two into the pot: one to match P2's raise of one and one to reraise by one) at step 3848, P2 may either fold or call at step 3862. At step 3864, a determination is made as to whether P2 folds or calls. If P2 folds, P1 wins P/2+2 (total ante of P plus P1's total bet of three plus P2's total bet of two minus P1's investment of P/2+3) at step 3866.

If P2 calls (by placing a bet of one into the pot to match P1's reraise) at step 3862, there is a showdown at step 3868. At this point, the total pot is P+6 (each player has ante'd P/2 and bet three). At step 3870, a determination is made as to whether P1's hand is better than P2's. If P1's hand is better, P1 wins P/2+3 (total pot of P+6 minus P1's investment of P/2+3) at step 3872. If P2's hand is better, P2 wins P/2+3 at step 3874.

The method of FIG. 37 may be applied to the game of FIGS. 38A and B as follows.

According to step 3710 of FIG. 37, the possible action sequences of each player are determined for the game of FIGS. 38A and 38B. These action sequences may be obtained by following the flow chart from step 3800 to each of the different resolutions of the game and noting the actions that each player takes leading to each resolution.

In FIGS. 38A and 38B, the resolutions that occur consist of either a player folding (with the result that the other player wins) or a showdown (with the result that the player with the better hand wins). In the game of FIGS. 38A and 38B, a resolution by folding occurs at steps 3824, 3838, 3851, and 3866. A resolution by showdown occurs at steps 3812, 3826, 3840, 3854, and 3868.

The action sequences for each player that lead to the resolution by folding at step 3824 are: (i) P1 checks, then folds; and (ii) P2 bets. For the resolution by folding at step 3838, the action sequences are: (i) P1 bets; and (ii) P2 folds. For the resolution by folding at step 3851, the action sequences are: (i) P1 bets, then folds; and (ii) P2 raises. For the resolution by folding at step 3866, the action sequences are: (i) P1 bets, then reraises; and (ii) P2 raises, then folds.

The action sequences for each player leading to the showdown at step 3812 are: (i) P1 checks; and (ii) P2 checks. The action sequences leading to the showdown at step 3826 are: (i) P1 checks, then calls; and (ii) P2 bets. The action sequences leading to the showdown at step 3840 are: (i) P1 bets; and (ii) P2 calls. The action sequences leading to the showdown at step 3854 are: (i) P1 bets, then calls; and (ii) P2 raises. The action sequences leading to the showdown at step 3868 are: (i) P1 bets, then reraises; and (ii) P2 raises, then calls.

The possible action sequences for each player and the resulting outcomes obtained according to steps 3710 and 3715 of FIG. 37 for the game of FIGS. 38A and 38B are summarized in Table 21. In Table 21, the equivalent term “pass” is used instead of “check.”

TABLE 21
Action Sequences and Outcomes

| Resolution Step | P1 Action Seq. | P2 Action Seq. | Outcome |
|---|---|---|---|
| By folding | | | |
| 3824 | pass-fold | bet | P2 wins P/2 |
| 3838 | bet | fold | P1 wins P/2 |
| 3851 | bet-fold | raise | P2 wins P/2 + 1 |
| 3866 | bet-re | raise-fold | P1 wins P/2 + 2 |
| | raise | | |
| By showdown | | | |
| 3812 | pass | pass | High hand wins P/2 |
| 3826 | pass-call | bet | High hand wins |
| | | | P/2 + 1 |
| 3840 | bet | call | High hand wins |
| | | | P/2 + 1 |
| 3854 | bet-call | raise | High hand wins |
| | | | P/2 + 2 |
| 3868 | bet-re | raise-call | High hand wins |
| | raise | | P/2 + 3 |

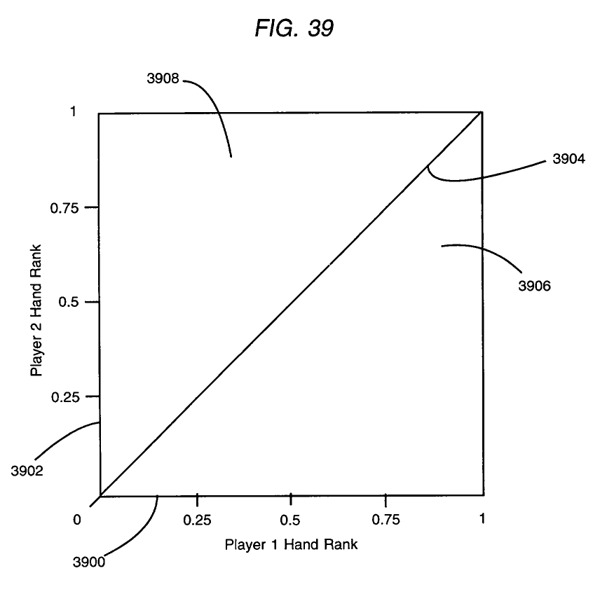

At step 3720 in FIG. 37, a model is constructed comprising an axis representing the hand strength of each of P1 and P2. This model is shown in FIG. 39. The model includes hand strength axes 3900 and 3902 for P1 and P2, respectively, and dividing line 3904 that separates the model into region 3906 in representing games in which P1's hands are better than P2's and region 3908 representing games in which P2's hands are better than P1's.

According to step 3725 in FIG. 37, variables are assigned to dividing points representing hand strength thresholds that trigger each of the action sequences for each player identified in step 3710. Looking first at P1, as shown in Table 21, the possible action sequences for P1 are pass, pass-fold, or pass-call, and bet, bet-fold, bet-call or bet-reraise.

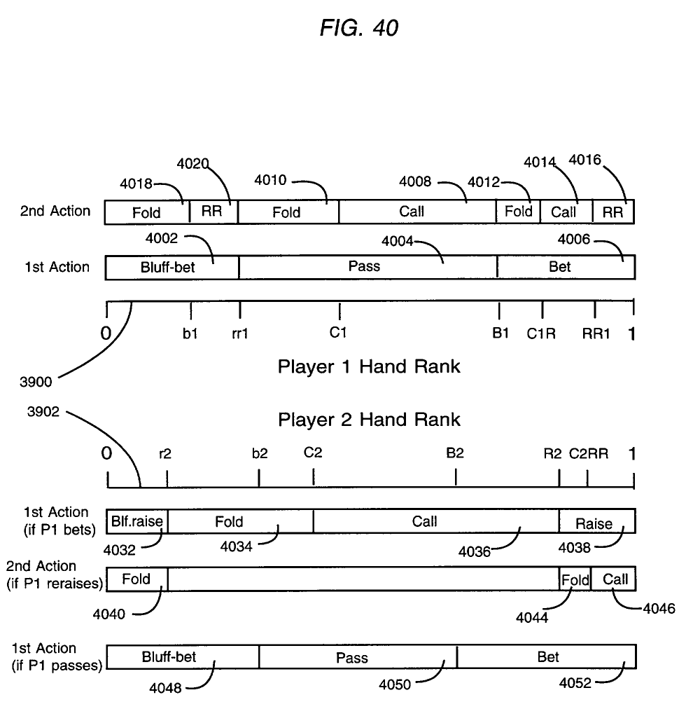

P1's first action choice is to pass or bet (either legitimately or as a bluff-bet). A first variable, for example “B1,” is assigned to the hand strength that is the lowest hand strength with which P1 will bet legitimately. A second variable, for example “rr1,” is assigned to the highest hand strength with which P1 will bluff bet. FIG. 40 shows P1's hand strength axis 3900 from FIG. 39. As shown in FIG. 40, variable B1 is initially placed at a location towards the high end of axis 3900, and variable rr1 is placed at a location towards the low end of axis 3900. As shown in FIG. 40, the hands 4002 between zero and rr1 represent hands with which P1 bluff-bets. The hands 4004 between rr1 and B1 represent hands with which P1 passes (or checks). The hands 4006 between B1 and 1 represent hands with which P1 bets.

P1's second action choices depend on P1's first action choice, and in certain cases also on P2's first action choice.

If P1's first action is to pass, a second action choice for P1 arises only if P2's first action is to bet (if P2's first action after a pass by P1 is to check, there is an immediate showdown. P1 has no further action choices). In this situation, P1's second action choice is to fold or call. If P1 calls, P1 may call either with the intention of beating a legitimate bet by P2 or to call a potential bluff-bet by P2.

Using the method of the invention, a variable, for example “C1,” is assigned to the lowest of P1's passing hands 4004 with which P1 will call. As shown in FIG. 40, the hands 4010 between b1 and C1 represent the portion of P1's passing hands with which P1 will fold, while the hands 4008 between C1 and B1 represent the portion of P1's passing hands 4004 with which P1 will call (the upper part of this portion represents hands with which P1 calls with the intent of beating a legitimate bet by P2, while the lower part represents hand with which P1 calls to beat a potential bluff-bet by P2). The interval between b1 and C1 thus represents hands that trigger a “pass-fold” action sequence, while the interval between C1 and B1 represents hands that trigger a “pass-call” action sequence.

If P1's first action is to bet, a second action choice for P1 arises only if P2 raises. (If P2 folds or calls, there is an immediate resolution: P1 wins if P2 folds, or there is a showdown if P2 calls). In this situation, P1 may fold, call, or reraise. Further, if P1 reraises, P1 may legitimately reraise or bluff-reraise.

According to the invention, a variable, for example “C1R,” is assigned to the lowest of P1's legitimate betting hands 4006 with which P1 will call a raise by P2, while another variable, for example “RR1,” is assigned to the lowest of P1's betting hands 4006 with which P1 will reraise a raise by P2. In this example, it is assumed that P1 will reraise with better hands than hands with which P1 calls. As shown in FIG. 40, the variables C1R and RR1 are placed on P1's hand strength axis 3900 within the interval 4006 representing P1's betting hands such that RR1>C1R. Accordingly hands 4012 between B1 and C1R represent hands that trigger a “bet-fold” sequence. Hands 4014 between C1R and RR1 represent hands that trigger a “bet-call” sequence. Hands 4016 between RR1 and 1 represent hands that trigger a “bet-reraise” sequence.

With respect to P1's bluff-betting hands 4002, P1 will also reraise with a portion of these hands and fold with the remainder. In this embodiments it is assumed that P1 bluff-reraises with the higher of P1's bluff-betting hands. In other embodiments, it is assumed that P1 bluff-reraises with the lower, or some other portion, of P1's bluff-betting hands.

A variable, for example “b1,” is assigned to the lowest of P1's bluff-betting hands 4002 with which P1 will bluff-reraise. As shown in FIG. 40, hands 4018 between 0 and b1 accordingly represent hands that trigger a “(bluff) bet-fold” sequence, while hands 4020 between b1 and rr1 represent hands that trigger a “(bluff) bet-reraise” sequence.

Turning to P2, P2's action choices depend on whether P1's first action choice is to pass or to bet. If P1's first action choice is to bet, P2 may either fold, call, or raise. When P2 raises, P2 may either legitimately raise or bluff-raise. According to the invention, a first variable, for example “R2,” is assigned to the lowest ranking hand with which P2 will legitimately raise if P1's first action is to bet. A second variable, for example “C2,” is assigned to the lowest ranking hand with which P2 will call if P1's first action is to bet. A third variable, for example “r2,” is assigned to the highest ranking hand with which P2 will bluff-raise. As shown in FIG. 34, these variables are assigned to relative positions on P2's hand rank axis 3902 in FIG. 40 such that R2>C2>r2. Accordingly, hands 4032 between 0 and r2 represent hands with which P2 bluff raises if P1 bets. Hands 4034 between r2 and C2 represent hands with which P2 folds if P1 bets. Hands 4036 between C2 and R2 represent hands with which P2 calls if P1 bets. Hands 4038 between R2 and 1 represent hands with which R2 raises if P1 bets.

P2 will have second action choices only for the case where P1 bets, P2 raises (bluff or legitimate), and P1 reraises. For all other cases, there will be an immediate resolution, either by folding or showdown, after P2's first action. Thus P2's second action choices are limited to those hands 4032 and 4038 with which P2 initially raised after P1 bet. P2's choices for these hands is to either fold or call (since P2 has already raised once, no further raising by P2 is allowed). P2 has little chance of winning a showdown with the hands 4032 with which P2 bluff-raised. So P2 folds with these hands if P1 reraises. P2 will call P1's reraise with the better of P2's legitimate raising hands 4038. According to the invention, a variable, for example “C2RR,” is assigned to the lowest of P2's raising hands 4038 with which P2 will call a reraise by P1. As shown in FIG. 40, hands 4040 and 4044 between 0 and r2, and R2 and C2RR, respectively, represent hands with which P2 initially raises if P1 bets and folds if P1 reraises. These hands therefore represent a “raise-fold” action sequence. Hands 4046 between C2RR and 1 represent hands with which P2 initially raises if P1 bets and calls if P1 reraises. These hands therefore represent a “raise-call” action sequence.

If P1's first action choice is to pass, P2's action choices are either to pass or to bet (legitimately and as a bluff). According to the invention, a first variable, for example “b2,” is assigned to the highest ranking hand with which P2 will bluff bet after P1 passes. A second variable, for example “B2,” is assigned to the lowest ranking hand with which P2 will legitimately bet. As shown in FIG. 40, b2 is placed on P2's hand rank axis 3902 between r2 and C2, while B2 is placed between C2 and R2. Hands 4048 between 0 and b2 thus represent hands with which P2 will bluff bet if P1 passes. Hands 4050 between b2 and B2 represent hands with which P2 will pass if P1 passes. Hands 4052 represent hands with which P2 will legitimately bet if P1 passes.

According to step 3730, a relative order is assigned to the variables assigned to the hand strengths that trigger the different action sequences for each of P1 and P2. During the assignment process described above for assigning the variables shown on FIG. 40, the relative orders for the variables for P1 and the relative order for the variables for P2 were already determined. The relative order of the variables for P1 and P2 with respect to each other must also be determined. For the example embodiment of FIG. 40, the relative order for all variables is: 0<r2<b1<rr1<b2<C2<=C1<B2<B1<C1R<R2<C2RR<RR1.

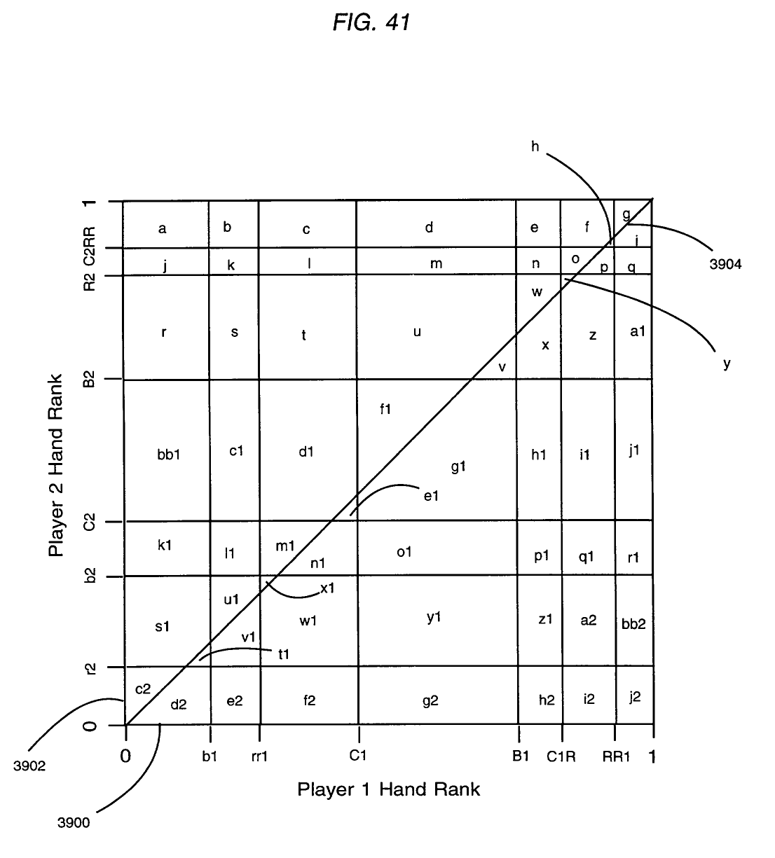

According to step 3735 of FIG. 37, the variables are located on the respective axes of P1 and P2 in arbitrary positions in the assigned relative order. FIG. 41 shows the respective variables for P1 and P2 assigned to their respective axes 3900 and 3902 in the assigned relative order.

According to steps 3740, 3745, and 3750 of FIG. 37, the model is divided into separate portions representing each of the possible outcomes, and the size and the return to a player for each outcome region is determined.

In this example, steps 3740-3750 are performed as follows. First, the model of FIG. 41 is divided into regions as shown in FIG. 41 by drawing lines perpendicular to each axis 3900 and 3902 at each variable location. The resulting regions are identified in FIG. 41 by the letters a-z, a1, bb1, c1-z1, a2, bb2, and c2-j2, respectively.

Next, the regions representing each outcome listed in Table 21 are identified using the action triggering intervals shown in FIG. 40.

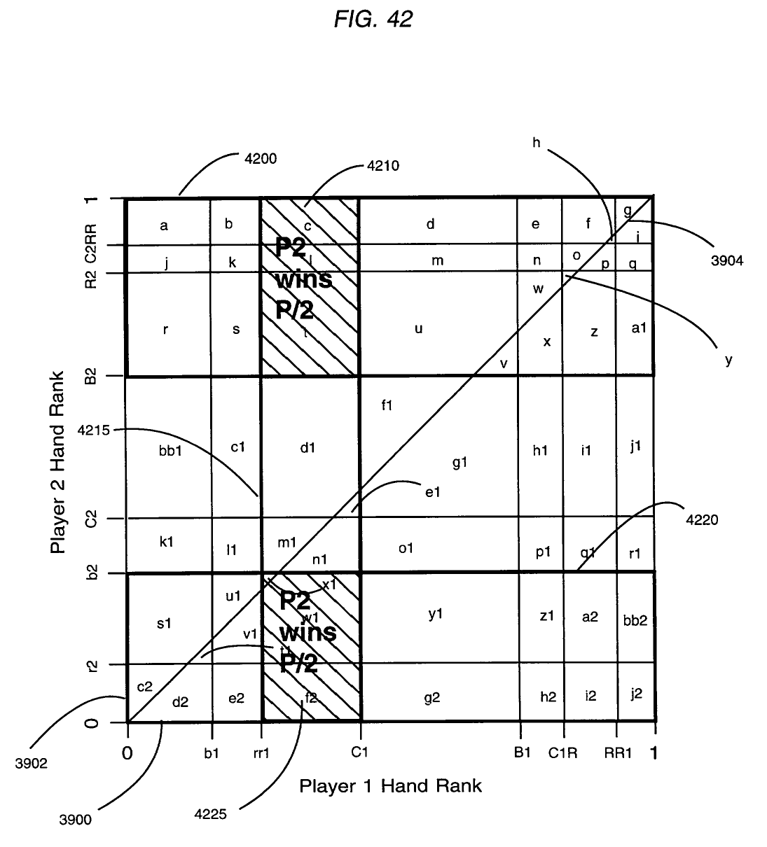

The first outcome listed in Table 21 occurs at resolution step 3824 for games in which P1 pass-folds and P2 bets. Referring to FIG. 40, P1 pass-folds with hands 4010 between rr1 and C1. These hands are indicated by rectangle 4215 in FIG. 42. P2's betting hands, after P1 passes, according to FIG. 40, are bluff-bet hands 4048 between 0 and b2 (indicated by rectangle 4220 in FIG. 42) and legitimate betting hands 4052 between B2 and 1 (indicated by rectangle 4200 in FIG. 42). The games for which P1 pass-folds and P2 bets are indicated in FIG. 42 by the rectangles 4210 and 4225 formed where rectangle 4215 intersects with rectangles 4200 and 4220. According to Table 21, and as indicated in FIG. 42, P2 wins P/2 for the games in rectangles 4210 and 4225. The return to P1 in rectangles 4210 and 4225 is thus −P/2. The expected return to P1 (“E1”) due to games resolved at step 3824 is the area of rectangles 4210 and 4225 multiplied by −P/2:

$${E1}_{3824} = - \frac{P}{2} [ ( ( C1 - rr1 ) ( b2 ) + ( C1 - rr1 ) ( 1 - B2 ) ]$$

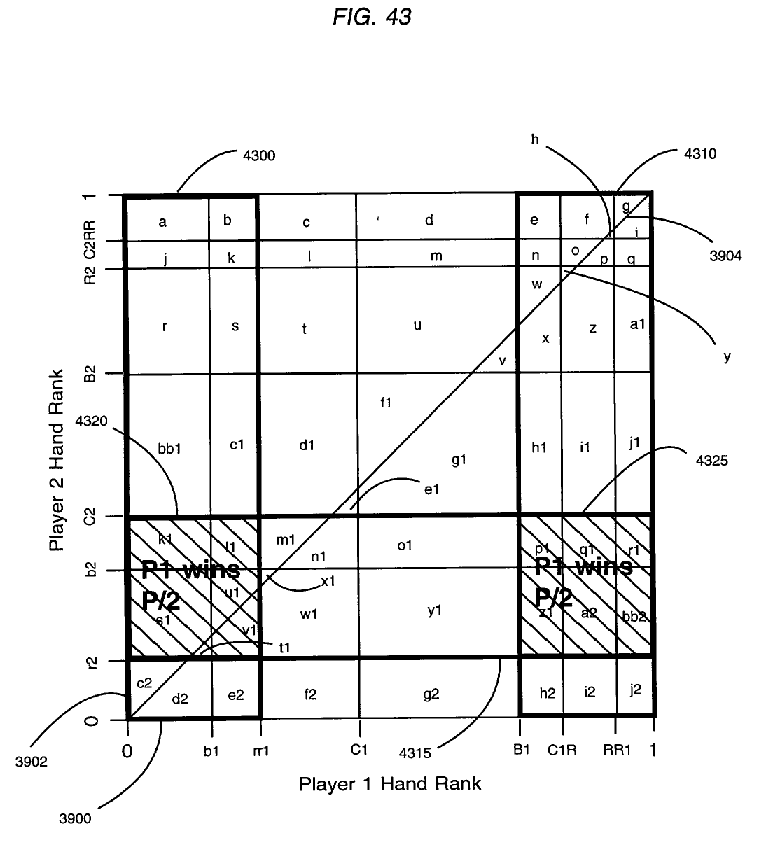

The second outcome listed in Table 21 occurs at resolution step 3838 for games in which P1 bets and P2 folds. Referring to FIG. 40, P1 bluff-bets with hands 4002 between 0 and rr1 (indicated by rectangle 4300 in FIG. 43) and legitimately bets with hands 4006 between B1 and 1 (indicated by rectangle 4310 in FIG. 43). P2's folding hands, after P1 bets, according to FIG. 40, are hands 4034 between r2 and C2 (indicated by rectangle 4315 in FIG. 43). The games for which P1 bets and P2 folds are indicated in FIG. 43 by rectangles 4320 and 4325 formed where rectangle 4315 intersects with rectangles 4300 and 4310, respectively. According to Table 21, and as indicated in FIG. 43, P1 wins P/2 for the games in rectangles 4320 and 4325. The expected return to P1 due to games resolved at step 3838 is the area of rectangles 4320 and 4325 multiplied by P/2:

$${E1}_{3838} = \frac{P}{2} [ rr1 ( C2 - r2 ) + ( 1 - B1 ) ( C2 - r2 ) ]$$

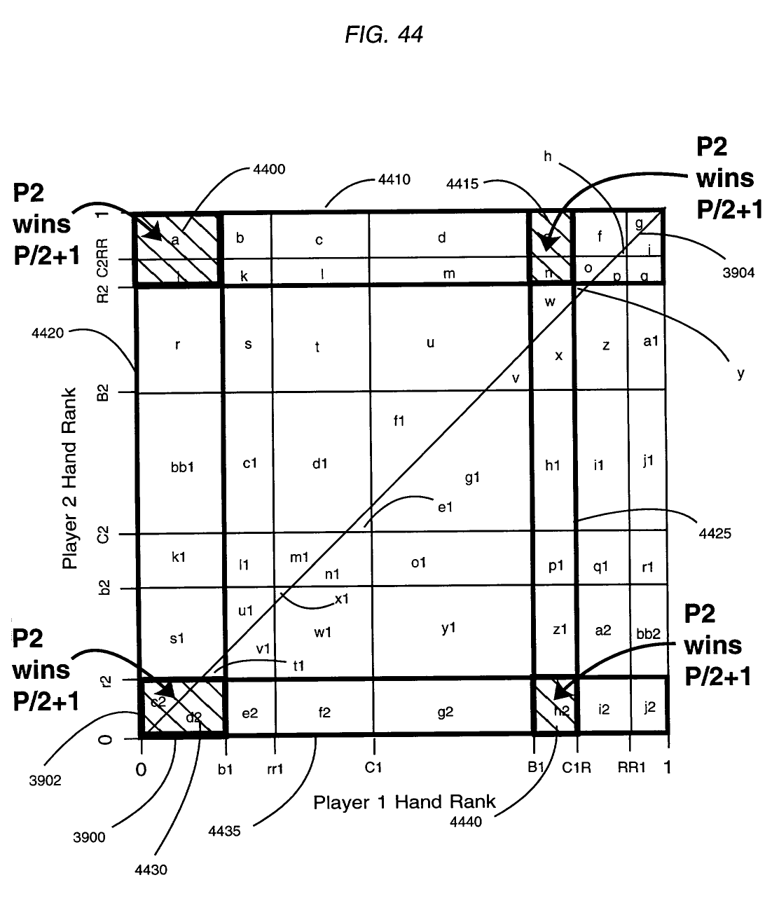

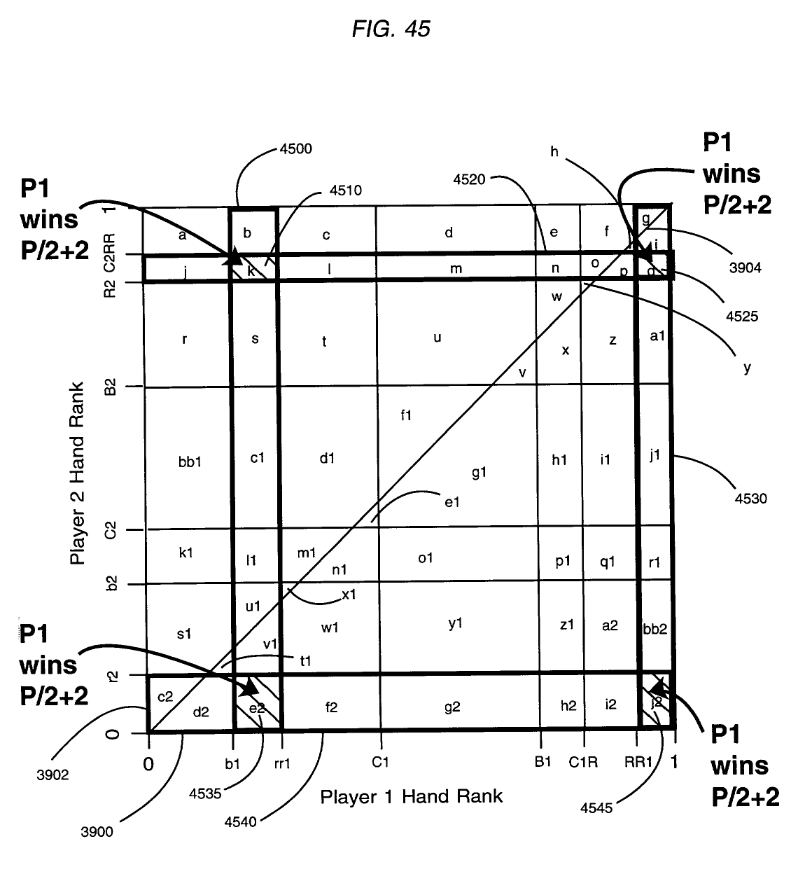

The third outcome listed in Table 21 occurs at resolution step 3851 for games in which P1 bet-folds and P2 raises. Referring to FIG. 40, P1 bet-folds with hands 4018 between 0 and b1 (indicated by rectangle 4420 in FIG. 44) and with hands 4012 between B1 and C1R (indicated by rectangle 4425 in FIG. 44). P2 raises, after P1 bets, with hands 4032 between 0 and r2 (indicated by rectangle 4435 in FIG. 44) and with hands 4038 between R2 and 1. The games in which P1 bet-folds and P2 raises are indicated in FIG. 44 by rectangles 4400, 4415, 4430 and 4440. According to Table 21, and as indicated in FIG. 44, P2 wins (P1 loses) P/2+1 for games in rectangles 4400, 4415, 4430 and 4440. The expected return to P1 due to games resolved at step 3851 is the area of rectangles 4400, 4415, 4430 and 4440 multiplied by −(P/2+1):

$$\begin{matrix}{E1}_{3851} = - ( \frac{P}{2} + 1 ) [ ( b1 ) ( 1 - R2 ) + ( C1R - B1 ) ( 1 - R2 ) + \\ ( b1 ) ( r2 ) + ( C1R - B1 ) ( r2 ) ]\end{matrix}$$

The fourth outcome listed in Table 21 occurs at resolution step 3866 for games in which P1 bet-reraises and P2 raise-folds. Referring to FIG. 40, P1 bet-reraises with hands 4020 between b1 and rr1 (indicated by rectangle 4500 in FIG. 45) and with hands 4016 between RR1 and 1 (indicated by rectangle 4530 in FIG. 45). P2 raise-folds with hands 4040 between 0 and r2 (indicated by rectangle 4540 in FIG. 45) and with hands 4044 between R2 and C2RR. The games in which P1 bet-reraises and P2 raise-folds are indicated in FIG. 45 by rectangles 4510, 4525, 4535 and 4545. According to Table 21, and as indicated in FIG. 45, P1 wins P/2+2 for games in rectangles 4510, 4525, 4535 and 4545. The expected return to P1 due to games resolved at step 3866 is the area of rectangles 4510, 4525, 4535 and 4545 multiplied by P/2+2:

$$\begin{matrix}{E1}_{3866} = ( \frac{P}{2} + 2 ) [ ( rr1 - b1 ) ( C2RR - R2 ) + \\ ( 1 - RR1 ) ( C2RR - R2 ) + ( rr1 - b1 ) ( r2 ) + \\ ( 1 - RR1 ) ( r2 ) ]\end{matrix}$$

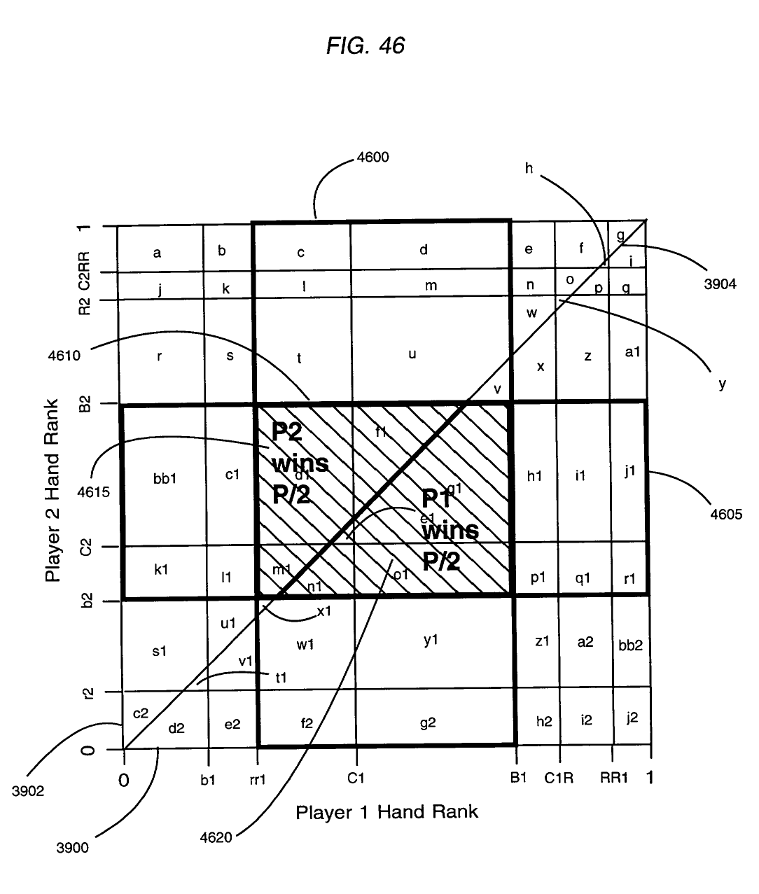

The fifth outcome listed in Table 21 occurs at resolution step 3812 for games in which P1 passes and P2 passes. Referring to FIG. 40, P1 passes with hands 4004 between rr1 and B1 (indicated by rectangle 4600 in FIG. 46). P2 passes, after P1 passes, with hands 4050 between b2 and B2 (indicated by rectangle 4605 in FIG. 46). The games in which P1 passes and P2 passes are indicated in FIG. 46 by rectangle 4610. According to Table 21, the player with the higher hand wins P/2 for games in rectangle 4610. In FIG. 46, P2 has the higher hand for games above dividing line 3904, and P1 has the higher hands below dividing line 3904. P2 wins (P1 loses) P/2 in portion 4615 of rectangle 4610 that includes regions d1, f1 and m1. P1 wins P/2 in the remaining portion 4620 of rectangle 4610 that includes regions e1, g1, n1 and o1. The expected return to P1 due to games resolved at step 3812 is the area of portion 4615 of rectangle 4610 multiplied by −(P/2) plus the area of portion 4620 of rectangle 4610 multiplied by P/2:

$$\begin{matrix}{E1}_{3812} = - ( \frac{P}{2} ) [ ( b2 - rr1 ) ( B2 - b2 ) + \frac{{( B2 - b2 )}^{2}}{2} ] + \\ \frac{P}{2} [ ( B1 - B2 ) ( B2 - b2 ) + \frac{{( B2 - b2 )}^{2}}{2} ]\end{matrix}$$

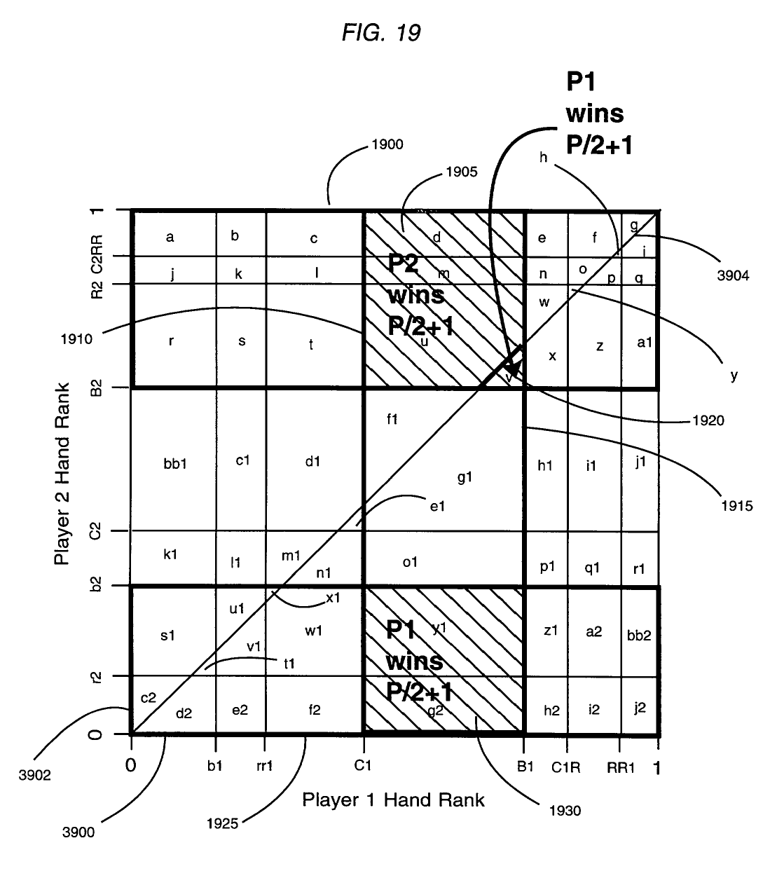

The sixth outcome listed in Table 21 occurs at resolution step 3826 for games in which P1 pass-calls and P2 bets. Referring to FIG. 40, P1 pass-calls with hands 4008 between C1 and B1 (indicated by rectangle 1915 in FIG. 19). P2 bets, after P1 passes, with hands 4048 between 0 and b2 (indicated by rectangle 1925 in FIG. 19) and hands 4052 between B2 and 1 (indicated by rectangle 1900 in FIG. 19). The games in which P1 pass-calls and P2 bets are indicated in FIG. 19 by rectangles 1910 and 1930. According to Table 21, the player with the higher hand wins P/2+1 for games in rectangles 1910 and 1930. In FIG. 19, P2 has the higher hand for games above dividing line 3904, and P1 has the higher hands below dividing line 3904. P2 wins (P1 loses) P/2+1 in portion 1905 of rectangle 1910 that includes regions d, m and u. P1 wins P/2+1 in the remaining portion 1920 of rectangle 1910 that includes region v and in all of rectangle 1930. The expected return to P1 due to games resolved at step 3826 is the area of portion 1905 of rectangle 1910 multiplied by −(P/2+1) plus the area of portion 1920 of rectangle 1910 multiplied by P/2+1 plus the area of rectangle 1930 multiplied by P/2+1:

$$\begin{matrix}{E1}_{3826} = - ( \frac{P}{2} + 1 ) [ ( B1 - C1 ) ( 1 - B2 ) + \frac{{( B1 - b2 )}^{2}}{2} ] + \\ ( \frac{P}{2} + 1 ) [ \frac{{( B1 - B2 )}^{2}}{2} + ( B1 - C1 ) ( b2 ) ]\end{matrix}$$

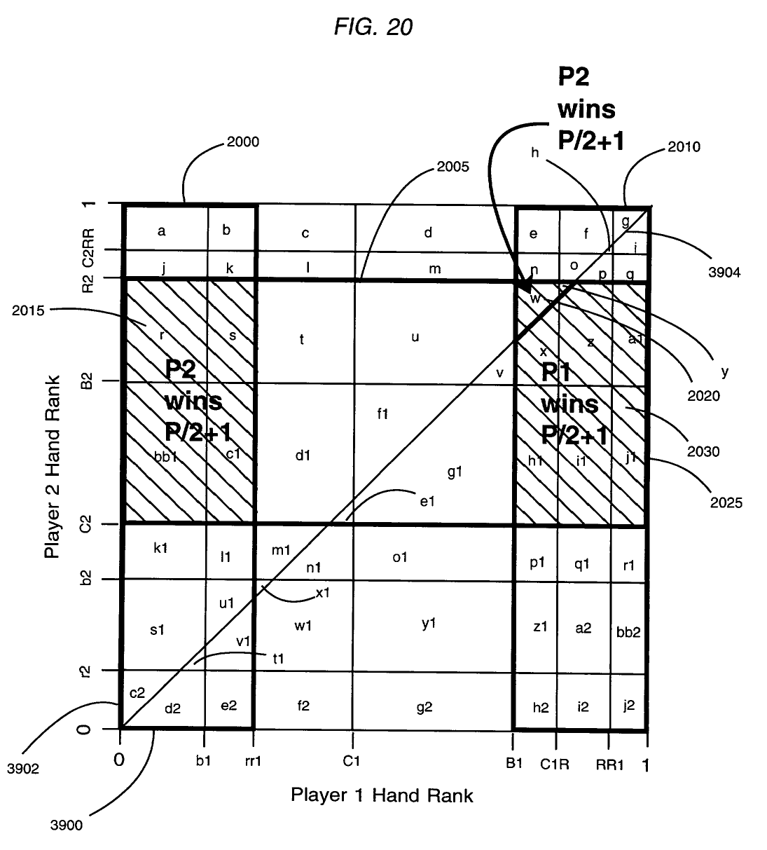

The seventh outcome listed in Table 21 occurs at resolution step 3840 for games in which P1 bets and P2 calls. Referring to FIG. 40, P1 bets with hands 4002 between 0 and rr1 (indicated by rectangle 2000 in FIG. 20) and with hands 4006 between B1 and 1 (indicated by rectangle 2010 in FIG. 20). P2 calls, after P1 bets, with hands 4036 between C2 and R2 (indicated by rectangle 2005 in FIG. 20). The games in which P1 bets and P2 calls are indicated in FIG. 20 by rectangles 2015 and 2025. According to Table 21, the player with the higher hand wins P/2+1 for games in rectangles 2015 and 2025. In FIG. 20, P2 has the higher hand for games above dividing line 3904, and P1 has the higher hands below dividing line 3904. P2 wins (P1 loses) P/2+1 in rectangle 2015 and in portion 2020 of rectangle 2015 that includes regions w and y. P1 wins P/2+1 in the remaining portion 2030 of rectangle 2025 that includes regions x, z, a1, h1, i1 and j1. The expected return to P1 due to games resolved at step 3840 is the area of rectangle 2015 and of portion 2020 of rectangle 2025 multiplied by −(P/2+1) plus the area of portion 2030 of rectangle 2025 multiplied by P/2+1:

$$\begin{matrix}{E1}_{3840} = - ( \frac{P}{2} + 1 ) [ ( rr1 ) ( R1 - C2 ) + \frac{{( R2 - B1 )}^{2}}{2} ] + \\ ( \frac{P}{2} + 1 ) [ ( 1 - B1 ) ( R2 - C2 ) - \frac{{( R2 - B1 )}^{2}}{2} ]\end{matrix}$$

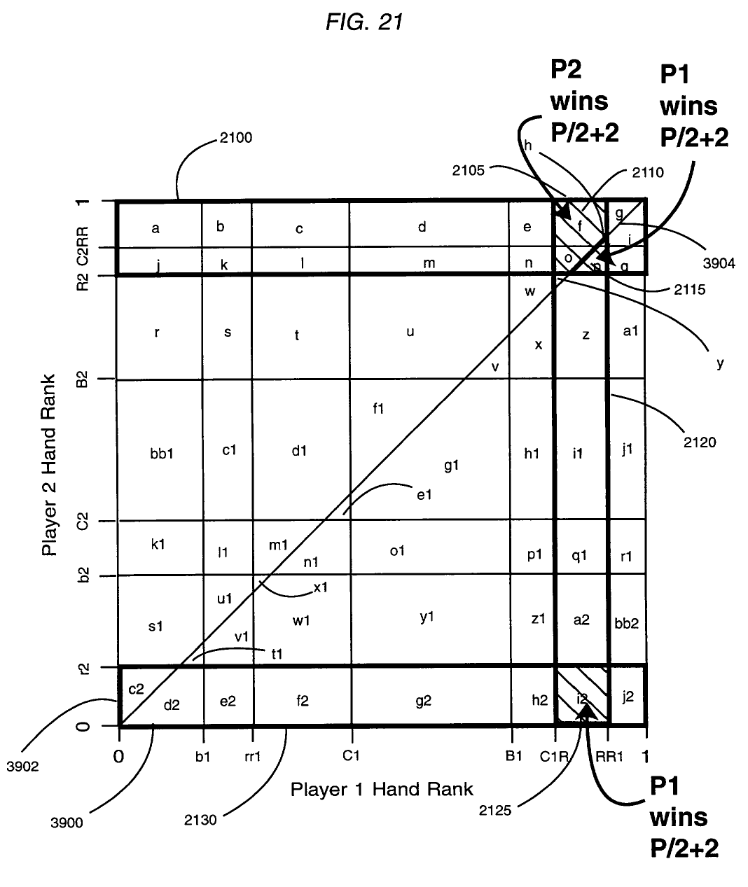

The eighth outcome listed in Table 21 occurs at resolution step 3854 for games in which P1 bet-calls and P2 raises. Referring to FIG. 40, P1 bet-calls with hands 4014 between C1R and RR1 (indicated by rectangle 2120 in FIG. 21). P2 raises, after P1 bets, with hands 4032 between 0 and r2 (indicated by rectangle 2130 in FIG. 21) and with hands 4038 between R2 and 1 (indicated by rectangle 2100 in FIG. 21). The games in which P1 bet-calls and P2 raises are indicated in FIG. 21 by rectangles 2105 and 2125. According to Table 21, the player with the higher hand wins P/2+2 for games in rectangles 2105 and 2125. In FIG. 21, P2 has the higher hand for games above dividing line 3904, and P1 has the higher hands below dividing line 3904. P2 wins (P1 loses) P/2+2 in portion 2110 of rectangle 2105 that includes regions f and o. P1 wins P/2+2 in the remaining portion 2115 of rectangle 2105 that includes regions p and h and in all of rectangle 2125. The expected return to P1 due to games resolved at step 3854 is the area of portion 2110 of rectangle 2105 multiplied by −(P/2+2) plus the area of portion 2115 of rectangle 2105 and of rectangle 2125 multiplied by P/2+2:

$${E1}_{3854} = - ( \frac{P}{2} + 2 ) [ ( RR1 - C1R ) ( 1 - R2 ) - \frac{{( RR1 - R2 )}^{2}}{2} ] + ( \frac{P}{2} + 2 ) [ \frac{{( RR1 - R2 )}^{2}}{2} + ( RR1 + C1R ) ( r2 ) ]$$

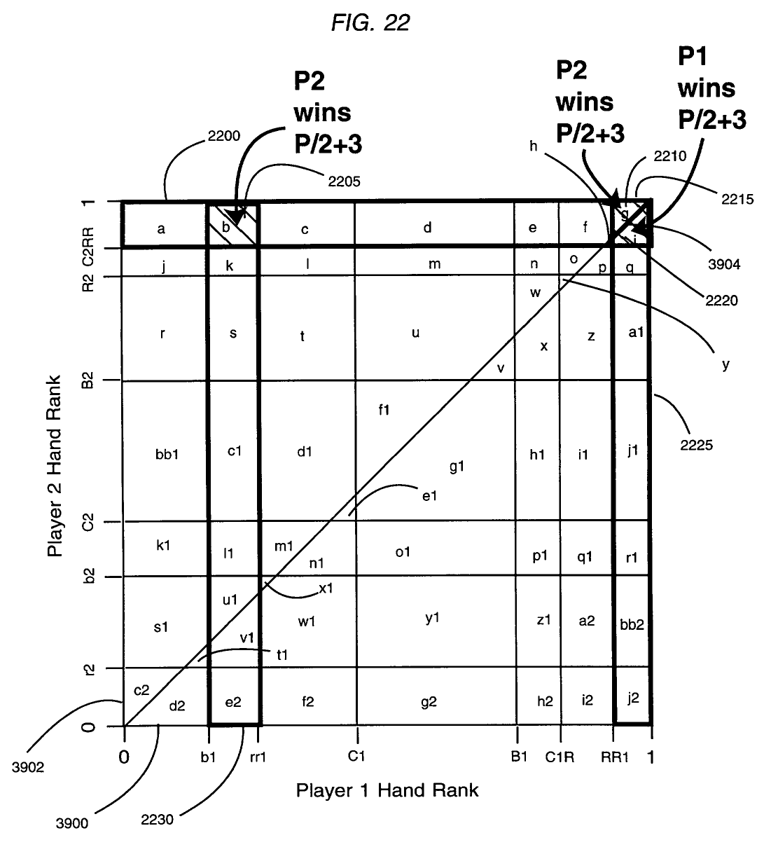

The ninth and final outcome listed in Table 21 occurs at resolution step 3868 for games in which P1 bet-reraises and P2 raise-calls. Referring to FIG. 40, P1 bet-reraises with hands 4020 between b1 and rr1 (indicated by rectangle 2230 in FIG. 22) and with hands 4016 between RR1 and 1 (indicated by rectangle 2225 in FIG. 22). P2 raise-calls with hands 4046 between C2RR and 1 (indicated by rectangle 2200 in FIG. 22). The games in which P1 bet-reraises and P2 raise-calls are indicated in FIG. 22 by rectangles 2205 and 2215. According to Table 21, the player with the higher hand wins P/2+3 for games in rectangles 2205 and 2215. In FIG. 22, P2 has the higher hand for games above dividing line 3904, and P1 has the higher hands below dividing line 3904. P2 wins (P1 loses) P/2+3 in portion 2210 of rectangle 2215 that includes region g and in rectangle 2205. P1 wins P/2+3 in the remaining portion 2220 of rectangle 2215 that includes region i. The expected return to P1 due to games resolved at step 3868 is the area of rectangle 2205 and of portion 2210 of rectangle 2215 multiplied by −(P/2+3) plus the area of portion 2220 of rectangle 2215 multiplied by P/2+3:

$${E1}_{3868} = - ( \frac{P}{2} + 3 ) [ ( rr1 - b1 ) ( 1 - C2RR ) + \frac{{( 1 - RR1 )}^{2}}{2} ] + ( \frac{P}{2} + 3 ) [ ( 1 - RR1 ) ( 1 - C2RR ) - \frac{{( 1 - RR1 )}^{2}}{2} ]$$

According to step 3755 of FIG. 37, an expression for a player's expected return is generated by taking the sum of the expected return due to games in each of the portions representing the different outcomes. The total expected return for P1 is thus:

E1=E1₃₈₂₄+E1₃₈₃₈E1₃₈₅₁+E1₃₈₆₆+E1₃₈₁₂E1₃₈₂₆+E1₃₈₄₀+E1₃₈₅₄+E1₃₈₆₈

Inserting the expressions for the expected returns due to games in each of the different portions, and rearranging, results is the following form of an equation for E1:

$$\begin{matrix}E1 = {B2}^{2} + Cl - b2C1 - B2C1 + C1R - C2 - C2RR + 2 r2 - \\ 3 C1Rr2 + B1b2 + B1B2 + B1B2 + B1C2 + B1r2 - R2 - \\ C1RR2 + {R2}^{2} + 2 b1 - 5 b1C2RR - 3 b1r2 + 3 b1R2 - 3 rr1 + \\ C2rr1 + 5 C2RRrr1 + 2 r2rr1 - 3 R2rr1 + RR1 + C2RRRR1 - \\ {RR1}^{1} + P ( \frac{1}{2} {b2}^{2} - b2C1 - C1Rr2 + B1r2 - b1C2RR - b1r2 + \\ b1R2 + C2rr1 + C2RRrr1 - R2rr1 )\end{matrix}$$

According to step 3760, the partial derivative of the expression for E1 is taken with respect to each sequence triggering variable (i.e. all of the variables in E1 except P), and each partial derivative is set equal to zero:

$$\begin{matrix}\frac{\partial E1}{\partial b1} = 2 - 5 C2RR - 3 r2 + 3 R2 + P ( - C2RR - r2 + R2 ) = 0 & ( 8 ) \\ \frac{\partial E1}{\partial B1} = b2 - B2 + C2 + r2 + r2P = 0 & ( 9 ) \\ \frac{\partial E1}{\partial b2} = - C1 + B1 + P ( b2 - C1 ) = 0 & ( 10 ) \\ \frac{\partial E1}{\partial B2} = 2 B2 - C1 - B1 = 0 & ( 11 ) \\ \frac{\partial E1}{\partial C1} = 1 - b2 - B2 - b2P = 0 & ( 12 ) \\ \frac{\partial E1}{\partial C1R} = 1 - 3 r2 - R2 - r2P = 0 & ( 13 ) \\ \frac{\partial E1}{\partial C1} = - 1 + B1 + rr1 + rr1P = 0 & ( 14 ) \\ \frac{\partial E1}{\partial C2RR} = - 1 - 5 b1 + 5 rr1 + RR1 + p ( - b + rr1 ) = 0 & ( 15 ) \\ \begin{matrix}\frac{\partial E1}{\partial r2} = 2 - 3 C1R + B1 - 3 b1 + 2 rr1 + \\ P ( - C1R + B1 - b1 ) = 0\end{matrix} & ( 16 ) \\ \frac{\partial E1}{\partial R2} = - 1 - C1R + 2 R2 + 3 b1 - 3 rr1 + P ( b1 - rr1 ) = 0 & ( 17 ) \\ \begin{matrix}\frac{\partial E1}{\partial rr1} = - 3 + C2 + 5 C2RR + 2 r2 - 3 R2 + P ( C2 + \\ C2RR - R2 ) = 0\end{matrix} & ( 18 ) \\ \frac{\partial E1}{\partial RR1} = 1 + C2RR - 2 RR1 = 0 & ( 19 )\end{matrix}$$

For any particular value of P, equations (8)-(19) are solved simultaneously (according to step 3765 of FIG. 37) to obtain values for the action sequence triggering variables. The solution may be performed by analytical and/or numerical techniques that are well known in the art. The resulting action sequence triggering values are mapped to corresponding actual card hands (according to step 3775 of FIG. 37), thereby generating card playing strategies by identifying subsets of hands for each player with which to play the different possible action sequences.

Two Player One Round Game with Check Raising

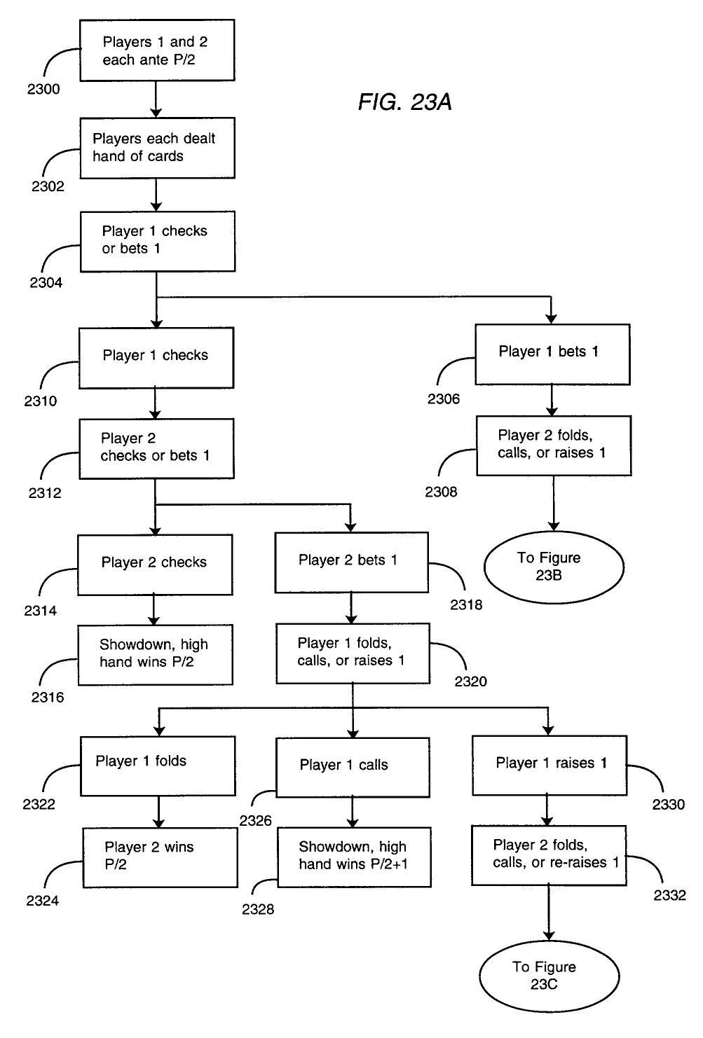

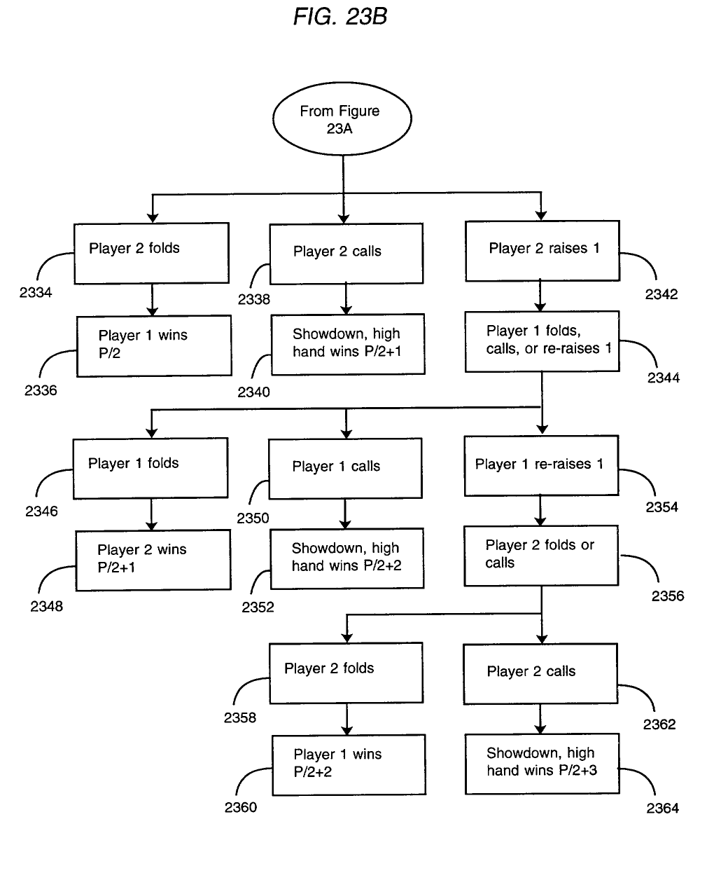

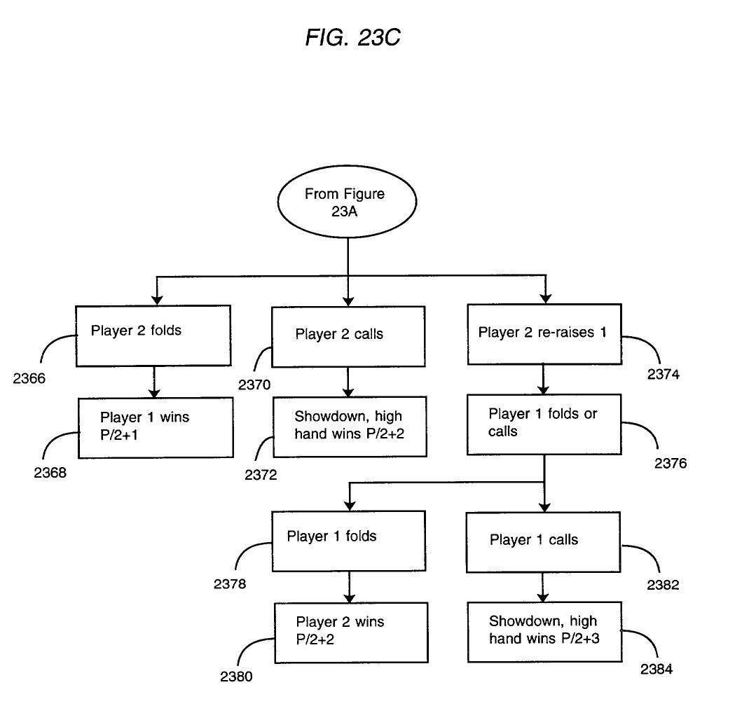

Another example of a game with which the method of the present invention may be used is a two-player one round game such as the game of FIGS. 38A-B in which check-raising is allowed. A flow chart for one embodiment of a two-player one-round game with check-raising is shown in FIGS. 23A-C.

As shown in FIG. 23A, the game begins with each player paying an ante of P/2 at step 2300. Each player is dealt a hand of cards at step 2302. At step 2304, P1 checks or bets one. If P1 bets, the game continues to step 2306. At step 2308, P2 folds, calls or raises. From step 2308, the flowchart continues to FIG. 23B.

If P2 folds at step 2308 in FIG. 23A, the game continues to step 2334 in FIG. 23B, and P1 wins P/2 at step 2336. If P2 calls at step 2308, the game continues to step 2338, and there is a showdown at step 2340. At step 2340, the player with the highest hand wins P/2+1.

If P2 raises at step 2308, the game continues to step 2342. At step 2344, P1 folds, calls, or reraises by one. If P1 folds at step 2344, the game continues to step 2346 and P2 wins P/2+1 at step 2348. If P1 calls at step 2344, the game continues to step 2350, and there is a showdown at step 2352. At step 2352, the player with the highest hand wins P/2+2.

If P1 reraises at step 2344, the game continues to step 2354. At step 2356, P2 folds or calls. If P2 folds at step 2356, the game continues to step 2358 and P1 wins P/2+2 at step 2360. If P2 calls at step 2356, the game continues to step 2362 and there is a showdown at step 2364. At step 2364, the player with the highest hand wins P/2+3.

Referring to FIG. 23A, if P1 checks (passes) at step 2304, the game continues to step 2310. At step 2312, P2 checks (passes) or bets 1. If P2 checks at step 2312, the game continues to step 2314, and there is a showdown at step 2316. If P2 bets at step 2312, the game continues to step 2318. At step 2320, P1 folds, calls, or raises one.

If P1 folds at step 2320, the game continues to step 2322 and P2 wins P/2 at step 2324. If P1 calls at step 2320, the game continues to step 2326 and there is a showdown at step 2328. At step 2328, the player with the highest hand wins P/2+1. If P1 raises at step 2320 (this is the allowed check-raise), the game continues to step 2330. At step 2332, P2 folds, calls, or reraises one. From step 2332, the flowchart continues in FIG. 23C.

If P2 folds at step 2332 of FIG. 23A, the game continues to step 2366 of FIG. 23C, and P1 wins P/2+1 at step 2368. If P2 calls at step 2332, the game continues to step 2370 and there is a showdown at step 2372. At step 2372 the player with the highest hand wins P/2+2. If P2 reraises at step 2332, the game continues to step 2374. At step 2376, P1 folds or calls.

If P1 folds at step 2376, the game continues to step 2378, and P2 wins P/2+2 at step 2380. If P1 calls at step 2376, the game continues to step 2382, and there is a showdown at step 2384. At step 2384, the player with the highest hand wins P/2+3.

Resolutions for the game of FIGS. 23A-C occur at steps 2316, 2324, 2328, 2336, 2340, 2348, 2352, 2360, 2364, 2368, 2372, 2380 and 2384. Of these resolution steps, the first nine, shown in FIGS. 23A and 23B (2316, 2324, 2328, 2336, 2340, 2348, 2352, 2360, and 2364), are the same as the resolution steps for the game of FIGS. 38A-B. The remaining four, shown in FIG. 23C (2368, 2372, 2380, and 2384), are new resolution steps that result from allowing check-raising. The outcomes at the 13 resolution steps for the game of FIGS. 23A-C, and the action sequences for each player leading to the resolution step, are shown in Table 22.

TABLE 22
Action Sequences and Outcomes

| Resolution Step | P1 Action Seq. | P2 Action Seq. | Outcome |
|---|---|---|---|
| By folding | | | |
| 2324 | pass-fold | bet | P2 wins P/2 |
| 2336 | bet | fold | P1 wins P/2 |
| 2348 | bet-fold | raise | P2 wins P/2 + 1 |
| 2360 | bet-re | raise-fold | P1 wins P/2 + 2 |
| | raise | | |
| 2368 | pass-raise | bet-fold | P1 wins P/2 + 1 |
| 2380 | pass-raise-fold | bet-reraise | P2 wins P/2 + 2 |
| By showdown | | | |
| 2316 | pass | pass | High hand wins |
| | | | P/2 |
| 2328 | pass-call | bet | High hand wins |
| | | | P/2 + 1 |
| 2340 | bet | call | High hand wins |
| | | | P/2 + 1 |
| 2352 | bet-call | raise | High hand wins |
| | | | P/2 + 2 |
| 2364 | bet-re | raise-call | High hand wins |
| | raise | | P/2 + 3 |
| 2372 | pass-raise | bet-call | High hand wins |
| | | | P/2 + 2 |
| 2384 | pass-raise-call | bet-re | High hand wins |
| | | raise | P/2 + 3 |

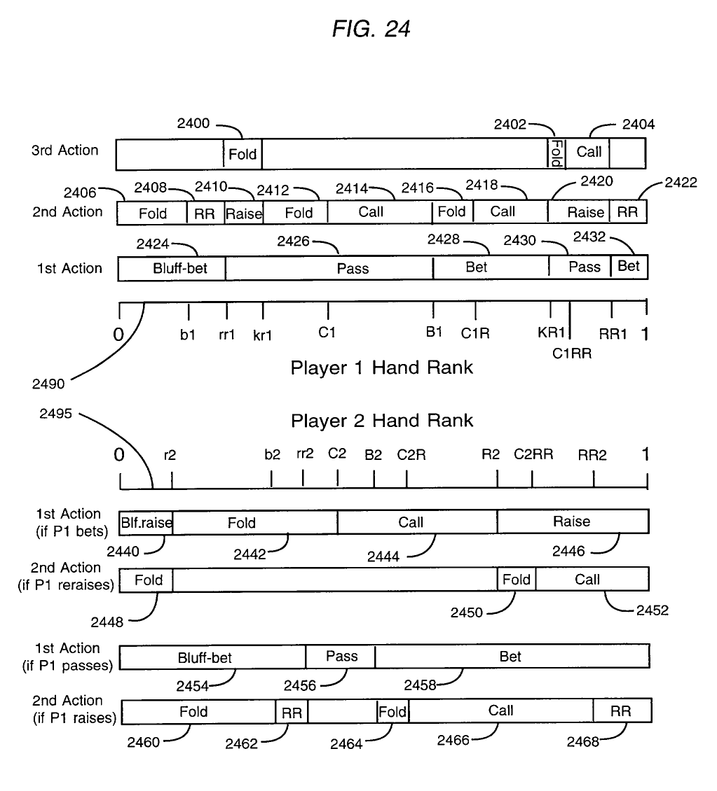

FIG. 24 shows action sequence triggering variables assigned to P1 and P2 for the game of FIG. 23 in one embodiment of the invention.

As shown in FIG. 24, the variables assigned to P1 are b1, rr1, kr1, C1, B1, C1R, KR1, C1RR and RR1. The variables assigned to P2 are r2, b2, rr2, C2, B2, C2R, R2, C2RR and RR2. The relative order of these variables as used in the embodiment of FIG. 24 is:

0<r2<b1<rr1<kr1<b2<rr2<C1<=C2<B2<C2R<B1<C1R<R2<C2RR<KR1<C1RR<RR2<RR1<1

These variables define the intervals of P1's and P2's hand strength axes 2490 and 2495 applicable to each of P1's and P2's action sequences, respectively. Because the variables are initially located at arbitrary locations along axes 2490 and 2495 (as long as the assigned relative order is followed), the actual values of the variables and the resultant sizes of the intervals as determined according to the invention may differ from those shown in FIG. 24.

As shown in Table 22, P1's possible action choices are pass, pass-fold, pass-call, pass-raise, pass-raise-fold, pass-raise-call, bet, bet-fold, bet-call, and bet-reraise. As shown in FIG. 24, the hands with which P1 passes are hands 2426 (between rr1 and B1) and 2430 (between KR1 and RR1). The hands with which P1 pass-folds are hands 2412 (between kr1 and C1). The hands with which P1 pass-calls are hands 2414 (between C1 and B1). The hands with which P1 pass-raises (check raises) are hands 2410 (bluff-raise, between rr1 and kr1) and 2420 (between KR1 and RR1). The hands with which P1 pass-raise-folds are hands 2400 (P1's bluff-raise hands, between rr1 and kr1) and 2402 (between KR1 and C1RR). The hands with which P1 pass-raise-calls are hands 2404 (between C1RR and RR1). The hands with which P1 bets are hands 2424 (bluff bet, between 0 and rr1), 2428 (between B1 and KR1), and 2432 (between RR1 and 1). The hands with which P1 bet-folds are hands 2406 (between 0 and b1) and 2416 (between B1 and C1R). The hands with which P1 bet-calls are hands 2418 (between C1R and KR1). The hands with which P1 bet-reraises are hands 2408 (bluff reraise, between b1 and rr1) and 2422 (between RR1 and 1).

As shown in Table 22, P2's possible action choices are fold, pass, call, bet, raise, bet-fold, bet-call, bet-reraise, raise-fold and raise-call. As shown in FIG. 24, the hands with which P2 folds are hands 2442 (between r2 and C2). The hands with which P2 passes are hands 2456 (between rr2 and B2). The hands with which P2 calls are hands 2444 (between C2 and R2). The hands with which P2 bets are hands 2454 (bluff-bet, between 0 and rr2) and 2458 (between B2 and 1). The hands with which P2 raises are hands 2440 (bluff-raise, between 0 arid r2) and 2446 (between R2 and 1). The hands with which P2 bet-folds are hands 2460 (between 0 and b2) and 2464 (between B2 and C2R). The hands with which P2 bet-calls are hands 2466 (between C2R and RR2). The hands with which P2 bet-reraises are hands 2462 (bluff-reraise, between b2 and rr2) and 2468 (between RR2 and 1). The hands with which P2 raise-folds are hands 2448 (P2's bluff-raise hands, between 0 and r2) and 2450 (between R2 and C2RR). The hands with which P2 raise-calls are hands 2452 between C2RR and 1.

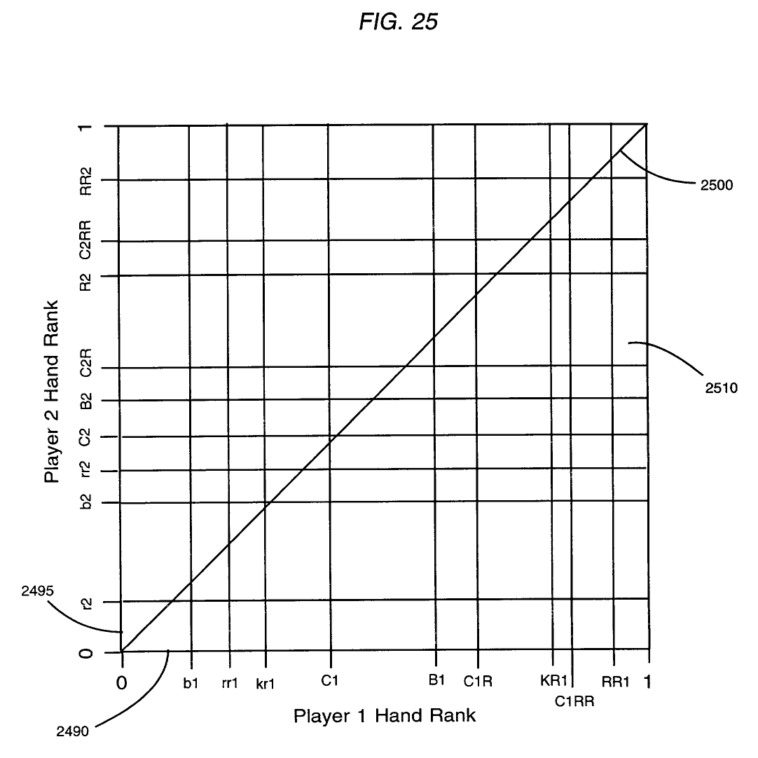

FIG. 25 shows a basic model constructed according to the invention using P1's and P2's hand strength axes 2490 and 2495, respectively. The model represents all possible P1 and P2 hand combinations for the game of FIG. 23. In FIG. 25, the model is divided into a plurality of subregions 2510 by dividing line 2500 and lines extending perpendicularly from each variable location on axes 2490 and 2495, respectively.

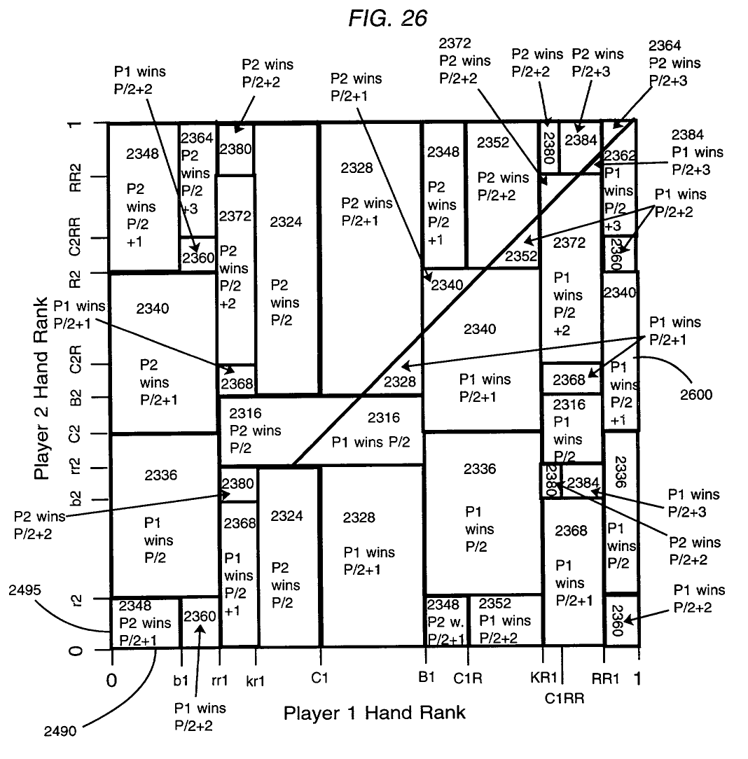

Using Table 22 and FIG. 24, the subregions of FIG. 25 that correspond to each of the resolution steps of Table 22 are identified, for example in the manner described with respect to FIGS. 19-22 and 42-46. FIG. 26 shows the resulting regions, and the outcomes for each region, that correspond to each of the resolution steps listed in Table 22. The resolution step number corresponding to a region and the outcome for the region are indicated in each region shown in FIG. 26. For example, region 2600 is marked “2340 P1 wins P/2+1,” indicating that the region corresponds to games resolved at resolution step 2340 of FIG. 23 with an outcome that P1 wins P/2+1.

According to the invention, the model of FIG. 26 is used to generate an expression for an expected return to a player (for example P1) by taking the sum of the products of the area of each region and the return to that player for games in that region. For example, the product of the area of subregion 2600 and the return to player P1 for games in region 2600 is:

$${E1}_{2600} = ( \frac{P}{2} + 1 ) [ ( 1 - RR1 ) ( R2 - C2 ) ]$$

Alternatively, instead of taking the product of area and return for each region, regions having the same return for a player may be combined into larger regions. The expected return may then be calculated by taking the sum of the products of the areas and returns for such combined regions.

The resulting expected return to P1 according to the model of FIG. 25 may be written as follows:

$$\begin{matrix}E1 = {B2}^{2} + C1 - B2C1 + C1R + C1RR + 5 b2C1RR - \\ C2 - C2RR - 2 kr1 + 3 b2kr1 - B2kr1 + \\ 3 C2Rkr1 - 3 b2KR1 + B2KR1 - C2KR1 + \\ C2RKR1 + b2C1RRP + b2kr1P - B2kr1P + \\ C2Rkr1P - b2KR1P + 2 r2 - 3 C1Rr2 + 2 KR1r2 - \\ C1RPr2 - R2 - C1RR2 - KR1R2 + {R2}^{2} - \\ b1 ( - 2 + C2RR ( 5 + P ) + ( 3 + P ) r2 - 3 R2 - \\ PR2 ) - rr1 - 3 b2rr1 + B2rr1 + C2rr1 - \\ 3 C2Rrr1 + 5 C2RRrr1 - b2rr1P + \\ B2rr1P + C2rr1P - C2Rrr1P + C2RRrr1P + \\ 2 r2rr1 - 3 R2rr1 - R2rr1P - 2 b2RR1 - \\ B2RR1 + C2RR1 - C2RRR1 + C2RRRR1 - \\ 2 r2RR1 + R2RR1 - C1rr2 - 5 C1RRrr2 - \\ 2 kr1rr2 + 2 KR1rr2 - C1rr2P - \\ C1RRrr2P + KR1rr2P + 2 rr1rr2 + 3 RR1rr2 + \\ \frac{{rr2}^{2} P}{2} + B1 ( - B2 + C2 + r2 + r2P + \\ rr2 ) - C1RRRR2 - RR1RR2 + {RR2}^{2}\end{matrix} \qquad ( 20 )$$

According to the method of the invention, the partial derivatives of equation (20) with respect to each variable (except P) are taken and set equal to zero:

$$\begin{matrix}\frac{\partial E1}{\partial b1} = 2 - C2RR ( 5 + P ) - ( 3 + P ) r2 + 3 R2 + R2P = 0 & ( 21 ) \\ \begin{matrix}\frac{\partial E1}{\partial rr1} = - 1 + B2 + C2 - 3 C2R + 5 C2RR + B2P + C2P - \\ C2RP + C2RRP - b2 ( 3 + P ) + 2 r2 - 3 R2 - \\ R2P + 2 rr2 = 0\end{matrix} & ( 22 ) \\ \begin{matrix}\frac{\partial E1}{\partial kr1} = - 2 - B2 + 3 C2R - B2P + C2RP + \\ b2 ( 3 + P ) - 2 rr2 = 0\end{matrix} & ( 23 ) \\ \frac{\partial E1}{\partial C1} = 1 - B2 - rr2 - rr2P = 0 & ( 24 ) \\ \frac{\partial E1}{\partial B1} = - B2 + C2 + r2 + r2P + rr2 = 0 & ( 25 ) \\ \frac{\partial E1}{\partial C1R} = 1 - ( 3 + P ) r2 - R2 = 0 & ( 26 ) \\ \begin{matrix}\frac{\partial E1}{\partial KR1} = B2 - C2 + C2R - b2 ( 3 + P ) + 2 r2 - R2 + \\ 2 rr2 + rr2P = 0\end{matrix} & ( 27 ) \\ \frac{\partial E1}{\partial C1RR} = 1 + b2 ( 5 + P ) - ( 5 + P ) rr2 - RR2 = 0 & ( 28 ) \\ \begin{matrix}\frac{\partial E1}{\partial RR1} = - 2 b2 - B2 + C2 - C2R + C2RR - 2 r2 + R2 + \\ 3 rr2 - RR2 = 0\end{matrix} & ( 29 ) \\ \begin{matrix}\frac{\partial E1}{\partial r2} = 2 + B1 - 3 C1R + 2 KR1 + B1P - C1RP - \\ b1 ( 3 + P ) + 2 rr1 - 2 RR1 = 0\end{matrix} & ( 30 ) \\ \begin{matrix}\frac{\partial E1}{\partial b2} = - 3 KR1 - KR1P + kr1 ( 3 + P ) + C1RR ( 5 + P ) - \\ 3 rr1 - rr1P - 2 RR1 = 0\end{matrix} & ( 31 ) \\ \begin{matrix}\frac{\partial E1}{\partial rr2} = B1 - 5 C1RR - 2 kr1 + 2 KR1 - C1RRP + KR1P - \\ C1 ( 1 + P ) + 2 rr1 + 3 RR1 + rr2P = 0\end{matrix} & ( 32 ) \\ \frac{\partial E1}{\partial C2} = - 1 + B1 - KR1 + rr1 + rr1P + RR1 = 0 & ( 33 ) \\ \begin{matrix}\frac{\partial E1}{\partial B2} = - B1 + 2 B2 - C1 - kr1 + KR1 - kr1P + rr1 + \\ rr1P - RR1 = 0\end{matrix} & ( 34 ) \\ \frac{\partial E1}{\partial C2R} = KR1 + kr1 ( 3 + P ) - 3 rr1 - rr1P - RR1 = 0 & ( 35 ) \\ \begin{matrix}\frac{\partial E1}{\partial R2} = - 1 - C1R - KR1 + b1 ( 3 + P ) + 2 R2 - 3 rr1 - rr1P + \\ RR1 = 0\end{matrix} & ( 36 ) \\ \frac{\partial E1}{\partial C2RR} = - 1 - b1 ( 5 + P ) + ( 5 + P ) rr1 + RR1 = 0 & ( 37 ) \\ \frac{\partial E1}{\partial RR2} = - C1RR - RR1 + 2 RR2 = 0 & ( 38 )\end{matrix}$$

For any particular value of P, equations (21)-(38) are solved simultaneously (according to step 3765 of FIG. 37) to obtain values for the sequence triggering variables. The resulting action sequence triggering values are mapped to corresponding actual card hands (according to step 3775 of FIG. 37), thereby generating card playing strategies by identifying subsets of hands for each player with which to play the different possible action sequences for the game of FIGS. 23A-C.

Pot Limit Games

The example games described so far have been limit bet games, specifically, games in which the limit for each bet has been a bet of one unit. The invention can be used with limit bet games having other limits, for pot limit games, and for other betting limit games. The betting limits are taken into account when determining the outcomes of each resolution step of a game according to the method of the invention.

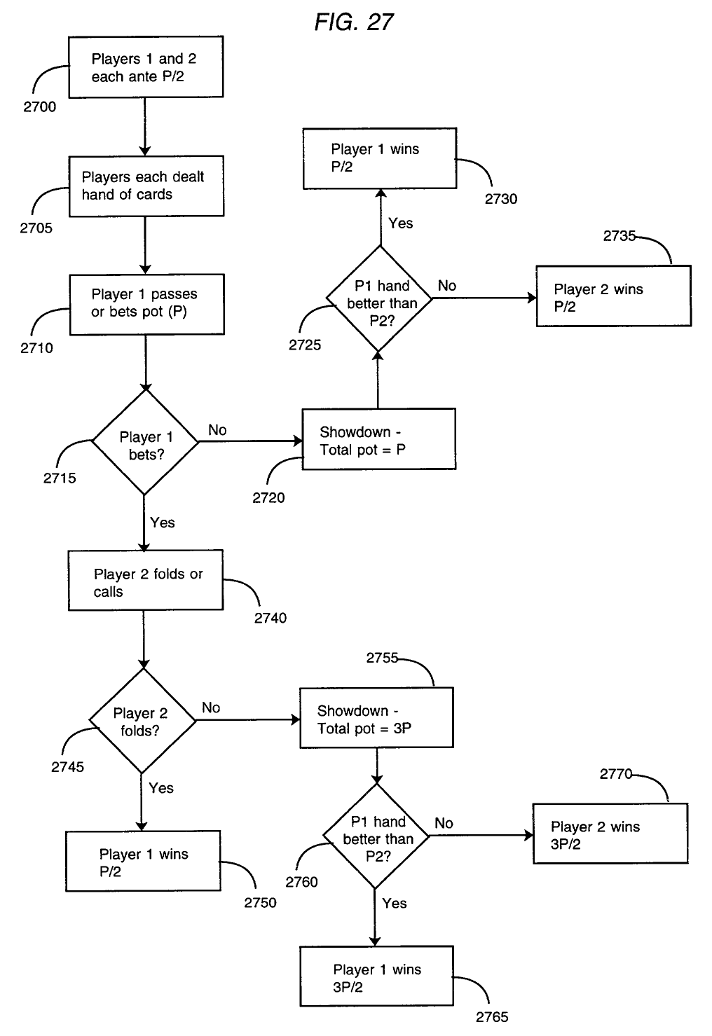

For example, FIG. 27 shows the flowchart of the game of FIG. 34 modified for a pot limit game. The flowchart steps are the same as in the game of FIG. 34. However, the size of the pot at certain resolution steps, and the resulting returns to the players, change as the result of having a pot limit instead of a fixed, one-unit betting limit. In the game of FIG. 34, resolution steps occur when P2 folds at step 3450 and when there are showdowns at steps 3420 and 3455. The returns to the winning player at these steps is P/2, P/2, and P/2+1, respectively. The corresponding resolution steps in FIG. 27 are steps 2750, 2720 and 2755, respectively. At steps 2750 and 2720, the returns to the winning player are the same as at steps 3450 and 3420, namely P/2. However, at resolution step 2755, because of the different betting limit, the pot has a different value (3P vs. P+2), resulting in a different return to the winning player (3P/2 vs. P/2+1).

An expression for the expected return to P1 from the game of FIG. 27 can be generated according to the invention by replacing the return to a winning player at step 3455 (P/2+1) in equation (0) (an expression for the expected return to P1 from the game of FIG. 34) with the return to a winning player at resolution step 2755 (3P/2) for the game of FIG. 27:

$$\begin{matrix}E1 = \frac{P}{2} [ \begin{matrix}( \frac{{b1}^{2}}{2} ) + ( B1C2 - \frac{{b1}^{2}}{2} - \frac{{C2}^{2}}{2} ) + ( C2 - B1C2 ) + \\ ( \frac{{B1}^{2}}{2} - B1C2 + \frac{{C2}^{2}}{2} ) + ( b1C2 - \frac{{b1}^{2}}{2} ) - \\ ( \frac{{C2}^{2}}{2} - b1C2 + \frac{{b1}^{2}}{2} ) - ( - \frac{{b1}^{2}}{2} + B1 - b1 + \\ b1C2 - \frac{{C2}^{2}}{2} )\end{matrix} ] + \\ ( \frac{3 P}{2} ) [ ( \frac{1}{2} - C2 + B1C2 - \frac{{B1}^{2}}{2} ) - ( b1 - b1C2 ) - \\ ( \frac{1}{2} - B1 + \frac{{B1}^{2}}{2} ) ]\end{matrix} \qquad ( 39 )$$

Equation (39) can be simplified and rewritten as:

$$E1 = P ( - C2 + B1C2 - {B1}^{2} - \frac{{b1}^{2}}{2} + 2 b1C2 + B1 - b1 ) \qquad ( 40 )$$

Taking the partial derivatives of equation (40) with respect to b1, B1 and C2 and setting equal to zero according to the invention yields the following equations:

$$\begin{matrix}\frac{\partial E1}{\partial b1} = P ( - b1 + 2 C2 - 1 ) = 0 & ( 41 ) \\ \frac{\partial E1}{\partial B1} = P ( C2 - 2 B1 + 1 ) = 0 & ( 42 ) \\ \frac{\partial E1}{\partial C2} = P ( - 1 + B1 + 2 b1 ) = 0 & ( 43 )\end{matrix}$$

Solving equations (41)-(43) simultaneously produces the following values:

$$b1 = \frac{1}{9}$$

$$B1 = \frac{7}{9}$$

$$C2 = \frac{5}{9}$$

The values of b1, B1 and C2 generated according to the present invention in the pot-limit case of the game of FIG. 34 are therefore fixed values, independent of P (as opposed to the limit-betting game of FIG. 34, in which the values of b1, B1 and C2 are dependent on P, as indicated in equations (5), (6), and (7)).

Applying the Invention to Discrete Hand Distributions

In one embodiment, the method of the present invention is used to generate card playing strategies by generating values for action sequence triggering variables such as those shown in FIG. 40. To apply these strategies to a game situation, a player (e.g. the intelligent gaming system of the invention) determines the rank of the hand of cards that the player was dealt, finds the action sequence interval that corresponds to that rank for that player, and follows the action sequence that corresponds to that interval.

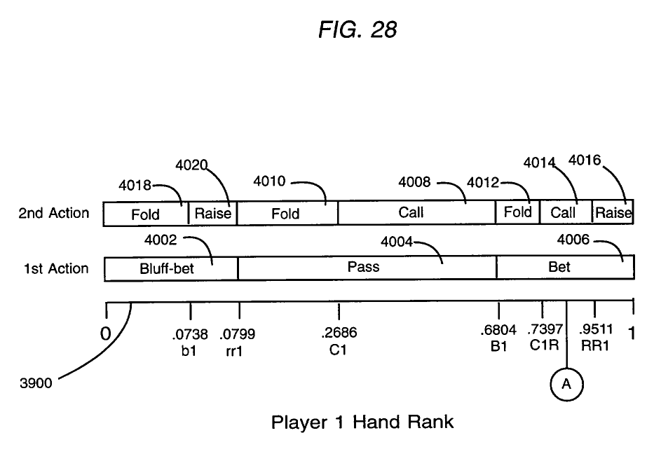

For example, FIG. 28 shows P1's hand rank axis 3900 from FIG. 40 showing the values obtained for the action sequence triggering variables for the game of FIGS. 38A-B for P=3. For example, if P1 is dealt a hand whose rank is 0.83, to apply the strategies generated by the present invention, P1 compares its hand rank to the action sequences triggering variables shown in FIG. 40. P1's hand rank, 0.83, falls in interval 4014 between C1R (0.7297) and RR1 (0.9511). The strategy indicated by FIG. 40 is for P1 follow a “bet-call” action sequence: i.e., P1 should bet, and call if raised by P2.

An action sequence triggering variable generated according to the invention indicates a hand that forms a dividing line between two action sequences. Hands of rank lower than the action sequence triggering variable trigger one action sequence, hands of higher rank trigger a second action sequence. For the hand that has the same rank as the value of the variable, it does not matter which action sequence is followed. However, in certain embodiments, one or the other of the two action sequences is deemed to apply. For example, variable C1 in FIG. 28 indicates the hand that forms the dividing line between a “pass-fold” action sequence and a “pass-call” action sequence. Accordingly, hands having a ranking greater than C1 follow a “pass-call” action sequence while hands having a lower ranking than C1 follow a “pass-fold” action sequence. For the game represented by FIG. 40, C1 was defined as the lowest hand with which P1 will pass and then call if raised. Accordingly, in the embodiment of FIG. 40, a hand having a ranking equal to C1 will follow a “pass-call” action sequence.

In actual card games, the rank of a hand of cards within a player's cumulative hand rank distribution is not immediately discernible from the faces of the cards themselves. Accordingly, in one embodiment of the invention, triggering sequence values are mapped to corresponding actual hands. For example, action sequence triggering variable B1 of the embodiment of Figure may be mapped to a hand containing a full-house, aces over threes. The strategy may then be applied by a player by comparing the cards in a hand directly to the hands corresponding to the action sequence triggering variables.

The hand corresponding to a action sequence triggering variable is determined by identifying a hand whose ranking in the applicable player's cumulative hand rank distribution is equal to or approximately equal to the numerical value of the action sequence triggering variable. Hands of cards dealt from an actual deck of cards do not result in continuous cumulative hand rank distributions, but in discrete distributions. Thus, there is not a hand that corresponds to every rank between 0 and 1. Accordingly, in a game of cards, there often is no hand whose rank corresponds exactly to an action sequence triggering variable value. In this case, in one embodiment, the card having the next highest or next lowest rank is selected to correspond to an action sequence triggering variable. Another embodiment of the present invention uses a novel interpolation technique to simulate a hand that falls exactly on a action sequence triggering value where no hand having the precise value of the variable exists.

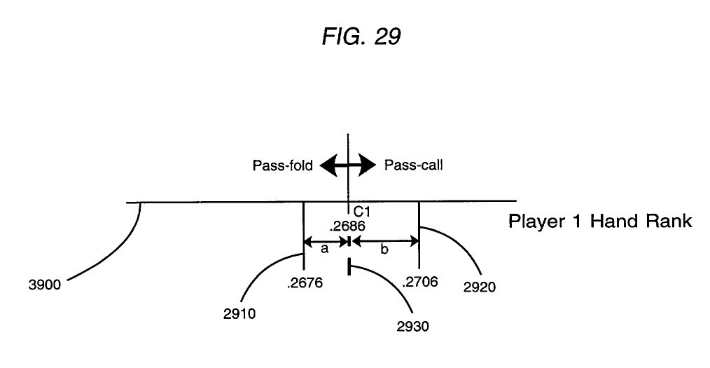

FIG. 29 shows the portion of P1's hand rank axis 3900 of FIG. 28 adjacent to variable C1 for a game with discrete card hand distributions. FIG. 29 shows the two hands, 2910 and 2920, nearest to C1. As shown in FIG. 29, C1 has a value of 0.2686, hand 2910 has a rank of 0.2676, and hand 2920 has a rank of 0.2706. The difference “a” between action sequence triggering variable C1 and the rank of the first hand immediately below variable C1 (hand 2910) is 0.2686-0.2676=0.0010. The difference “b” between the rank of the first hand immediately above variable C1 (hand 2920) and variable C1 is 0.2706-0.2686-0.0020.

According to this embodiment, if a triggering variable is defined as the lowest hand rank with which a certain action sequence is followed (such as C1 which is defined as the lowest hand rank with which P1 pass-calls), if no hand rank falls exactly on the triggering variable, the hand with the first hand rank below an action triggering variable value is assigned to follow the action sequence for the interval above the triggering variable

$$\frac{b}{a + b}$$

of the time. Similarly, if a triggering variable is defined as the highest hand rank with which a certain action sequence is followed (such as b2 which is defined as the highest hand rank with which P2 bluff-bets), if no hand rank falls exactly on the triggering variable, the hand with the first hand rank above an action triggering variable value is assigned to follow the action sequence for the interval below the triggering variable

$$\frac{a}{a + b}$$

of the time. The result is the creation of a “virtual hand” located at approximately the triggering variable.

For example, in FIG. 29, interval 4010 below C1 corresponds to a “pass-fold” action sequence, while interval 4008 above C1, which corresponds to a “pass-call” sequence. C1 is defined as the lowest hand with which P1 pass-calls.

$$\frac{b}{a + b} = \frac{0.002}{0.001 + 0.002} = \frac{2}{3} .$$

Accordingly, in this embodiment of the invention, P1's strategy is to play a “pass-call” action sequence with two-thirds of its 2910 hands, and to play a “pass-fold” sequence with the remainder of P1's 2910 hands. P1's strategy is to always play a “pass-call” sequence with its 2920 hands.

In another embodiment, whenever there is no hand rank that falls precisely on a triggering variable, the hand with the first hand rank below an action triggering variable follows the action sequence for the interval above the triggering variable

$$\frac{b}{a + b}$$

of the time and the hand with the first hand rank above an action triggering variable follows the action sequence for the interval below the triggering variable

$$\frac{a}{a + b}$$

of the time.

Computer Implementations of the Invention

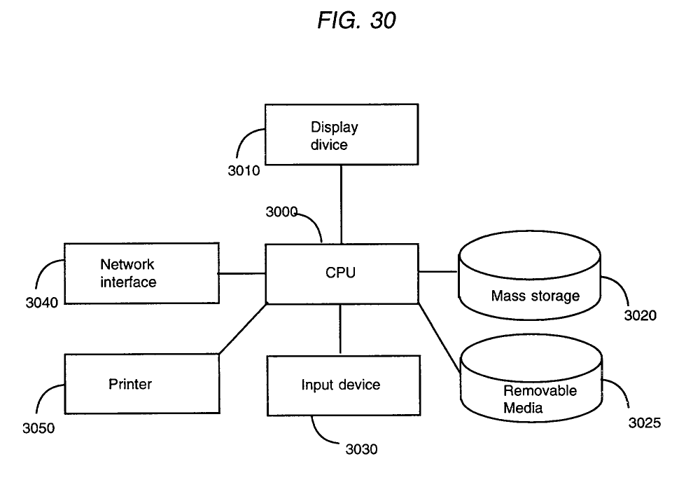

The method of the invention may be implemented by means of appropriate software on the gaming system of FIG. 4, on the computer system, of FIG. 30, and on any of a variety of other computer systems, including hand-held and arcade computer games and other computer gaming systems. The exemplary computer system shown in FIG. 30 includes a CPU unit 3000 that includes a central processor, main memory, peripheral interfaces, input-output devices, power supply, and associated circuitry and devices; a display device 3010 which may be a cathode ray tube display, LCD display, gas-plasma display, or any other computer display; an input device 3030, which may include a keyboard, mouse, digitizer, or other input device; non-volatile storage 3020, which may include magnetic, re-writable optical, or other mass storage devices; a transportable media drive 3025, which may include magnetic, re-writable optical, or other removable, transportable media, and a printer 3050. The computer system may also include a network interface 3040, which may include a modem, allowing the computer system to communicate with other systems over a communications network such as the Internet. Any of a variety of other configurations of computer systems may also be used. In one embodiment, the computer system comprises an Intel Pentium (tm) CPU and runs the Microsoft Windows 95 (tm) operating environment.

When a gaming system or computer system executes the processes and process flows described herein, it is an apparatus for generating improved card playing strategies. The processes of the invention may be implemented in any of a variety of computer languages, as are well known in the art, including, without limitation, C, Objective C, C++, Matlab scripts, Mathematica, Axiom, etc.

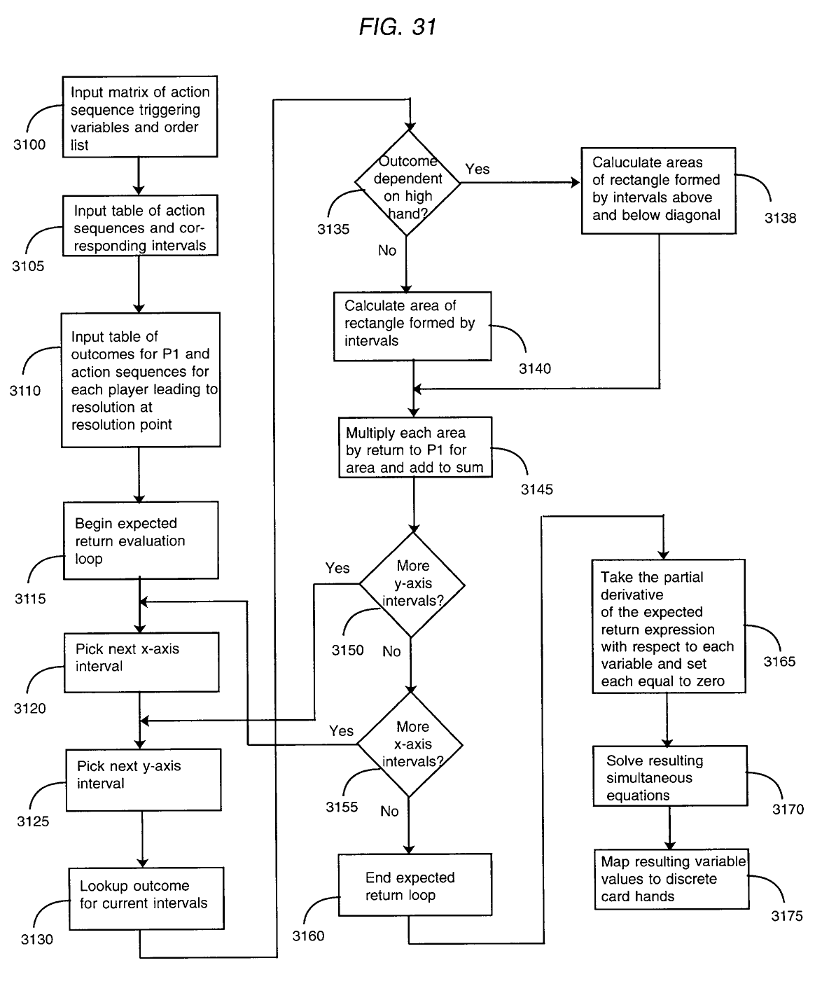

FIG. 31 is a flow chart of one embodiment of a computer implementation of the invention for a two-player game. As shown in FIG. 31, the first three steps are input steps in which information for a particular game is input into the system. A matrix of actions sequence triggering variables and a list specifying the relative order of variables is input at step 3100. For a two player game, the matrix consists of two rows: one row of action sequence triggering variables for each of P1 and P2. A lookup table matching action sequences to intervals between action sequence triggering variables is input at step 3105. This lookup table, for example, may contain the information shown in FIG. 40 in table form. A lookup table listing outcomes (for P1) and the respective action sequences for each of P1 and P2 leading to the outcome is input at step 3110. This lookup table, for example, may contain the information in Table 21.

Using the information input in steps 3100, 3105, and 3110, the system enters an expected return evaluation loop at block 3115. At step 3120, the next x-axis interval (between action sequence triggering variables for P1) is selected. For example, for the game of FIG. 40, the first x-axis interval is the interval between 0 and b1. The other x-axis intervals are between b1 and rr1, rr1 and C1, C1 and B1, B1 and C1R, C1R and RR1, and RR1 and 1.

At step 3125, the next y-axis interval (between action sequence triggering variables for P2) is selected. For the game of FIG. 40, the first y-axis interval is the interval between 0 and r2. The other y-axis intervals are between r2 and b2, b2 and C2, C2 and B2, B2 and R2, R2 and C2RR, and C2RR and 1.

At step 3130, the outcome for the current intervals is obtained from the lookup tables input at steps 3105 and 3110. The action sequences for P1 and P2 are obtained from the table input at step 3105, and the resulting outcome is obtained from the table input at step 3110. For example, for the combination of the first x-axis interval (between 0 and b1) and the first y-axis interval (between 0 and r2), as shown in FIG. 40, P1's action sequence is “bet-fold” and P2's action sequence is “raise.” As shown in Table 21, the resulting outcome is P1 loses P/2+1 (P1's return is −(p/2+1)).

At step 3135 a determination is made as to whether the outcome obtained at step 3130 is dependent on the player having the high hand. If, as in the current interval combination, the outcome does not depend on the high hand, the area of the rectangle formed by the current x-axis and y-axis intervals (i.e. the product of the lengths of the respective intervals) is determined at step 3140. If, however, it is determined at step 3135 that the outcome does depend on the high hand, the area of the rectangle formed by the two intervals respectively above and below the diagonal is determined in step 3138. The areas above and below the diagonal are determined using the relative order of action sequence triggering variables input at step 3100.

At step 3145, the area(s) obtained at steps 3140 or 3138 are multiplied by the return to P1 for each area. Each product so obtained is added to a running sum, which will, when all areas have been evaluated, become an expression for P1's expected return.

At step 3150, a determination is made as to whether there are any remaining y-axis intervals that have not yet been taken into account for the current x-axis interval. If there are more y-axis intervals, execution returns to step 3125. If there are no more y-axis intervals, a determination is made at step 3155 as to whether there are any more x-axis intervals. If yes, execution returns to step 3120. If no, the expected return loop ends at step 3160 and execution proceeds to step 3165.

At step 3165, the partial derivative of the expected return expression generated by the expected return loop is taken with respect to each action sequence triggering variable, and each resulting expression is set equal to zero. The current value for the pot size P is input at step 3170, and the resulting simultaneous equations are solved at step 3175. The resulting action sequence triggering variables are mapped to discrete card hands at step 3180.

Slot Machine Embodiments of the Invention

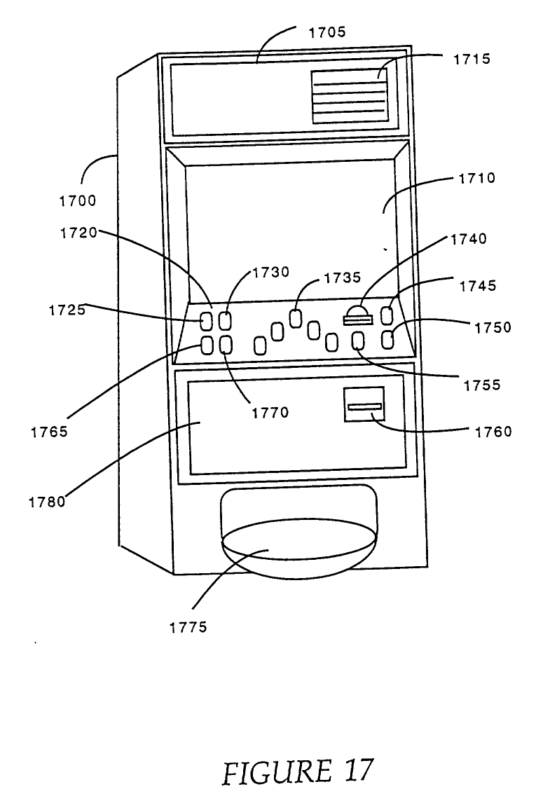

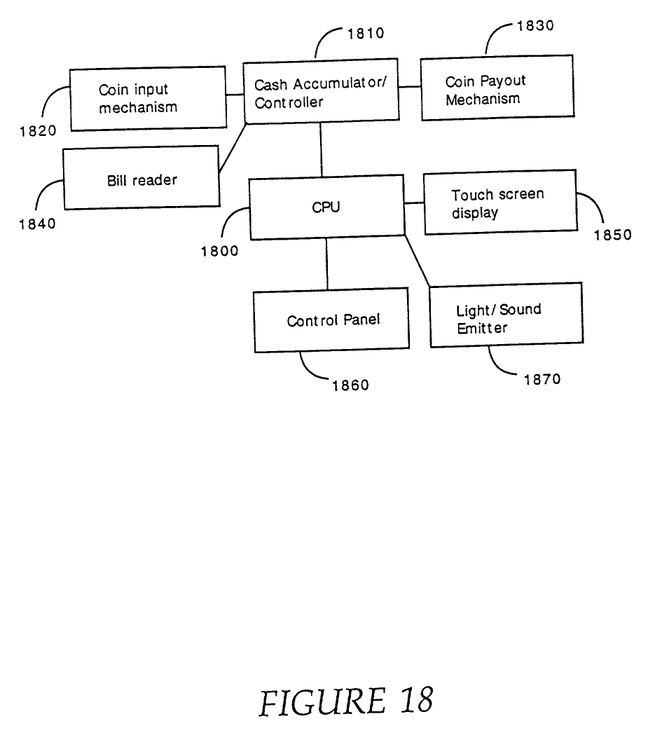

FIGS. 17 and 18 illustrate slot machine embodiments of the intelligent card playing system of the invention. It will be understood that the features shown for the embodiments of FIGS. 17 and 18 are by way of example, only. Slot machine embodiments of the invention may have any variety of other configurations, as will be apparent to those skilled in the art.

FIG. 18 is a schematic diagram illustrating the functional components in one slot machine embodiment of the invention. As shown in FIG. 18, the functional components in this embodiment include a CPU unit 1800, a cash accumulator/controller 1810, a coin input mechanism 1820, a bill reader 1840, a coin payout mechanism 1830, a control panel 1860, a touch-screen display 1850, and light and sound emitters 1870. CPU unit 1800 contains a microprocessor such as, for example, a Pentium™ processor from Intel, along with associated software, components and peripherals, such as main memory, video graphics adapter, sound card, mass storage, and input/output interfaces, that allow CPU unit 1800 to function as an intelligent controller of the slot machine unit. CPU unit 1800 monitors user input, generates strategies for and controls actions of one or more simulated players, determines outcomes of games, and controls payout of user winnings.

Cash accumulator/controller 1810 monitors a user's cash input from coin input mechanism 1820 and bill reader 1840, and controls cash payout to a user provided by coin payout mechanism 1830, all under the control of CPU unit 1800.

Display 1850, which may, for example, be a CRT or LCD or other type of display, displays output to the user, such as, for example, images of cards dealt to a user, images of cards dealt to the simulated player(s), information concerning the state of the game, the size of the pot, the actions available to the user, etc. In the embodiment of FIG. 18, display 1850 is a touch screen display that accepts touch input from a user. In this embodiment, a user can indicate the user's desired actions by touching corresponding images displayed on the display screen. For example, the user may indicate cards to hold during a drawing phase of a game by touching the cards the user wishes to hold. Preferably, visual feedback is provided to the user to confirm that the user's touch screen input has been recognized. For example, the receipt of a touch screen input may be indicated by highlighting the image (e.g. a card selected for holding) underlying the position at which the user touches the screen.

In addition to a touch-screen, the embodiment of FIG. 18 also contains a control panel 1860 that may be used as an alternate means to provide user input. Control panel 1860 may, for example, consist of a panel containing a number of button switches. Each button corresponds to one or more user actions. A user chooses a desired action by pressing the appropriate button. In one embodiment, a user may indicate desired user actions by touching an appropriate area on touch screen 1850 and/or by pressing an appropriate button on control panel 1860.

Light/sound emitter 1870 is used to provide sound and light output. For example, light/sound emitter 1870 in one embodiment includes a flashing light and emits the sound of a bell ringing to indicate that the user has won a game.

The system of FIG. 18 may include other features found on slot machines as are known in the art.

FIG. 17 illustrates the outward appearance of one embodiment of a card playing slot machine system such as the system of FIG. 18. As shown in FIG. 17, this slot machine comprises a housing 1700 which contains functional components of the system, for example components 1800-1870 of FIG. 18. The input and output interfaces with a user are situated on the front of housing 1700. These input and output interfaces include a display screen 1710 (which may be a touch-screen display), a control panel 1720, a bill reader 1760, and a coin output tray 1775. The front of housing 1700 also includes a first and second billboard display areas 1705 and 1780, respectively.

First billboard display area 1705 comprises a backlit display containing graphics. The graphics are intended to attract players to the game, and may, for example, include the name of the game played by the slot machine system. The slot machine system may, for example, play five card draw poker. In one embodiment, the slot machine system allows a user to play a simulated poker game against an intelligent, simulated player. In another embodiment, the slot machine system allows a player to play simultaneously against an intelligent, simulated player and against a video-poker style payoff table. If the slot machine system provides combined play against a simulated opponent and a payoff table, display area 1705 may include a depiction of the payoff table 1715. Display area 1705 may also include flashing lights that are activated when a user wins a game.

Second display area 1780 provides an area in which additional graphics may be displayed. Second display area 1780 includes bill reader 1760 that is used to accept cash bills from a user.

Display 1710 is a CRT or LCD display that provides output to, and, in the case of an embodiment in which display 1710 is a touch screen display, accepts input from, a user as described with respect to display 1850 of FIG. 18.

Control panel 1720 includes a coin slot 1740 for accepting coins from a user and a number of button switches that the user may activate to indicate desired user actions. In the embodiment of FIG. 17, the buttons include a “call” button 1725, a “raise/bet” button 1730, an “ante” button 1765, a “fold/check” button 1730, five “hold” buttons 1735, a “draw” button 1745, a “cashout” button 1750, and a “game select” button 1755. Call button 1725 is activated by a user to indicate a desired call action. Raise/bet button 1730 is activated by a user to indicate a desired raise or bet action, depending on the state of the game. Ante button 1765 is activated by a user to debit the amount required for an ante from a balance of money deposited by the user into the slot machine system via coin slot 1740 or bill reader 1760, thereby initiating a new game. Fold/check button 1730 is activated by a user to indicate a desired fold or check action, depending on the state of the game. Hold buttons 1735 are used to indicate cards that the user wishes to hold prior to a draw. There is one hold button for each card in a user's hand. In the embodiment of FIG. 17, there are five hold buttons 1735, corresponding to a five-card game such as five card draw. Draw button 1745 is used by a user to initiate a draw, such that the user is dealt a new card for each card discarded (i.e. for the cards the user has indicated the user does not wish to hold). Cashout button 1750 is used by a user to obtain a payout, in cash, of any balance remaining to the user's account. The cashout amount is paid out to the user by depositing coins in payout tray 1775. Game select button 1755 is used by a user to select the desired game to play in embodiments that allow a user to select from different games. For example, in one embodiment, game select button 1755 allows a user to select optional play against a payoff table in addition to play against a simulated, intelligent opponent.

In one embodiment, the available actions available to a user an any stage of a game are indicated by lighting up only those buttons corresponding to the available actions.

Thus, a computer gaming system has been presented.

1. In a computer gaming system, a method for generating card playing strategies for a game of cards comprising at least one round of betting comprising the steps of:
determining possible action sequences for a round of said game for each player of said game;
determining possible outcomes for said round of said game resulting from said action sequences;
assigning variables representing dividing points between intervals of a card hand strength hierarchy for each player, each of said intervals corresponding to a subset of hands from said player's card hand strength hierarchy with which said player undertakes a particular action sequence;
constructing an expression for an expected return to a player for said game using said variables;
deriving expressions for said variables that maximize said expected return;
evaluating said expressions to obtain values for said variables;
identifying endpoints of said intervals of said card hand strength hierarchies of said players using said values.

2. The method of claim 1 wherein said step of deriving expressions for said variables comprises the step of:
generating a plurality of simultaneous equations by taking a partial derivative of said expected return expression with respect to each of said variables and setting said expected return expression equal to zero.

3. The method of claim 2 wherein said step of evaluating said expressions to obtain values for said variables comprises the step of:
solving said simultaneous equations to obtain values for said variables.

4. The method of claim 1 wherein said step of constructing said expected return expression comprises the steps of:
constructing a multidimensional model comprising an axis corresponding to each of said player's hand strength hierarchy;
dividing said model into portions representing said possible outcomes for said round of said game;
determining sizes of said portions in terms of said variables;
constructing said expected return expression from a sum of products of said outcomes and said sizes for said portions.

5. The method of claim 1 wherein said step of assigning variables comprises the steps of:
assigning a first variable to a dividing point between an interval in which said second player follows a raise-fold action sequence and an interval in which said second player follows a fold action sequence;
assigning a second variable to a dividing point between an interval in which said first player follows a bet-fold action sequence and an interval in which said first player follows a bet-reraise action sequence;
assigning a third variable to a dividing point between an interval in which said first player follows a bet-reraise action sequence and an interval in which said first player follows a pass-fold action sequence;
assigning a fourth variable to a dividing point between an interval in which said second player follows a bet action sequence and an interval in which said second player follows a pass action sequence;
assigning a fifth variable to a dividing point between an interval in which said second player follows a fold action sequence and an interval in which said second player follows a call action sequence;
assigning a sixth variable to a dividing point between an interval in which said first player follows a pass-fold action sequence and an interval in which said first player follows a pass-call action sequence;
assigning a seventh variable to a dividing point between an interval in which said second player follows a pass action sequence and an interval in which said second player follows a bet action sequence;
assigning an eighth variable to a dividing point between an interval in which said first player follows a pass-call action sequence and an interval in which said first player follows a bet-fold action sequence;
assigning a ninth variable to a dividing point between an interval in which said first player follows a bet-fold action sequence and an interval in which said first player follows a bet-call action sequence;
assigning a tenth variable to a dividing point between an interval in which said second player follows a call action sequence and an interval in which said second player follows a raise-fold action sequence;
assigning an eleventh variable to a dividing point between an interval in which said second player follows a raise-fold action sequence and an interval in which said second player follows a raise-call action sequence;
assigning a twelfth variable to a dividing point between an interval in which said first player follows a bet-call action sequence and an interval in which said first player follows a bet-reraise action sequence.

6. The method of claim 5 wherein said variables are assigned a relative order such that:
said first variable is less than said second variable;
said second variable is less than said third variable;
said third variable is less than said fourth variable;
said fourth variable is less than said fifth variable;
said fifth variable is less than or equal to said sixth variable;
said sixth variable is less than said seventh variable;
said seventh variable is less than said eighth variable;
said eighth variable is less than said ninth variable;
said ninth variable is less than said tenth variable;
said tenth variable is less than said eleventh variable;
said eleventh variable is less than said twelfth variable.

7. The method of claim 1 wherein step of assigning variables comprises the steps of:
assigning a first variable to a dividing point between an interval in which said second player follows a raise-fold action sequence and an interval in which said second player follows a fold action sequence;
assigning a second variable to a dividing point between an interval in which said first player follows a bet-fold action sequence and an interval in which said first player follows a bet-reraise action sequence;
assigning a third variable to a dividing point between an interval in which said first player follows a bet-reraise action sequence and an interval in which said first player follows a pass-raise-fold action sequence;
assigning a fourth variable to a dividing point between an interval in which said first player follows a pass-raise-fold action sequence and an interval in which said first player follows a pass-fold action sequence;
assigning a fifth variable to a dividing point between an interval in which said second player follows a bet-fold action sequence and an interval in which said second player follows a bet-reraise action sequence;
assigning a sixth variable to a dividing point between an interval in which said second player follows a bet-reraise action sequence and an interval in which said second player follows a pass action sequence;
assigning a seventh variable to a dividing point between an interval in which said first player follows a pass-fold action sequence and an interval in which said first player follows a pass-call action sequence;
assigning an eighth variable to a dividing point between an interval in which said second player follows a fold action sequence and an interval in which said second player follows a call action sequence;
assigning a ninth variable to a dividing point between an interval in which said second player follows a pass action sequence and an interval in which said second player follows a bet-fold action sequence;
assigning a tenth variable to a dividing point between an interval in which said second player follows a bet-fold action sequence and an interval in which said second player follows a bet-call action sequence;
assigning an eleventh variable to a dividing point between an interval in which said first player follows a pass-call action sequence and an interval in which said first player follows a bet-fold action sequence;
assigning a twelfth variable to a dividing point between an interval in which said first player follows a bet-fold action sequence and an interval in which said first player follows a bet-call action sequence;
assigning a thirteenth variable to a dividing point between an interval in which said second player follows a call action sequence and an interval in which said second player follows a raise-fold action sequence;
assigning a fourteenth variable to a dividing point between an interval in which said second player follows a raise-fold action sequence and an interval in which said second player follows a raise-call action sequence;
assigning a fifteenth variable to a dividing point between an interval in which said first player follows a bet-call action sequence and an interval in which said first player follows a pass-raise-fold action sequence;
assigning a sixteenth variable to a dividing point between an interval in which said first player follows a pass-raise-fold action sequence and an interval in which said first player follows a pass-raise-call action sequence;
assigning a seventeenth variable to a dividing point between an interval in which said second player follows a bet-call action sequence and an interval in which said second player follows a bet-reraise action sequence;
assigning an eighteenth variable to a dividing point between an interval in which said first player follows a pass-raise-call action sequence and an interval in which said first player follows a bet-reraise action sequence.

8. The method of claim 7 wherein said variables are assigned a relative order such that:
said first variable is less than said second variable;
said second variable is less than said third variable;
said third variable is less than said fourth variable;
said fourth variable is less than said fifth variable;
said fifth variable is less than said sixth variable;
said sixth variable is less than said seventh variable;
said seventh variable is less than or equal to said eighth variable;
said eighth variable is less than said ninth variable;
said ninth variable is less than said tenth variable;
said tenth variable is less than said eleventh variable;
said eleventh variable is less than said twelfth variable;
said twelfth variable is less than said thirteenth variable;
said thirteenth variable is less than said fourteenth variable;
said fourteenth variable is less than said fifteenth variable;
said fifteenth variable is less than said sixteenth variable;
said seventeenth variable is less than said eighteenth variable.

9. A method for generating card playing strategies for a game of cards comprising at least one round of betting comprising the steps of:
determining possible action sequences for a round of said game for each player of said game;
determining possible outcomes for said round of said game resulting from said action sequences;
assigning variables representing dividing points between intervals of a card hand strength hierarchy for each player, each of said intervals corresponding to a subset of hands from said player's card hand strength hierarchy with which said player undertakes a particular action sequence;
constructing an expression for an expected return to a player for said game using said variables;
generating a plurality of simultaneous equations by taking a partial derivative of said expected return expression with respect to each of said variables and setting said expected return expression equal to zero;
solving said simultaneous equations to obtain values for said variables;
identifying endpoints of said intervals of said card hand strength hierarchies of said players using said values.

10. The method of claim 9 wherein said step of constructing said expected return expression comprises the steps of:
constructing a multidimensional model comprising an axis corresponding to each of said player's hand strength hierarchy;
dividing said model into portions representing said possible outcomes for said round of said game;
determining sizes of said portions in terms of said variables;
constructing said expected return expression from a sum of products of said outcomes and said sizes for said portions.

11. The method of claim 9 wherein said step of assigning variables comprises the steps of:
assigning a first variable to a dividing point between an interval in which said second player follows a raise-fold action sequence and an interval in which said second player follows a fold action sequence;
assigning a second variable to a dividing point between an interval in which said first player follows a bet-fold action sequence and an interval in which said first player follows a bet-reraise action sequence;
assigning a third variable to a dividing point between an interval in which said first player follows a bet-reraise action sequence and an interval in which said first player follows a pass-fold action sequence;
assigning a fourth variable to a dividing point between an interval in which said second player follows a bet action sequence and an interval in which said second player follows a pass action sequence;
assigning a fifth variable to a dividing point between an interval in which said second player follows a fold action sequence and an interval in which said second player follows a call action sequence;
assigning a sixth variable to a dividing point between an interval in which said first player follows a pass-fold action sequence and an interval in which said first player follows a pass-call action sequence;
assigning a seventh variable to a dividing point between an interval in which said second player follows a pass action sequence and an interval in which said second player follows a bet action sequence;
assigning an eighth variable to a dividing point between an interval in which said first player follows a pass-call action sequence and an interval in which said first player follows a bet-fold action sequence;
assigning a ninth variable to a dividing point between an interval in which said first player follows a bet-fold action sequence and an interval in which said first player follows a bet-call action sequence;
assigning a tenth variable to a dividing point between an interval in which said second player follows a call action sequence and an interval in which said second player follows a raise-fold action sequence;
assigning an eleventh variable to a dividing point between an interval in which said second player follows a raise-fold action sequence and an interval in which said second player follows a raise-call action sequence;
assigning a twelfth variable to a dividing point between an interval in which said first player follows a bet-call action sequence and an interval in which said first player follows a bet-reraise action sequence.

12. The method of claim 11 wherein said variables are assigned a relative order such that:
said first variable is less than said second variable;
said second variable is less than said third variable;
said third variable is less than said fourth variable;
said fourth variable is less than said fifth variable;
said fifth variable is less than or equal to said sixth variable;
said sixth variable is less than said seventh variable;
said seventh variable is less than said eighth variable;
said eighth variable is less than said ninth variable;
said ninth variable is less than said tenth variable;
said tenth variable is less than said eleventh variable;
said eleventh variable is less than said twelfth variable.

13. The method of claim 9 wherein said step of assigning variables comprises the steps of:
assigning a first variable to a dividing point between an interval in which said second player follows a raise-fold action sequence and an interval in which said second player follows a fold action sequence;
assigning a second variable to a dividing point between an interval in which said first player follows a bet-fold action sequence and an interval in which said first player follows a bet-reraise action sequence;
assigning a third variable to a dividing point between an interval in which said first player follows a bet-reraise action sequence and an interval in which said first player follows a pass-raise-fold action sequence;
assigning a fourth variable to a dividing point between an interval in which said first player follows a pass-raise-fold action sequence and an interval in which said first player follows a pass-fold action sequence;
assigning a fifth variable to a dividing point between an interval in which said second player follows a bet-fold action sequence and an interval in which said second player follows a bet-reraise action sequence;
assigning a sixth variable to a dividing point between an interval in which said second player follows a bet-reraise action sequence and an interval in which said second player follows a pass action sequence;
assigning a seventh variable to a dividing point between an interval in which said first player follows a pass-fold action sequence and an interval in which said first player follows a pass-call action sequence;
assigning an eighth variable to a dividing point between an interval in which said second player follows a fold action sequence and an interval in which said second player follows a call action sequence;
assigning a ninth variable to a dividing point between an interval in which said second player follows a pass action sequence and an interval in which said second player follows a bet-fold action sequence;
assigning a tenth variable to a dividing point between an interval in which said second player follows a bet-fold action sequence and an interval in which said second player follows a bet-call action sequence;
assigning an eleventh variable to a dividing point between an interval in which said first player follows a pass-call action sequence and an interval in which said first player follows a bet-fold action sequence;
assigning a twelfth variable to a dividing point between an interval in which said first player follows a bet-fold action sequence and an interval in which said first player follows a bet-call action sequence;
assigning a thirteenth variable to a dividing point between an interval in which said second player follows a call action sequence and an interval in which said second player follows a raise-fold action sequence;
assigning a fourteenth variable to a dividing point between an interval in which said second player follows a raise-fold action sequence and an interval in which said second player follows a raise-call action sequence;
assigning a fifteenth variable to a dividing point between an interval in which said first player follows a bet-call action sequence and an interval in which said first player follows a pass-raise-fold action sequence;
assigning a sixteenth variable to a dividing point between an interval in which said first player follows a pass-raise-fold action sequence and an interval in which said first player follows a pass-raise-call action sequence;
assigning a seventeenth variable to a dividing point between an interval in which said second player follows a bet-call action sequence and an interval in which said second player follows a bet-reraise action sequence;
assigning an eighteenth variable to a dividing point between an interval in which said first player follows a pass-raise-call action sequence and an interval in which said first player follows a bet-reraise action sequence.

14. The method of claim 13 wherein said variables are assigned a relative order such that:
said first variable is less than said second variable;
said second variable is less than said third variable;
said third variable is less than said fourth variable;
said fourth variable is less than said fifth variable;
said fifth variable is less than said sixth variable;
said sixth variable is less than said seventh variable;
said seventh variable is less than or equal to said eighth variable;
said eighth variable is less than said ninth variable;
said ninth variable is less than said tenth variable;
said tenth variable is less than said eleventh variable;
said eleventh variable is less than said twelfth variable;
said twelfth variable is less than said thirteenth variable;
said thirteenth variable is less than said fourteenth variable;
said fourteenth variable is less than said fifteenth variable;
said fifteenth variable is less than said sixteenth variable;
said seventeenth variable is less than said eighteenth variable.

15. In a computer gaming system, a method for generating a virtual hand for a card game having a hand strength ranking corresponding to a value of a action sequence triggering variable representing a dividing point between first and second intervals of a card hand strength hierarchy for a player, said first interval corresponding to a subset of hands from said player's card hand strength hierarchy with which said player undertakes a first action sequence, said second interval corresponding to a subset of hands from said player's card hand strength hierarchy with which said player undertakes a second action sequence, wherein said hand strength hierarchy of said player comprises a first hand in said first interval having a hand strength immediately below said value of said variable and a second hand in said second interval having a hand strength immediately above said value of said variable, said method comprising the steps of:
determining a ratio between (i) a difference between said hand strength of said second hand and said value of said variable and (ii) a difference between said hand strength of said second hand and said hand strength of said first hand;
undertaking said second action sequence with a fraction of said first hands equal to said ratio.

16. In a computer gaming system, a method for generating a virtual hand for a card game having a hand strength ranking corresponding to a value of a action sequence triggering variable representing a dividing point between first and second intervals of a card hand strength hierarchy for a player, said first interval corresponding to a subset of hands from said player's card hand strength hierarchy with which said player undertakes a first action sequence, said second interval corresponding to a subset of hands from said player's card hand strength hierarchy with which said player undertakes a second action sequence, wherein said hand strength hierarchy of said player comprises a first hand in said first interval having a hand strength immediately below said value of said variable and a second hand in said second interval having a hand strength immediately above said value of said variable, said method comprising the steps of:
determining a first ratio between (i) a difference between said value of said variable and said hand strength of said first hand and (ii) a difference between said hand strength of said second hand and said hand strength of said first hand;
undertaking said first action sequence with a fraction of second hands equal to said first ratio.

17. The method of claim 16 further comprising the steps of:
determining a second ratio between (i) a difference between said hand strength of said second hand and said value of said variable and (ii) a difference between said hand strength of said second hand and said hand strength of said first hand;
undertaking said second action sequence with a fraction of said first hands equal to said second ratio.

18. An article of manufacture comprising:
a computer usable medium having computer readable program code embodied therein for generating card playing strategies for a game of cards, the computer readable program code in said article of manufacture comprising:
computer readable program code configured to cause said computer to manipulate a plurality of variables representing dividing points between intervals of a card hand strength hierarchy for each player of said game, each of said intervals corresponding to a subset of hands from said player's card hand strength hierarchy with which said player undertakes a particular action sequence;
computer readable program code configured to cause said computer to construct an expression for an expected return to a player for a round of said game using said variables;
computer readable program code configured to cause said computer to derive expressions for said variables that maximize said expected return;
computer readable program code configured to cause said computer to evaluate said expressions to obtain values for said variables.

19. The article of manufacture of claim 18 wherein said computer readable program code configured to cause said computer to derive expressions for said variables that maximize said expected return comprises computer readable program code configured to cause said computer to generate a plurality of simultaneous equations by taking a partial derivative of said expected return expression with respect to each of said variables and setting said expected return expression equal to zero.

20. The article of manufacture of claim 19 wherein said computer readable program code configured to cause said computer to derive expressions for said variables that maximize said expected return comprises computer readable program code configured to cause said computer to solve said simultaneous equations to obtain values for said variables.

21. The article of manufacture of claim 19 wherein said computer readable program code configured to cause said computer to construct an expression for said expected return comprises computer readable program code configured to cause said computer to determine products of an expected return for each of a plurality of outcomes of said round of said game and a probability of the occurrence of said outcome.

22. The article of manufacture of claim 18 wherein said plurality of variables comprise:
a first variable representing a dividing point between an interval in which said second player follows a raise-fold action sequence and an interval in which said second player follows a fold action sequence;
a second variable representing a dividing point between an interval in which said first player follows a bet-fold action sequence and an interval in which said first player follows a bet-reraise action sequence;
a third variable representing a dividing point between an interval in which said first player follows a bet-reraise action sequence and an interval in which said first player follows a pass-fold action sequence;
a fourth variable representing a dividing point between an interval in which said second player follows a bet action sequence and an interval in which said second player follows a pass action sequence;
a fifth variable representing a dividing point between an interval in which said second player follows a fold action sequence and an interval in which said second player follows a call action sequence;
a sixth variable representing a dividing point between an interval in which said first player follows a pass-fold action sequence and an interval in which said first player follows a pass-call action sequence;
a seventh variable representing a dividing point between an interval in which said second player follows a pass action sequence and an interval in which said second player follows a bet action sequence;
an eighth variable representing a dividing point between an interval in which said first player follows a pass-call action sequence and an interval in which said first player follows a bet-fold action sequence;
a ninth variable representing a dividing point between an interval in which said first player follows a bet-fold action sequence and an interval in which said first player follows a bet-call action sequence;
a tenth variable representing a dividing point between an interval in which said second player follows a call action sequence and an interval in which said second player follows a raise-fold action sequence;
an eleventh variable representing a dividing point between an interval in which said second player follows a raise-fold action sequence and an interval in which said second player follows a raise-call action sequence;
a twelfth variable representing a dividing point between an interval in which said first player follows a bet-call action sequence and an interval in which said first player follows a bet-reraise action sequence.

23. The article of manufacture of claim 22 further comprising computer readable code configured to cause said computer to assign a relative order to said variables such that:
said first variable is less than said second variable;
said second variable is less than said third variable;
said third variable is less than said fourth variable;
said fourth variable is less than said fifth variable;
said fifth variable is less than or equal to said sixth variable;
said sixth variable is less than said seventh variable;
said seventh variable is less than said eighth variable;
said eighth variable is less than said ninth variable;
said ninth variable is less than said tenth variable;
said tenth variable is less than said eleventh variable;
said eleventh variable is less than said twelfth variable.

24. The article of manufacture of claim 18 wherein said plurality of variables comprise:
a first variable representing a dividing point between an interval in which said second player follows a raise-fold action sequence and an interval in which said second player follows a fold action sequence;
a second variable representing a dividing point between an interval in which said first player follows a bet-fold action sequence and an interval in which said first player follows a bet-reraise action sequence;
a third variable representing a dividing point between an interval in which said first player follows a bet-reraise action sequence and an interval in which said first player follows a pass-raise-fold action sequence;
a fourth variable representing a dividing point between an interval in which said first player follows a pass-raise-fold action sequence and an interval in which said first player follows a pass-fold action sequence;
a fifth variable representing a dividing point between an interval in which said second player follows a bet-fold action sequence and an interval in which said second player follows a bet-reraise action sequence;
a sixth variable representing a dividing point between an interval in which said second player follows a bet-reraise action sequence and an interval in which said second player follows a pass action sequence;
a seventh variable representing a dividing point between an interval in which said first player follows a p ass-fold action sequence and an interval in which said first player follows a pass-call action sequence;
an eighth variable representing a dividing point between an interval in which said second player follows a fold action sequence and an interval in which said second player follows a call action sequence;
a ninth variable representing a dividing point between an interval in which said second player follows a pass action sequence and an interval in which said second player follows a bet-fold action sequence;
a tenth variable representing a dividing point between an interval in which said second player follows a bet-fold action sequence and an interval in which said second player follows a bet-call action sequence;
an eleventh variable representing a dividing point between an interval in which said first player follows a pass-call action sequence and an interval in which said first player follows a bet-fold action sequence;
a twelfth variable representing a dividing point between an interval in which said first player follows a bet-fold action sequence and an interval in which said first player follows a bet-call action sequence;
a thirteenth variable representing a dividing point between an interval in which said second player follows a call action sequence and an interval in which said second player follows a raise-fold action sequence;
a fourteenth variable representing a dividing point between an interval in which said second player follows a raise-fold action sequence and an interval in which said second player follows a raise-call action sequence;
a fifteenth variable representing a dividing point between an interval in which said first player follows a bet-call action sequence and an interval in which said first player follows a pass-raise-fold action sequence;
a sixteenth variable representing a dividing point between an interval in which said first player follows a pass-raise-fold action sequence and an interval in which said first player follows a pass-raise-call action sequence;
a seventeenth variable representing a dividing point between an interval in which said second player follows a bet-call action sequence and an interval in which said second player follows a bet-reraise action sequence;
an eighteenth variable representing a dividing point between an interval in which said first player follows a pass-raise-call action sequence and an interval in which said first player follows a bet-reraise action sequence.

25. The article of manufacture of claim 24 further comprising computer readable code configured to cause said computer to assign a relative order to said variables such that:
said first variable is less than said second variable;
said second variable is less than said third variable;
said third variable is less than said fourth variable;
said fourth variable is less than said fifth variable;
said fifth variable is less than said sixth variable;
said sixth variable is less than said seventh variable;
said seventh variable is less than or equal to said eighth variable;
said eighth variable is less than said ninth variable;
said ninth variable is less than said tenth variable;
said tenth variable is less than said eleventh variable;
said eleventh variable is less than said twelfth variable;
said twelfth variable is less than said thirteenth variable;
said thirteenth variable is less than said fourteenth variable;
said fourteenth variable is less than said fifteenth variable;
said fifteenth variable is less than said sixteenth variable;
said seventeenth variable is less than said eighteenth variable.

26. An article of manufacture comprising:
a computer usable medium having computer readable program code embodied therein for generating card playing strategies for a game of cards, the computer readable program code in said article of manufacture comprising:
computer readable program code configured to cause said computer to manipulate a plurality of variables representing dividing points between intervals of a card hand strength hierarchy for each player of said game, each of said intervals corresponding to a subset of hands from said player's card hand strength hierarchy with which said player undertakes a particular action sequence;
computer readable program code configured to cause said computer to construct an expression for an expected return to a player for a round of said game using said variables comprising computer readable program code configured to cause said computer to determine products of an expected return for each of a plurality of outcomes of said round of said game and a probability of the occurrence of said outcome;
computer readable program code configured to cause said computer to derive expressions for said variables that maximize said expected return comprising computer readable program code configured to cause said computer to generate a plurality of simultaneous equations by taking a partial derivative of said expected return expression with respect to each of said variables and setting said expected return expression equal to zero;
computer readable program code configured to cause said computer to evaluate said expressions to obtain values for said variables comprising computer readable program code configured to cause said computer to solve said simultaneous equations to obtain values for said variables.

27. The article of manufacture of claim 26 wherein said plurality of variables comprise:
a first variable representing a dividing point between an interval in which said second player follows a raise-fold action sequence and an interval in which said second player follows a fold action sequence;
a second variable representing a dividing point between an interval in which said first player follows a bet-fold action sequence and an interval in which said first player follows a bet-reraise action sequence;
a third variable representing a dividing point between an interval in which said first player follows a bet-reraise action sequence and an interval in which said first player follows a pass-fold action sequence;
a fourth variable representing a dividing point between an interval in which said second player follows a bet action sequence and an interval in which said second player follows a pass action sequence;
a fifth variable representing a dividing point between an interval in which said second player follows a fold action sequence and an interval in which said second player follows a call action sequence;
a sixth variable representing a dividing point between an interval in which said first player follows a pass-fold action sequence and an interval in which said first player follows a pass-call action sequence;
a seventh variable representing a dividing point between an interval in which said second player follows a pass action sequence and an interval in which said second player follows a bet action sequence;
an eighth variable representing a dividing point between an interval in which said first player follows a pass-call action sequence and an interval in which said first player follows a bet-fold action sequence;
a ninth variable representing a dividing point between an interval in which said first player follows a bet-fold action sequence and an interval in which said first player follows a bet-call action sequence;
a tenth variable representing a dividing point between an interval in which said second player follows a call action sequence and an interval in which said second player follows a raise-fold action sequence;
an eleventh variable representing a dividing point between an interval in which said second player follows a raise-fold action sequence and an interval in which said second player follows a raise-call action sequence;
a twelfth variable representing a dividing point between an interval in which said first player follows a bet-call action sequence and an interval in which said first player follows a bet-reraise action sequence.

28. The article of manufacture of claim 27 further comprising computer readable code configured to cause said computer to assign a relative order to said variables such that:
said first variable is less than said second variable;
said second variable is less than said third variable;
said third variable is less than said fourth variable;
said fourth variable is less than said fifth variable;
said fifth variable is less than or equal to said sixth variable;
said sixth variable is less than said seventh variable;
said seventh variable is less than said eighth variable;
said eighth variable is less than said ninth variable;
said ninth variable is less than said tenth variable;
said tenth variable is less than said eleventh variable;
said eleventh variable is less than said twelfth variable.

29. The article of manufacture of claim 26 wherein said plurality of variables comprise:
a first variable representing a dividing point between an interval in which said second player follows a raise-fold action sequence and an interval in which said second player follows a fold action sequence;
a second variable representing a dividing point between an interval in which said first player follows a bet-fold action sequence and an interval in which said first player follows a bet-reraise action sequence;
a third variable representing a dividing point between an interval in which said first player follows a bet-reraise action sequence and an interval in which said first player follows a pass-raise-fold action sequence;
a fourth variable representing a dividing point between an interval in which said first player follows a pass-raise-fold action sequence and an interval in which said first player follows a pass-fold action sequence;
a fifth variable representing a dividing point between an interval in which said second player follows a bet-fold action sequence and an interval in which said second player follows a bet-reraise action sequence;
a sixth variable representing a dividing point between an interval in which said second player follows a bet-reraise action sequence and an interval in which said second player follows a pass action sequence;
a seventh variable representing a dividing point between an interval in which said first player follows a pass-fold action sequence and an interval in which said first player follows a pass-call action sequence;
an eighth variable representing a dividing point between an interval in which said second player follows a fold action sequence and an interval in which said second player follows a call action sequence;
a ninth variable representing a dividing point between an interval in which said second player follows a pass action sequence and an interval in which said second player follows a bet-fold action sequence;
a tenth variable representing a dividing point between an interval in which said second player follows a bet-fold action sequence and an interval in which said second player follows a bet-call action sequence;
an eleventh variable representing a dividing point between an interval in which said first player follows a pass-call action sequence and an interval in which said first player follows a bet-fold action sequence;
a twelfth variable representing a dividing point between an interval in which said first player follows a bet-fold action sequence and an interval in which said first player follows a bet-call action sequence;
a thirteenth variable representing a dividing point between an interval in which said second player follows a call action sequence and an interval in which said second player follows a raise-fold action sequence;
a fourteenth variable representing a dividing point between an interval in which said second player follows a raise-fold action sequence and an interval in which said second player follows a raise-call action sequence;
a fifteenth variable representing a dividing point between an interval in which said first player follows a bet-call action sequence and an interval in which said first player follows a pass-raise-fold action sequence;
a sixteenth variable representing a dividing point between an interval in which said first player follows a pass-raise-fold action sequence and an interval in which said first player follows a pass-raise-call action sequence;
a seventeenth variable representing a dividing point between an interval in which said second player follows a bet-call action sequence and an interval in which said second player follows a bet-reraise action sequence;
an eighteenth variable representing a dividing point between an interval in which said first player follows a pass-raise-call action sequence and an interval in which said first player follows a bet-reraise action sequence.

30. The article of manufacture of claim 29 further comprising computer readable code configured to cause said computer to assign a relative order to said variables such that:
said first variable is less than said second variable;
said second variable is less than said third variable;
said third variable is less than said fourth variable;
said fourth variable is less than said fifth variable;
said fifth variable is less than said sixth variable;
said sixth variable is less than said seventh variable;
said seventh variable is less than or equal to said eighth variable;
said eighth variable is less than said ninth variable;
said ninth variable is less than said tenth variable;
said tenth variable is less than said eleventh variable;
said eleventh variable is less than said twelfth variable;
said twelfth variable is less than said thirteenth variable;
said thirteenth variable is less than said fourteenth variable;
said fourteenth variable is less than said fifteenth variable;
said fifteenth variable is less than said sixteenth variable;
said seventeenth variable is less than said eighteenth variable.

31. An article of manufacture comprising:
a computer usable medium having computer readable program code embodied therein for generating a virtual hand for a card game having a hand strength ranking corresponding to a value of a action sequence triggering variable representing a dividing point between first and second intervals of a card hand strength hierarchy for a player, said first interval corresponding to a subset of hands from said player's card hand strength hierarchy with which said player undertakes a first action sequence, said second interval corresponding to a subset of hands from said player's card hand strength hierarchy with which said player undertakes a second action sequence, wherein said hand strength hierarchy of said player comprises a first hand in said first interval having a hand strength immediately below said value of said variable and a second hand in said second interval having a hand strength immediately above said value of said variable, the computer readable program code in said article of manufacture comprising:
computer readable program code configured to cause said computer to determine a ratio between (i) a difference between said hand strength of said second hand and said value of said variable and (ii) a difference between said hand strength of said second hand and said hand strength of said first hand;
computer readable program code configured to cause said computer to output a value representing a fraction of said first hands equal to said ratio with which to undertake said second action sequence.

32. An article of manufacture comprising:
a computer usable medium having computer readable program code embodied therein for generating a virtual hand for a card game having a hand strength ranking corresponding to a value of a action sequence triggering variable representing a dividing point between first and second intervals of a card hand strength hierarchy for a player, said first interval corresponding to a subset of hands from said player's card hand strength hierarchy with which said player undertakes a first action sequence, said second interval corresponding to a subset of hands from said player's card hand strength hierarchy with which said player undertakes a second action sequence, wherein said hand strength hierarchy of said player comprises a first hand in said first interval having a hand strength immediately below said value of said variable and a second hand in said second interval having a hand strength immediately above said value of said variable, the computer readable program code in said article of manufacture comprising:
computer readable program code configured to cause said computer to determine a first ratio between (i) a difference between said value of said variable and said hand strength of said first hand and (ii) a difference between said hand strength of said second hand and said hand strength of said first hand;
computer readable program code configured to cause said computer to output a value representing a fraction of said second hands equal to said first ratio with which to undertake said first action sequence.

33. The article of manufacture of claim 32 further comprising:
computer readable program code configured to cause said computer to determine a second ratio between (i) a difference between said hand strength of said second hand and said value of said variable and (ii) a difference between said hand strength of said second hand and said hand strength of said first hand;
computer readable program code configured to cause said computer to output a value representing a fraction of said first hands equal to said second ratio with which to undertake said second action sequence.
